(19) United States
(12) Patent Application Publication
(10) Pub. No.: US 2007/0043595 A1
(43) Pub. Date: Feb. 22, 2007

(54) System, method and computer software product for estimating costs under health care plans

(76) Inventor: Derek Pederson, Lakeville, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/504,221

(22) Filed: Aug. 15, 2006

Related U.S. Application Data
(63) Continuation-in-part of application No. 11/430,254, filed on May 8, 2006.
(60) Provisional application No. 60/686,801, filed on Jun. 1, 2005.

(51) Int. Cl. G06Q 10/00; G06Q 40/00

(52) U.S. Cl. 705/2; 705/4

(57) ABSTRACT

In a system and method for estimating medical costs under at least one health plan, one or more user devices provide user health data entered by one or more users to a processor, and the processor provides estimated health plan cost data to the user device(s) to enable the user(s) to compare the costs and benefits of various health plan options available to the user(s). The processor includes an administrative module for receiving user account data and health plan data entered by an administrator; a calculation module for providing estimated cost data based upon the user health data; a user module for generating the estimated health plan cost data based upon the user health data, user account data, health plan data and estimated cost data and providing the estimated health plan cost data to the user device; and a database for storing the estimated health plan cost data, user health data, user account data, health plan data and estimated cost data. The user health data may include medical condition data, prescription data, prescription cost saving option data, healthcare provider selection data, historical user data, expected medical procedure data and/or expected durable medical equipment data. The user module calculates the estimated health plan cost data by adding all estimated cost data corresponding to the user health data and applying the health plan data and user account data to determine expected costs to the user under each health plan option available to the user. The user module may further calculate a recommended contribution to a flexible spending account or health savings account based upon the estimated health plan cost data and a tax savings amount associated with the recommended contribution to the flexible spending account or health savings account using income and tax status data provided by the user.

### CROSS REFERENCE TO RELATED APPLICATIONS

This application is a continuation-in-part of U.S. patent application Ser. No. 11/430,254, filed May 8, 2006, entitled “System, Method and Computer Program Product for Estimating Medical Costs Under Health Care Plans,” which claims benefit under 35 U.S.C. §119(e) to U.S. Provisional Patent Application No. 60/686,801, entitled “System, Method, and Computer Program Product for Estimating Medical Costs Under Health Care Plans,” filed Jun. 1, 2005. The disclosure of both applications is hereby incorporated by reference.

### FIELD OF THE INVENTION

The present invention relates generally to a system, method and computer program for enabling one or more users to estimate the costs and expenses associated with one or more available health care plans. Individuals, such as employees of a company or participants in a health plan, are provided with the ability to compare the costs and expenses associated with different health plans that may be available to the individual.

### BACKGROUND OF THE INVENTION

In selecting healthcare insurance coverage, individuals may be faced with a number of potential health plan options, each with varying characteristics such as deductibles, premiums, co-payments, other costs, and scopes of coverage. The complexity of the various plans and the variations among the plans may be difficult and time-consuming for the individual seeking to assess the comparative costs and expenses of each available health plan to select one health plan from the plan options available to the individual.

Furthermore, it may be difficult for the individual to estimate the actual out-of-pocket costs that the individual can expect to pay under each available plan. This makes it difficult for individuals to budget their healthcare costs. Also, individuals who are offered benefits such as pre-tax flexible spending accounts and health savings accounts may have difficulty choosing an amount to contribute annually to cover their medical costs.

Therefore, there is a need for a tool that enables individuals to assess the comparative costs and benefits of health plans available to them in order to enable selection of the most beneficial health plan and to more accurately budget for their annual medical costs.

### BRIEF SUMMARY OF THE INVENTION

The present invention provides a system, method and computer program product that enable individuals, such as employees of a company or participants in a health plan, to assess and compare the costs and benefits of different health plans available to the individual. In particular, the present invention permits a user to obtain an estimate of healthcare costs as well as a display of calculations of out-of-pocket medical expenses under various health plans so that the employee/user can assess which health plan would be most advantageous for that user's particular circumstances. Optionally, individuals who are offered benefits such as pre-tax flexible spending accounts and health savings accounts may use the system and method of the present invention to calculate a recommended amount to contribute annually to these accounts.

A system for estimating medical costs in accordance with the present invention includes a user terminal or other input device for providing user health data entered by a user and obtaining estimated health plan cost data generated in response to the user health data; and a processor for providing the estimated health plan cost data. The processor may include an administrative module for receiving user account data and health plan data entered by an administrator; a calculation module for providing estimated cost data based upon the user health data; a user module for generating the estimated health plan cost data based upon the user health data, user account data, health plan data and estimated cost data and providing the estimated health plan cost data to the user device; and a database for storing the estimated health plan cost data, user health data, user account data, health plan data and estimated cost data.

The user health data entered into the system by the user may include medical condition data, prescription data, expected medical procedure data and/or expected durable medical equipment data, and the calculation module may provide estimated cost data for at least one expected future medical procedure, expected future prescription, and/or expected future use of durable medical equipment based upon the user health data.

The system may also offer prescription cost savings options to the user, for example, the option of receiving medications by mail, the option of ordering a smaller number of pills having a greater dosage than the dosage to be taken by the user such that the user can cut the pills into smaller doses (“pill splitting”), or the option of purchasing a generic version of the medication. The user may select one or more prescription cost-saving options as a component of the user health data.

The system may further provide a provider look-up feature to enable a user to determine whether a specific health care provider (e.g., a physician or facility) is covered under the user's health plan options or to enable a user to identify one or more providers, such as providers of a certain specialty. Provider preferences may be included as a component of the user health data.

The system may also display recommended care (such as check-ups or recommended medical procedures), for example, based upon the age and gender of the patient. The user may select one or more of the recommended care services or procedures as a component of the user health data.

The system may further import historical user data for one or more users based upon past data entered by the user or obtained from the medical history or historical medical claim data filed by the user in the past such that this information need not be re-entered by the user each year. This feature saves user time and makes the health plan cost estimates more accurate. The user may choose to modify the historical user data in assessing future health care needs. Also, the historical user data that is displayed to the user may be limited, for example, based upon HIPAA requirements, such that the user may view his/her own historical data but not the historical data of his/her spouse and other dependents.

The user module may calculate the estimated health plan cost data for the user by adding all estimated cost data corresponding to the user health data and applying the health plan data an user account data to determine expected costs to the user under at least one health plan. The estimated health plan cost data also may include comparative healthcare costs for the user under two or more health plans.

Optionally, the user module may also calculate a recommended contribution to a flexible spending account or health savings account based upon the estimated health plan cost data and a tax savings amount associated with the recommended contribution to the flexible spending account or health savings account using the income and tax status data provided by the user.

A method for estimating medical costs in accordance with the present invention includes the steps of: receiving user health data entered by a user; receiving user account data and health plan data entered by an administrator; generating estimated cost data based upon the user health data; generating estimated health plan cost data based upon the user health data, user account data, health plan data and estimated cost data; and providing the estimated health plan cost data to the user. The user health data includes medical condition data, prescription data, expected medical procedure data or expected durable medical equipment data, and may also include prescription cost savings options, provider preferences, recommended procedures, and/or historical data concerning the medical history the patients for whom the health plan costs are to be estimated.

The method may also include the step of providing estimated cost data for at least one expected future medical procedure, expected future prescription, or expected future use of durable medical equipment based upon the user health data. The estimated health plan cost data may be calculated by adding all estimated cost data corresponding to the user health data and applying the health plan data an user account data to determine expected costs to the user under one or more health plan.

Optionally, the method may further include the step of calculating a recommended contribution to a flexible spending account or health savings account based upon the estimated health plan cost data and the step of calculating a tax savings amount associated with the recommended contribution to the flexible spending account or health savings account using the income and tax status data provided by the user.

The system and method described above may be implemented, for example, as a computer program product for enabling one or more users to compare health plan costs and benefits.

The features, utilities and advantages of the various embodiments of the invention will be apparent from the following more particular description of embodiments of the invention as illustrated in the accompanying drawings.

### BRIEF DESCRIPTION OF THE DRAWINGS

FIG. 1 provides a block diagram of a system for estimating and comparing medical costs under one or more health plans.

FIG. 2 provides a functional diagram of operations of an administrative module for use in the system of FIG. 1.

FIG. 3 provides a functional diagram of operations of a user module for use in the system of FIG. 1.

FIGS. 3A and 3B provide additional details concerning the functions of the user module illustrated in FIG. 3.

FIG. 4 provides a functional diagram of operations of a calculation module for use in the system of FIG. 1.

FIGS. 5-19 provide illustrations of a graphic user interface by which an administrator may access the administrative module of the system in FIG. 1.

FIGS. 20-45 illustrate various features and user interface capabilities of a graphic user interface for a user device in the system of FIG. 1.

FIGS. 46A-C illustrate an exemplary user interface for entry of prescription information, including cost saving selections.

FIGS. 47A-E illustrate an exemplary user interface for entry of health care provider selections or preferences.

### DETAILED DESCRIPTION

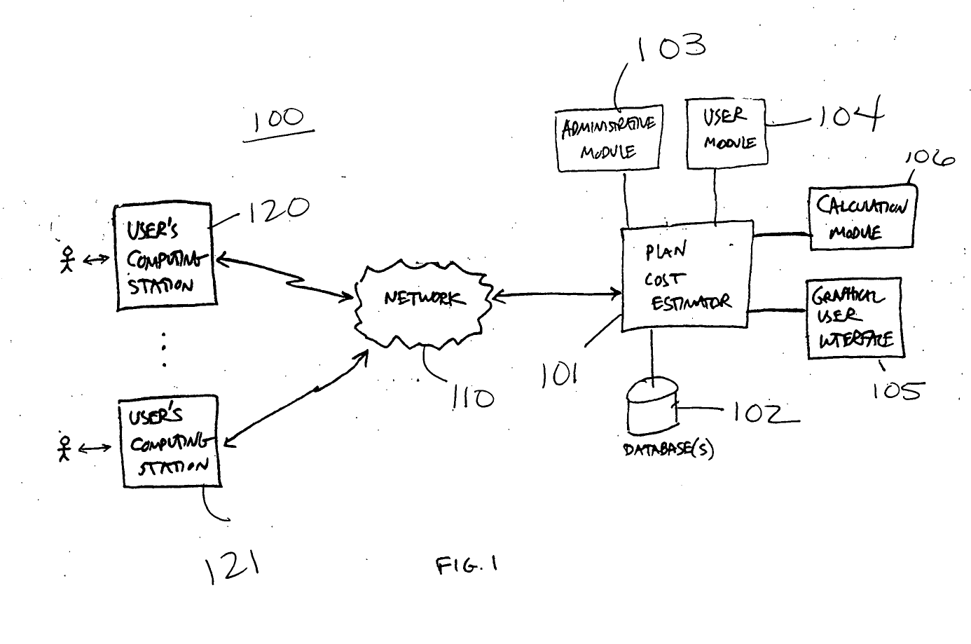

FIG. 1 illustrates a block diagram of a system 100 for estimating and comparing medical costs under health care plans. As shown in FIG. 1, a plan cost estimator module 101 may include or access one or more administrative modules 103 and one or more user modules 104. The plan cost estimator may also use or access a calculation module 106 and provide one or more graphical user interfaces 105. The plan cost estimator module 101 may access one or more databases 102 in order to perform various functions. The plan cost estimator may be implemented in a client server model, ASP model, or networked application model, wherein users can access or operate the plan cost estimator remotely from user devices, e.g., user terminals 120 and 121, over a network 110.

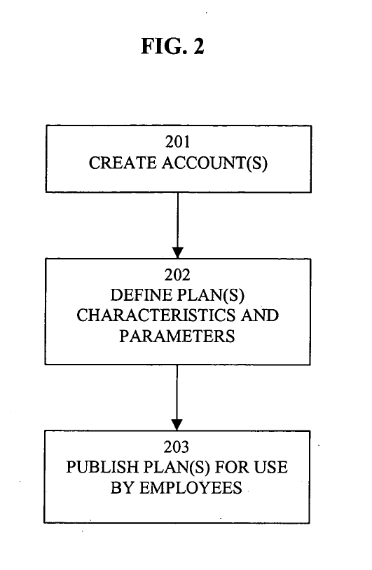

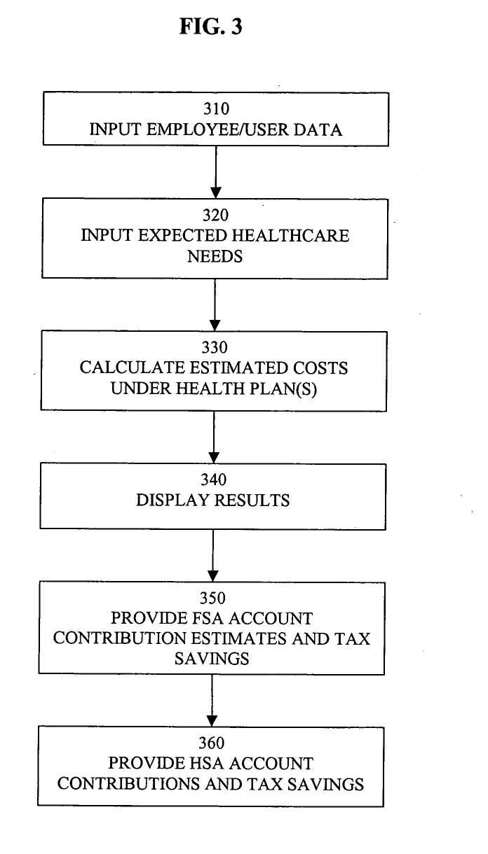

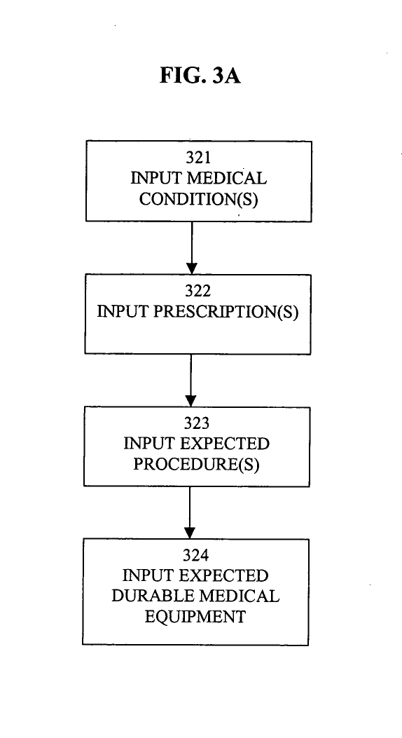

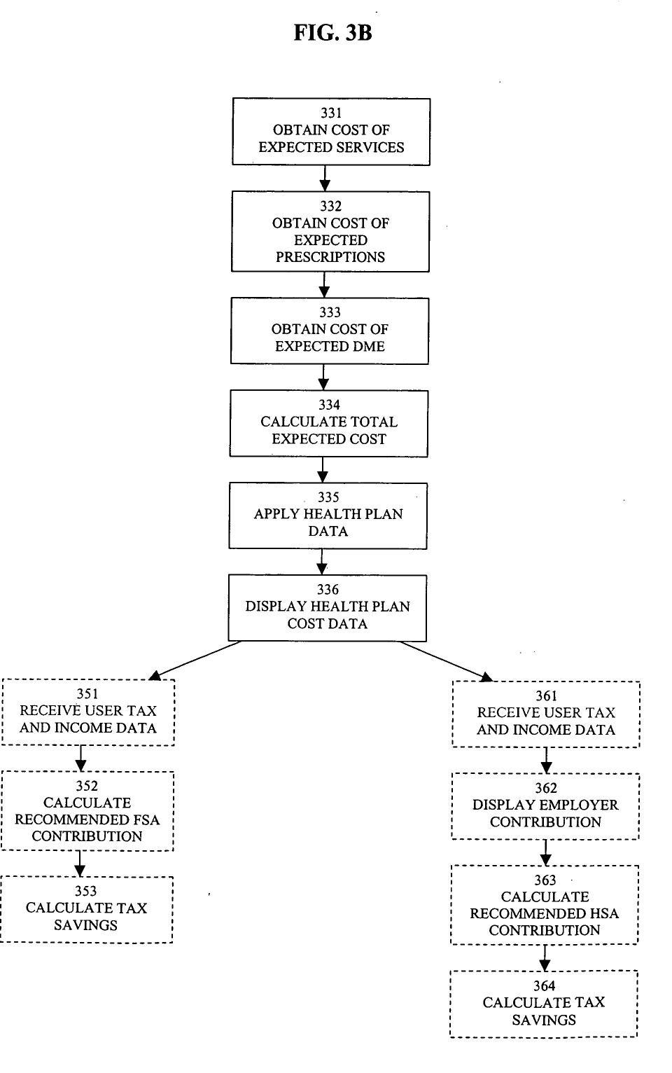

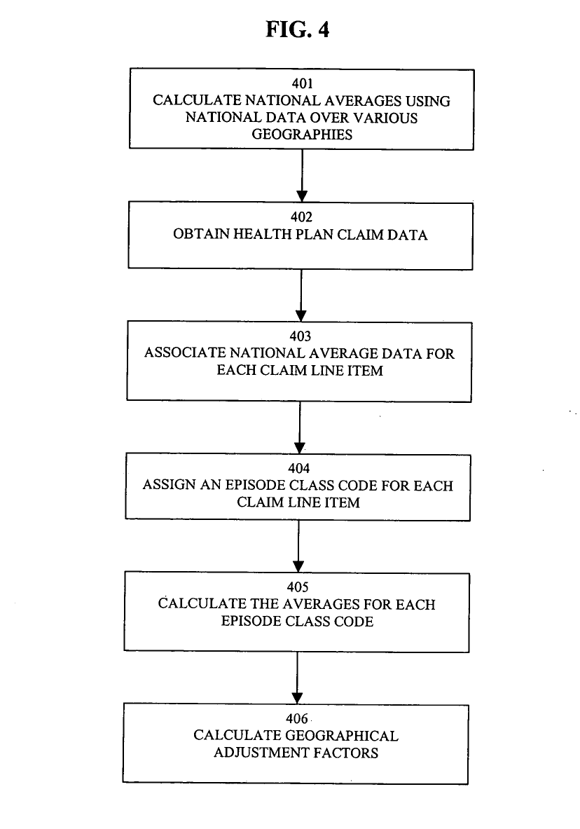

As described below with reference to FIG. 2, the administrative module 103 provides various operations, functions and interfaces that are used by an administrator to set up and establish accounts or scenarios which users or employees can access in order to estimate medical expenses under various different health plans. As described below with reference to FIGS. 3 and 3A, the user module 104 provides a plurality of operations, functions and user interfaces for providing the user with the ability to estimate medical expenses under various health plans via user devices such as terminals 120 and 121. The calculation module 106, also know as the treatment cost estimator, shown in FIG. 1 may perform medical cost estimating functions operations as described in detail below with reference to FIG. 4.

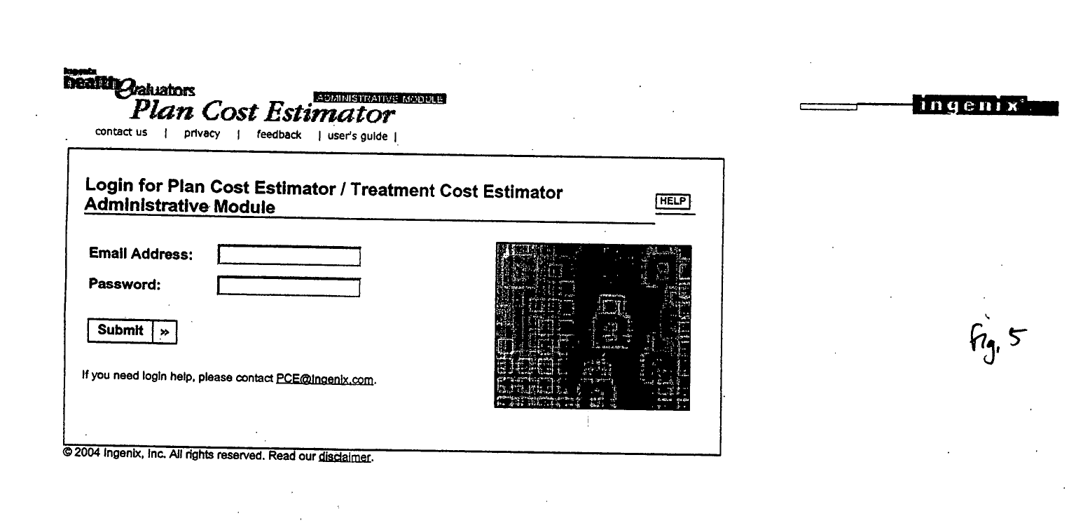

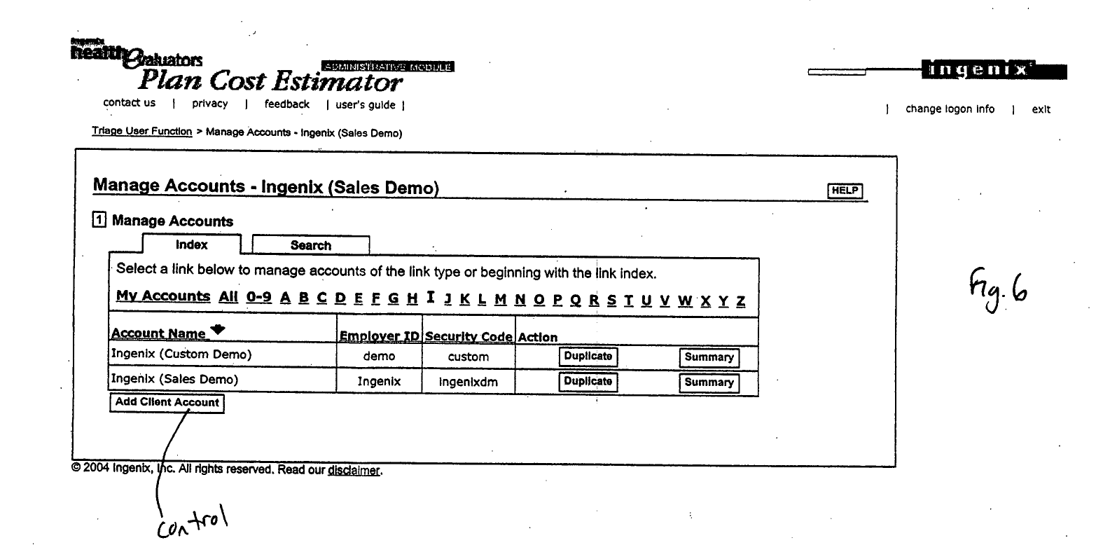

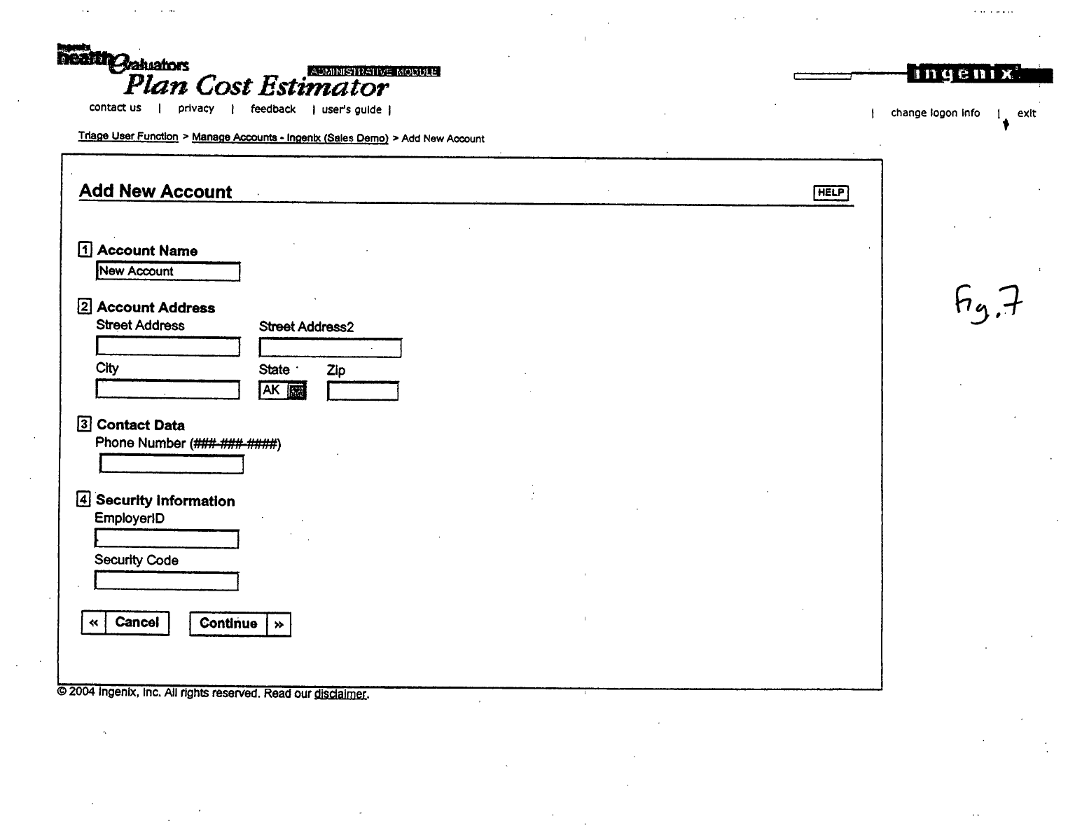

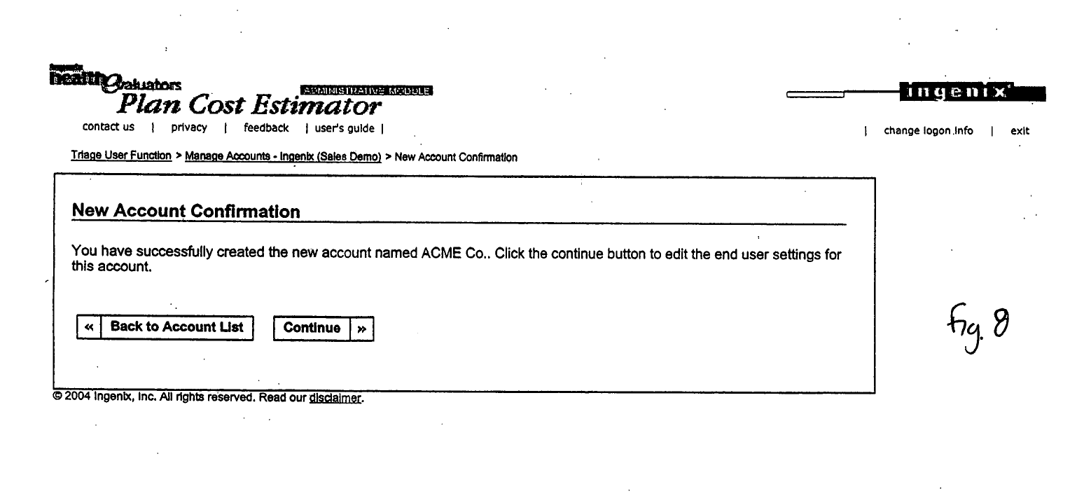

FIG. 2 provide an example of logical operations performed by the administrative module 103 for use in system 100. In step 201, an administrator creates one or more accounts by entering user account data into the administrative module. In step 202, the administrator enters health plan data that defines characteristics and parameters of various health plans within a particular account. In step 203, the administrator publishes the user account data and health plan data into the user module 104 so that users/employees can utilize the account/plans that the administrator has set up in order to compare and estimate healthcare costs under different health plans. FIGS. 5-19, described below, provide examples of a graphic user interface by which an administrator may access the administrative module 103 and perform various operations, such as creating and managing employer accounts, defining and managing employer profiles, and defining and managing health plans available to the employees of each employer. The information entered into the administrative module 103 is used in conjunction with estimated cost data generated by calculation module 106 (described in detail below with reference to FIG. 4) and the information entered by the user(s) or employee(s) to provide comparative health plan cost values to the user(s) or employee(s).

FIG. 3 illustrates an example of logical operations for a user module 104 for use in system 100. In step 310, a user or employee inputs data regarding the employee and the employee's spouse/dependents. In step 320, the employee inputs user health data representing the healthcare needs of the employee and any other covered individual, such as a spouse or dependents (see also FIG. 3A). Notably, the data input by the employee or user may be actual data or hypothetical data that the user enters to obtain health plan cost estimates based upon different parameters. In step 330, estimated health plan cost data for various health plans is calculated based upon the user account data, health plan data (defined by the administrator using administrative module 103), user health data (actual or hypothetical as entered by the user) and estimated cost data generated by the calculation module 106 (see also FIG. 3B). Other factors are utilized in the calculation, as described herein.

In step 340 of FIG. 3, the estimated health plan cost data may be displayed to the employee/user so that the employee/user can compare the costs and benefits of various health plans. In step 350, the user module may, optionally, provide contribution estimates and estimated tax savings for flexible spending accounts. In step 360, the user module may, optionally, provide contribution estimates and estimated tax savings for health savings accounts, if desired.

FIGS. 20-45 relate to various features and user interface capabilities of a user module, in accordance with embodiments of the present invention.

FIG. 3A illustrates an example of logical operations for obtaining user health data for an employee/user and/or their spouse and/or dependants included in step 320 of FIG. 3. In step 321 in FIG. 3A, the user inputs medical conditions of the user/employee, and/or spouse/dependents. In step 322, the employee/user inputs prescriptions that will be expected to be utilized within the next year by the employee and/or spouse/dependents. In step 323, the user/employee inputs expected medical procedures that will be received by the employee and/or spouse/dependents. In step 340, the user/employee inputs the expected durable medical equipment that will be utilized by the employee and/or spouse/dependents within the coming year.

FIG. 3B provides an example of a process by which the estimated health plan cost data for each health plan available to a user is calculated included in step 330 of FIG. 3. In step 331, the cost associated with expected user services is obtained by adding the average cost of each expected medical procedure and service for each family member (or covered individual) under each health plan available to the user (as calculated by calculation module 106). In step 332, the cost associated with expected user prescriptions is obtained by adding the average cost of each prescription for each family member (or covered individual) under each health plan available to the user (as calculated by calculation module 106). In step 333, the cost associated with expected user durable medical equipment (DME) is obtained by adding the average cost of the equipment for each family member (or covered individual) under each health plan available to the user (as calculated by calculation module 106). In step 334, the total cost of expected medical services, prescriptions, and equipment for all individuals to be covered under the health plan is calculated for each health plan available to the user. The total cost data optionally may be displayed to the user.

In step 335, health plan coverage data, such as health plan data input by an administrator using administrative module 103 or health plan data received from a health insurance organization, is applied to determine the costs that the user would pay for the services, prescriptions, and equipment under the terms of each available health plan. Health plan data may include definitions of user/employee premiums, deductibles, co-payments, coinsurance amounts, and other costs that would be the responsibility of the user/employee under the terms of each available health plan.

In step 336, the estimated health plan cost data that represents the costs to the user/employee under each available health plan is displayed to the user in a format defined by the administrator using administrative module 103. This estimated health plan cost data for each available health plan enables the user to compare his/her costs for the coming year (or other applicable time period) under each health plan available to the user, thereby facilitating selection of one health plan from the available health plans.

The system 100 also optionally may assist the user in estimating the amount of withholding for the user's flexible spending account. In optional step 351, the user enters tax status data and income data, selects a health plan option from the available health plans, and enters any other expected medical cost data for the coming year. In optional step 352, the user module 104 calculates the recommended amount of withholding for the user's flexible spending account (FSA) based upon the cost of the health plan and displays this amount to the user. In optional step 353, user module 104 calculates the tax savings to the user based upon the amount recommended for the FSA account and the user's tax status and annual income and displays this tax savings amount to the user. This optional functionality of calculating a recommended annual contribution to a user's FSA and associated tax savings may be enabled by the administrator of the system using administrative module 103 (as described above with reference to FIG. 2).

The system 100 also optionally may assist the user in estimating contribution amounts and estimated tax savings for health savings accounts. In optional step 361, the user enters tax status data and income data, selects a health plan option from the available health plans, and enters any other expected medical cost data for the coming year. In optional step 362, the user module 104 displays the amount of the user's employer's annual contribution, if applicable. In optional step 363, the user module 104 calculates the recommended user's contribution to his/her health savings account (HSA) based upon the cost of the health plan and displays this amount to the user. In optional step 364, user module 104 calculates the tax savings to the user based upon the amount recommended for the HSA account and the user's tax status and annual income and displays this tax savings amount to the user. This optional functionality of calculating a recommended annual contribution to a user's HSA and associated tax savings may be enabled by the administrator of the system using administrative module 103 (as described above with reference to FIG. 2).

FIG. 4 provides an example of logical operations for generating estimated cost data that may performed by the calculation module 106. In step 401, national data from various geographies is utilized to calculate national averages for selected medical services or procedures, such as office visits to various types of healthcare providers as well as medical procedures and treatments. For example, data from a “MDR” database may be obtained using approximately 15,000 CPT codes and an amount billed and an amount paid for each code over 300 different geographic regions in the United States.

In one example of the operation performed by calculation module 106 in step 401, the calculation module 106 takes the 50^{th} percentile of all geographic codes for each CPT code and averages them, thereby forming a national average for the particular medical service or procedure associated with the CPT code. In one example, the result of this operation produces, for each CPT code, one national average for the amount billed for the respective CPT code and one national average for the amount paid for each CPT code. As there may be approximately 15,000 CPT codes in the MDR database, in this example the operation in step 401 produces approximately 3,000 averages. It is understood that the number of CPT codes in the MDR database is provided as an example, and that the data from which the national average is calculated in step 401 may vary and include more or less than 15,000 CPT or other types of codes. For instance, step 401 may calculate national averages using other databases or data models, such as from Prevailing Charge Systems or other databases.

Similarly, national average costs for various prescription medications and medical equipment may also be estimated in step 401 by obtaining and averaging the relevant data.

In step 402, health plan claim data is obtained. In one example, a particular health plan includes multiple claim line items including a procedure code description, such as a CPT code, for each claim line item. The data may also include ICD-9 codes, International Classification of Disease codes that indicate why a particular procedure or medical service was provided (also referred to as procedure codes).

The health plan claim data generally further includes or is drawn from data provided by the health plan relevant to the particular cost estimate being provided. For instance, if an employer offers two different health plans each serviced by a different health plan provider, then in step 402 calculation module 106 will access health plan claim data from a first provider to provide cost estimates for the first health plan and health plan claim data from the second provider to provide cost estimates for the second health plan. In this way, the calculation module 106 may provide different cost estimates for multiple different health plans based upon the corresponding health plan claim data from each health plan.

In operation 403, for each claim line item obtained from the health plan claim data in step 402, calculation module 106 associates the national average obtained in step 401 with the particular claim line item. For example, in step 403 the calculation module 106 reads the CPT code associated with a particular claim line item of the health plan claim data of step 402 and looks up the national average amount collected as calculated in step 401 for the respective CPT code. Calculation module 106 may then associate these national averages for each claim line item. Hence, by virtue of steps 401-403, a data set is produced that includes a plurality of claim line items from a health plan, CPT and/or procedure codes associated with each line item, and a national average dollar amount for the amount billed and the amount collected (calculated in step 401).

In step 404, for each line item in the data set produced in step 403, an episode class code may be assigned to each line item. For example, claim data is transformed into episodes that associate all medical services, procedures, prescriptions, equipment, and other costs associated with a particular disease, condition, surgery or other procedure.

In one example, episode class codes may be subdivided or grouped into classes or codes. For instance, episode class codes may include codes for conditions or diseases related to clinical care (such as high cholesterol, sprained ankle, etc.), codes for procedures (e.g., knee arthroscopy, colonoscopy, etc.), and codes for services, office visits, tests (e.g., x-rays, cat scans, cancer cell tests, etc.).

Episode class codes may be assigned or associated with particular line items utilizing one or more of the methodologies described in detail in U.S. Pat. No. 6,223,164, which is incorporated herein by reference.

In step 405, calculation module 106 calculates the averages for each episode class code in the data set created in step 404. First, all line items in the data set created in step 404 are tagged with or assigned to an episode class code. Thus, the various line items of the data set into certain groups based upon their episode classes. Once the data is categorized by episode class codes, the calculation module 106 counts the number of instances of an episode class code in the data and calculates an average amount billed and amount paid/collected for the particular episode class. Optionally, adjustments to the calculation of the average may be made to account for outliers for the conditions and procedures to adjust for high utilization.

In step 406, geographic adjustment factors for the average values calculated as described above may be calculated by identifying and using a selection of the most common medical services to compare the relative national averages of the common medical services by geographic region, such as regions in the United States divided by zip code. Weighed average values may then be determined that take into account the location in which the medical services are provided. This data set of average costs of various medical services, procedures, prescriptions, equipment, etc., weighted by geographic region is stored for use by the system 100, for example, in database 102, in order to provide supporting data for the health plan cost estimator 101.

Additional details concerning a process for calculating estimated costs of medical services is provided in U.S. patent application Ser. No. 10/966,530, filed Oct. 15, 2004 and entitled “SYSTEM, METHOD AND COMPUTER PROGRAM PRODUCT FOR ESTIMATING MEDICAL COSTS,” which is incorporated herein by reference.

Embodiments of the present invention may provide an administrative interface for an employer to establish parameters of the various health plans that the employer offers. These parameters are utilized for calculating the estimated planned costs that the employees will experience under particular health plans. FIGS. 5-19 illustrate various examples of administrative interfaces that may be provided for an employer or other entity to manage the user interfaces of the treatment cost estimator.

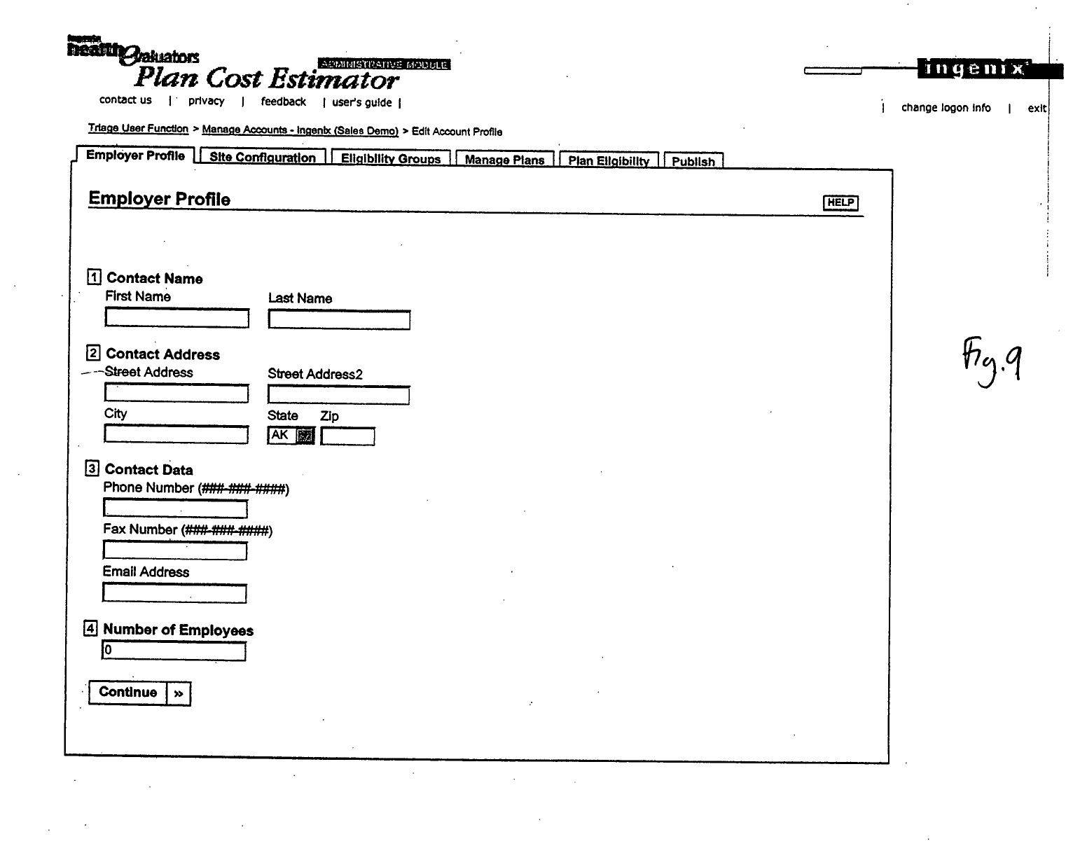

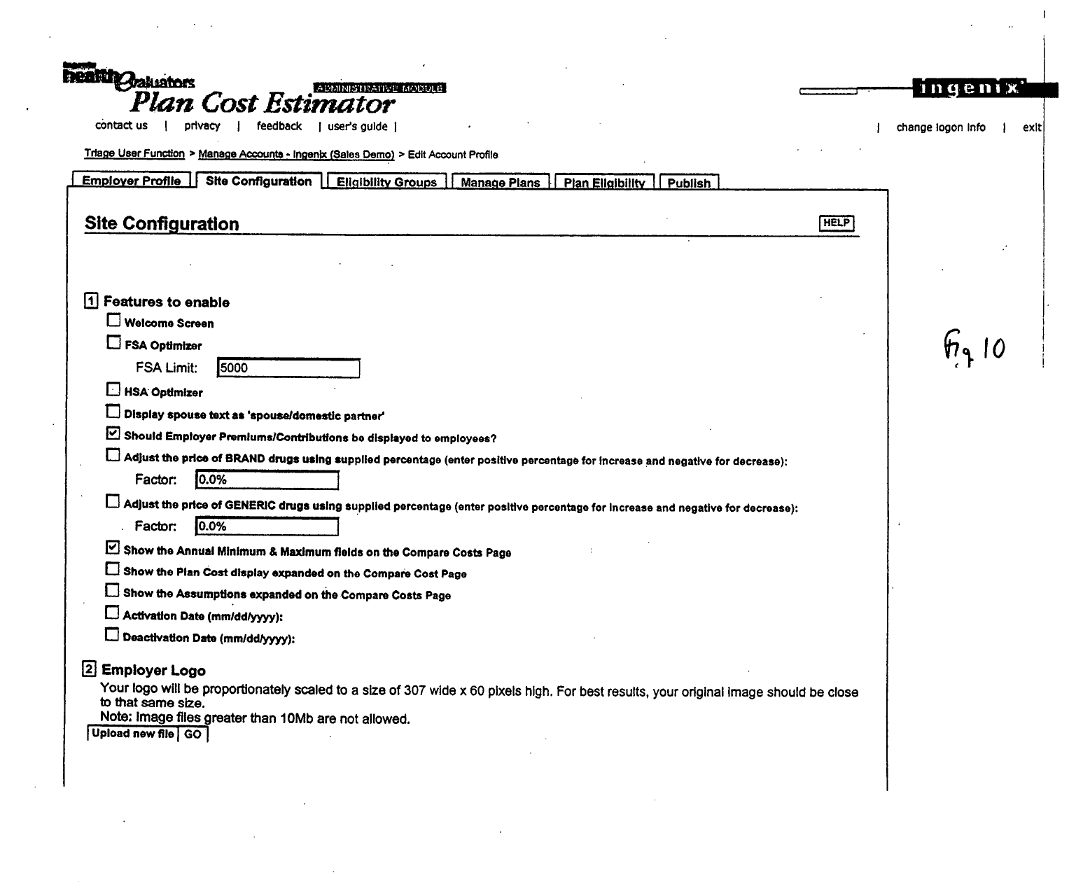

In FIG. 5, a login screen for the administrative module is illustrated, and may utilize conventional security measures for limiting access to the administrative module. FIG. 6 illustrates an example of a display screen where the administrator/user/employer can manage existing accounts or create new accounts if desired. Accounts, in this sense, include various instances or scenarios for sets of employees. For instance, an administrator may set up different accounts for different subsidiary companies of an entity; an administrator may set up different accounts for different employee groups of a company (such as executives, managers, salaried employees, hourly employees). In this sense, the accounts that an administrator may set up are intended to provide the administrator with flexibility for creating a number of different useful grouping of one or more healthcare plans for use within an organization or multiple organizations. In FIG. 6, a control is provided for creating or adding a new account.

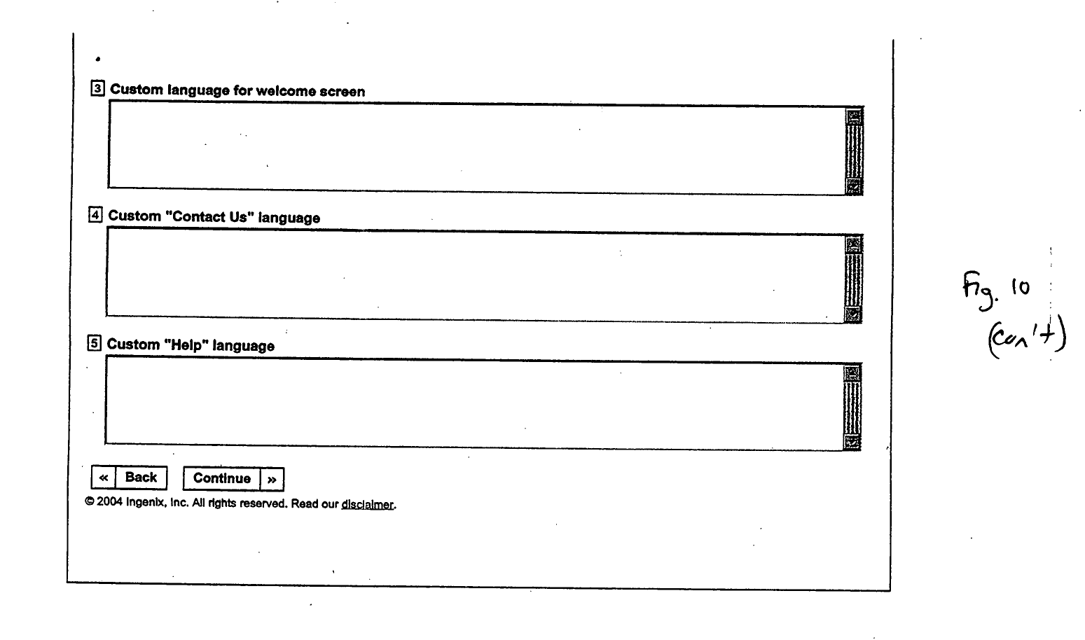

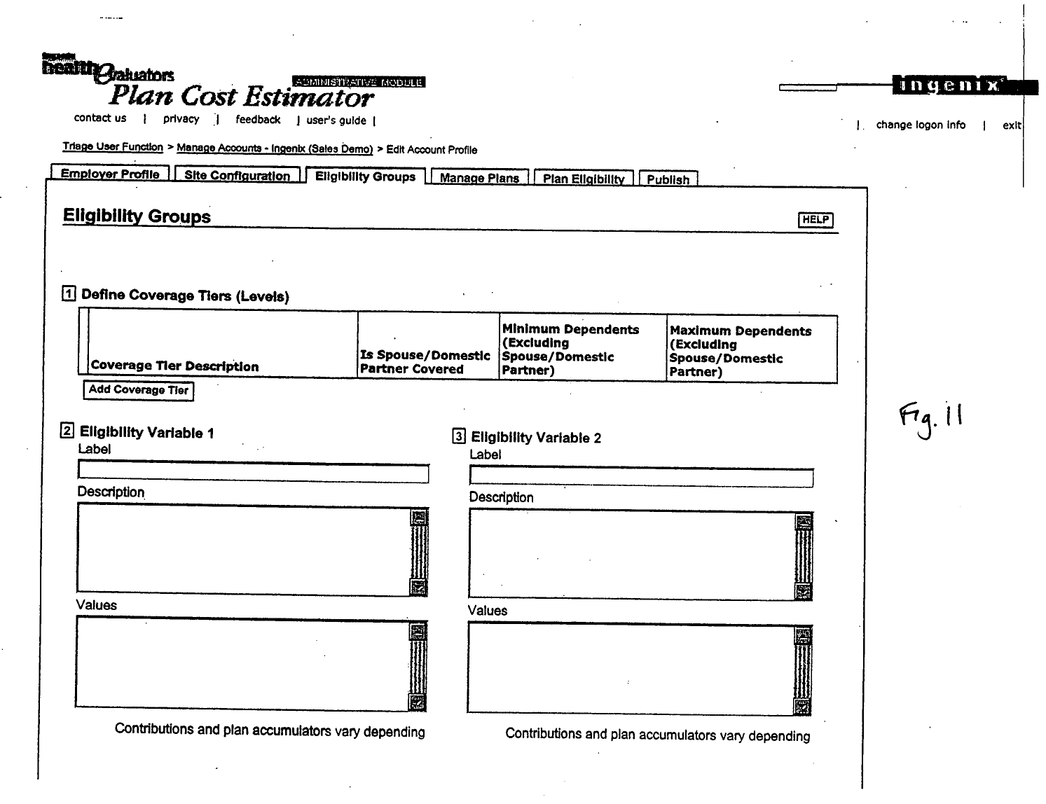

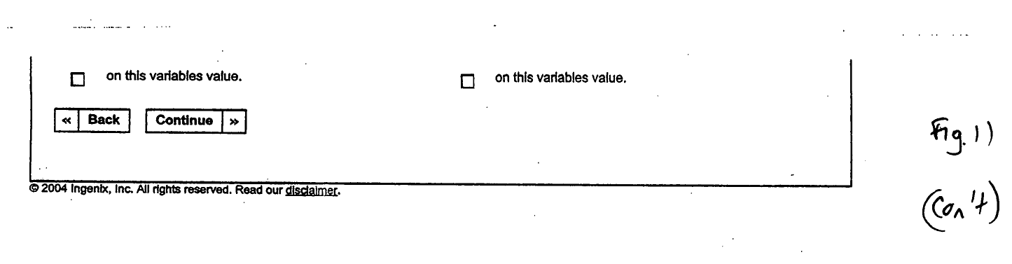

FIG. 7 illustrates an example administrative interface for an administrator to create or add a new account. In this example, fields may be provided for obtaining information such as the account name, account address, contact data including phone number, and security information data. Once an account has been successfully created, a screen may be provided to indicate the successful creation of the new account, as illustrated in the example of FIG. 8.

For each account, the administrative interface may provide the ability for an administrator to edit an employer profile, configure the sites (i.e., the content and appearance of the user interface corresponding to this account); eligibility groups for this account; manage health plans and characteristics thereof; specify plan eligibility; and publish the plan definitions to the user module so that the employees/users can begin utilizing the plan cost estimator functions.

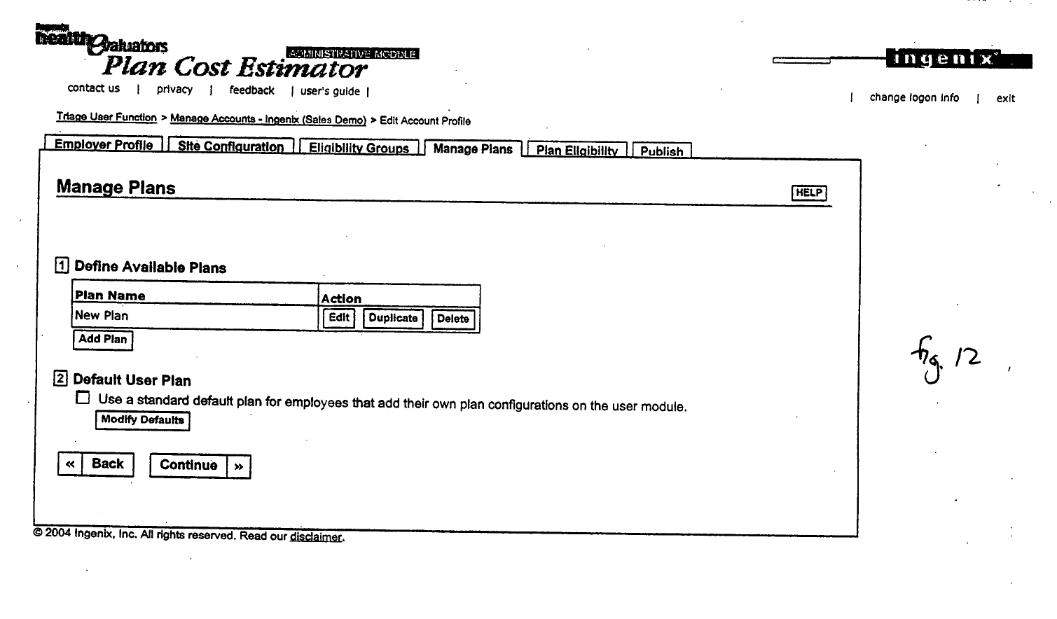

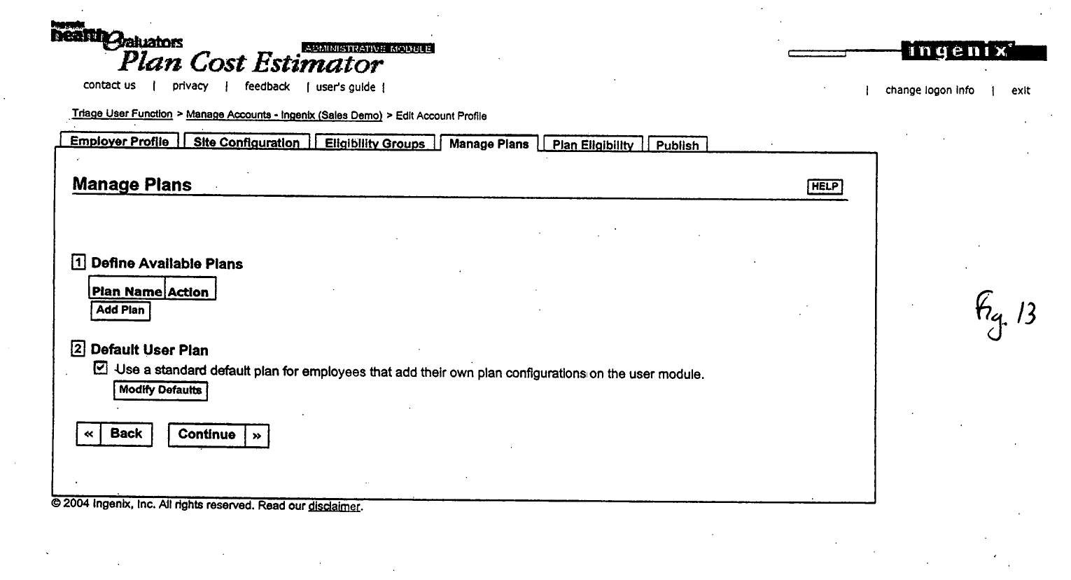

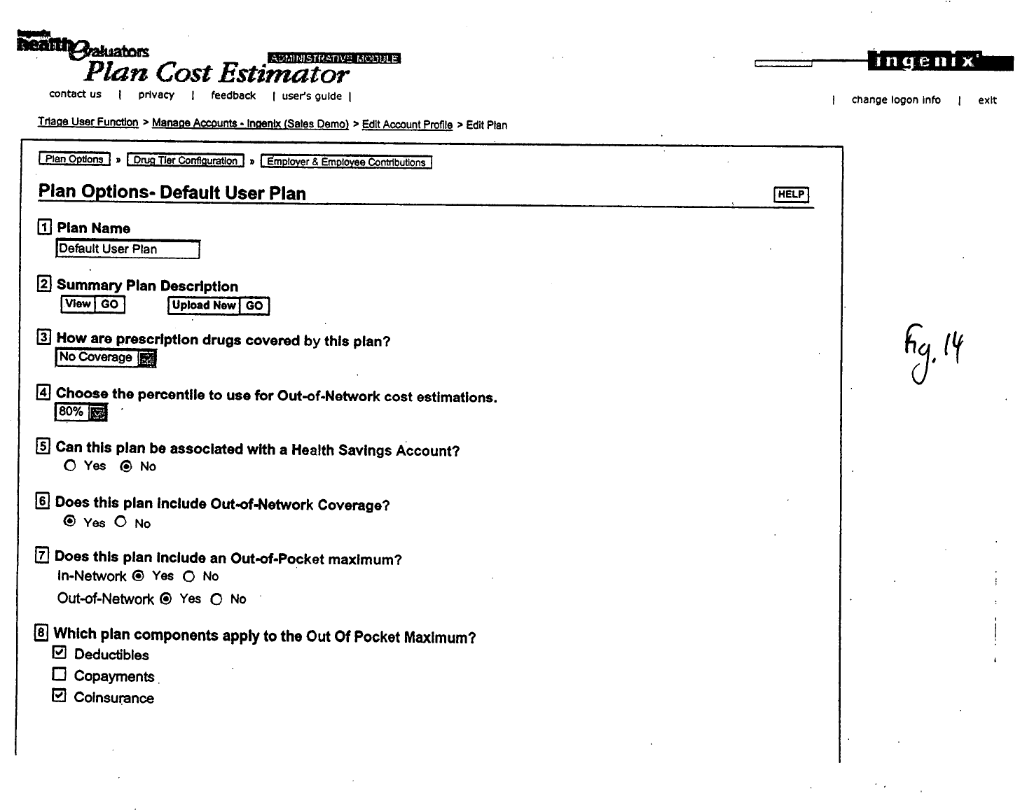

FIG. 9 illustrates an example display screen for an administrative interface where an administrator may specify various aspects of the employer profile, including a contact name, address, phone numbers, and the number of employees of the employer. In FIG. 10, site configuration information may be provided into the administrative interface. Selectable features include a welcome screen; a flexible spending account optimizer with the ability to specify a FSA limit; a health spending account optimizer; an option to display spouse text as “spouse/domestic partner”; enabling or disabling the display of employer premiums/contributions; a field to adjust the price of brand name drugs; a field to adjust the price of generic drugs; enable/disable the annual minimum and maximum fields, plan costs, and assumptions on the compare costs pages; and enable or disable activation and deactivation dates. Further, the administrative interface may provide a control or button for the employer logo to be uploaded, as well as custom language for the welcome screen, contact information and help language for display in the user module interfaces.

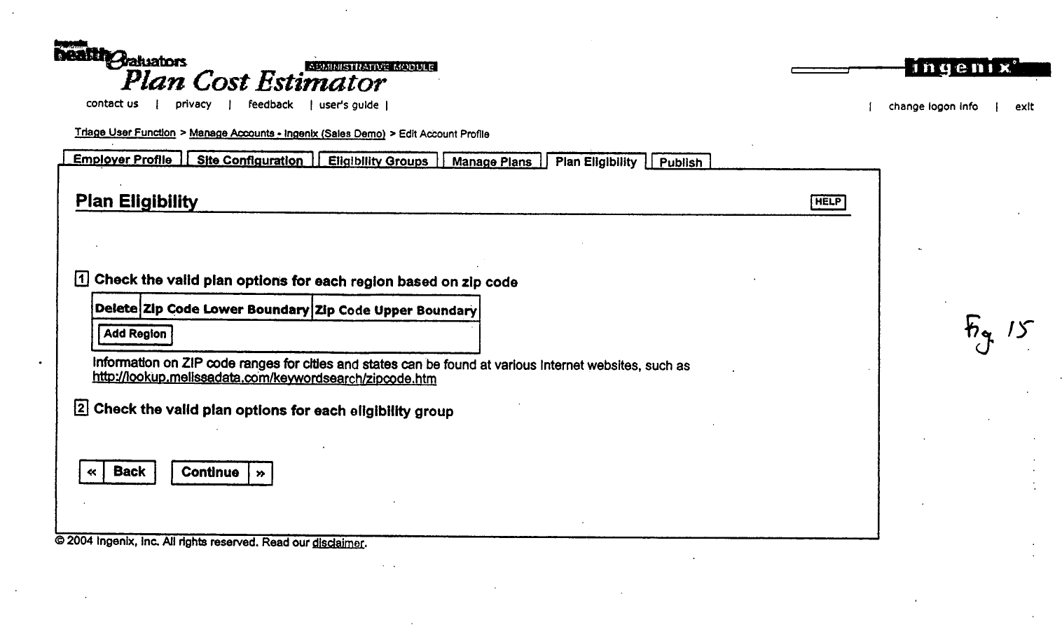

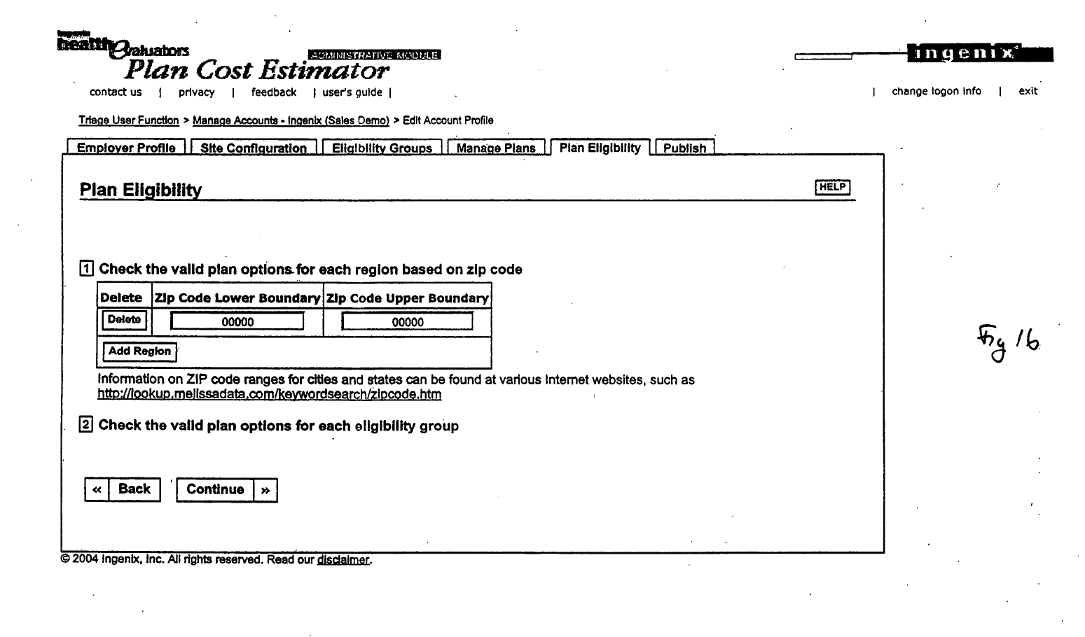

FIG. 11 illustrates an example of an administrative interface display screen for specifying eligibility groups. A field may be provided to define or add coverage tiers (such as coverage levels) that may include a description of a coverage tier, whether the spouse/domestic partner would be covered within this coverage tier, minimum dependents, and maximum dependents. The administrative interface may also include various eligibility variables, which may be specified by the administrator, with a checkbox for the administrator to indicate whether contributions and plan accumulators may vary depending upon the particular variable being defined.

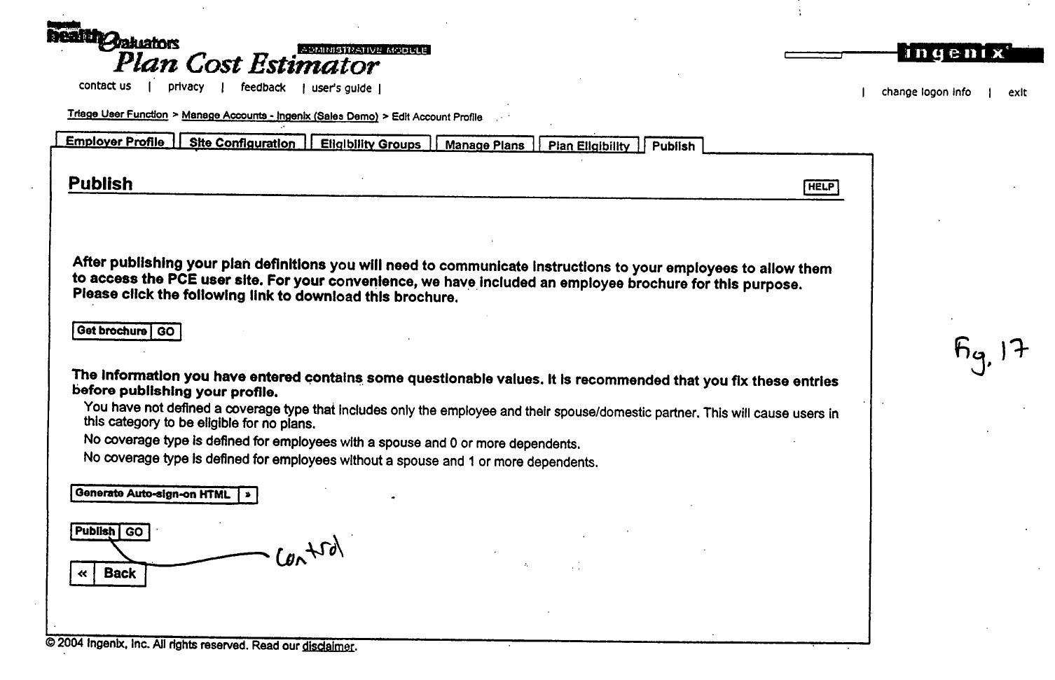

FIG. 12 illustrates an example of an administrative interface display screen for managing health plans. As shown in FIG. 12, an administrator may add new plans, or edit existing plans.

A default user plan may also be provided for employees that add their own plan configurations within the user module.

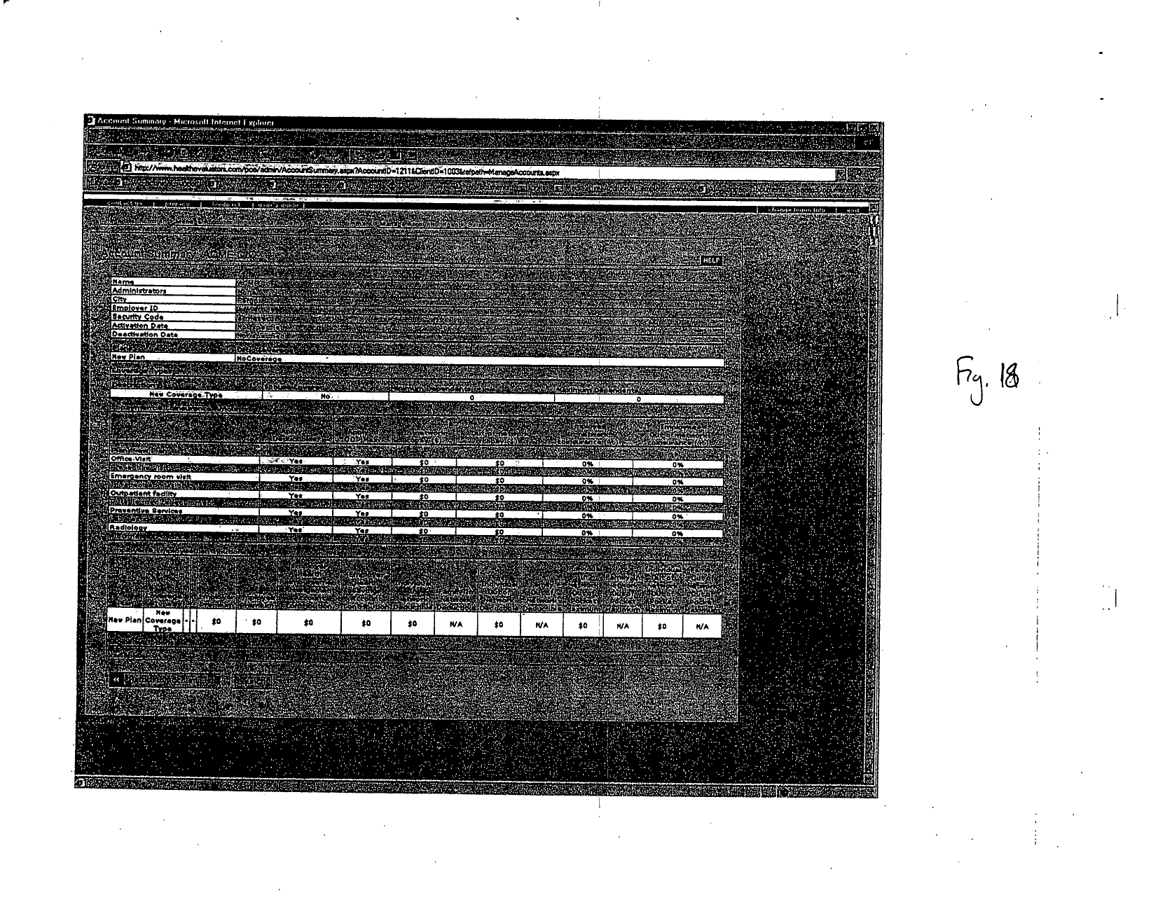

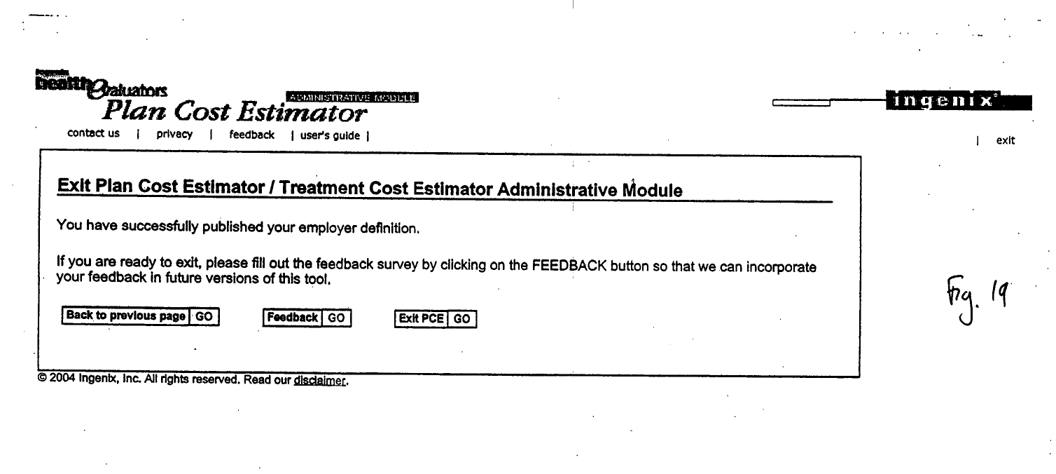

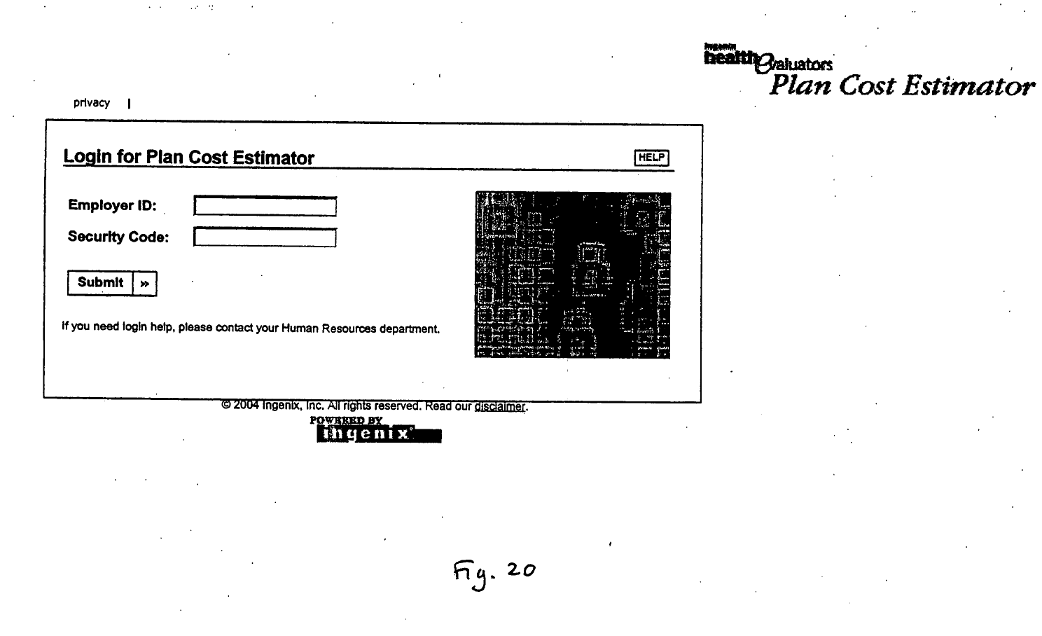

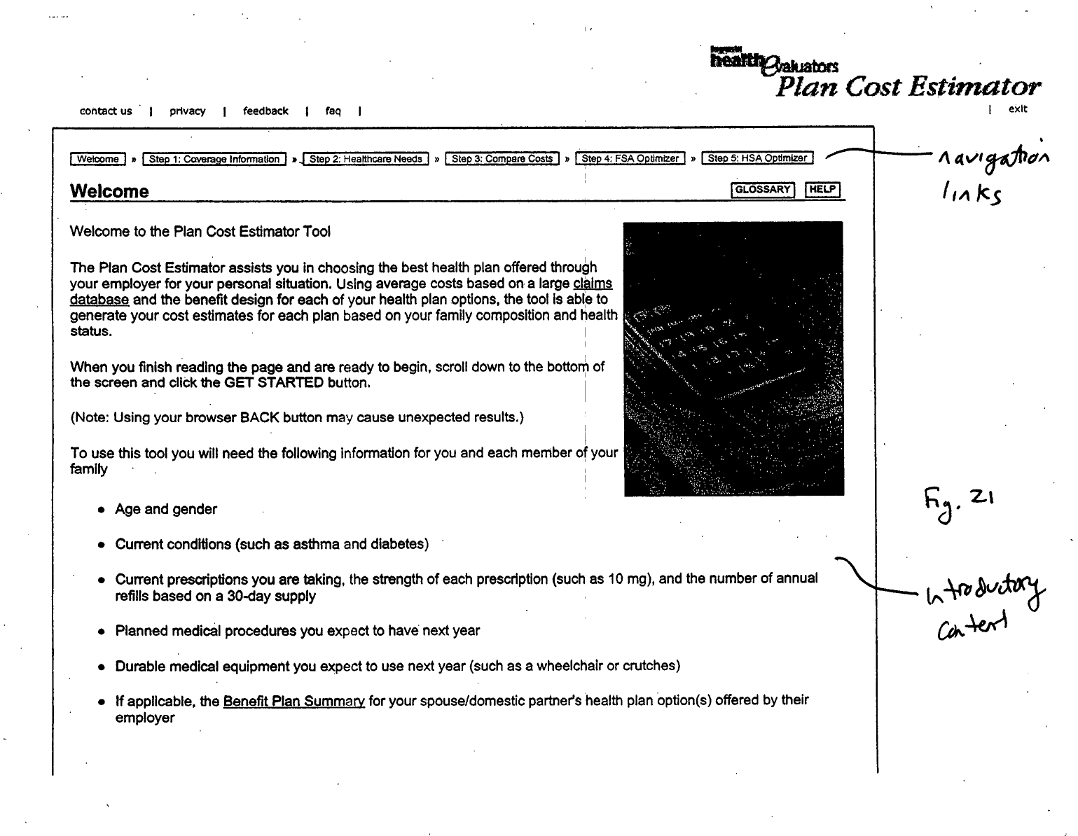

FIG. 13 illustrates an example of an administrator selecting a default user plan, and FIG. 14 illustrates various default user plan options, such as plan name, summary of plan description, whether prescription drugs are covered, a percentile to use for out-of-network cost estimations, whether the plan can be associated with a health savings account, whether the plan includes out-of-network coverage, whether the plan includes an out-of-pocket maximum (in-network or out-of-network), the ability to specify components (deductibles, co-payments, coinsurance) for application to the out-of-pocket as well as payable by health reimbursement arrangements account contributions, and the ability to enter plan co-payment amounts and coinsurance percentages.

In FIG. 15, an administrative interface may be provided with a plan eligibility condition wherein the administrator can specify a zip code lower boundary and upper boundary (i.e., a geographic region) that would be needed for participation in each health plan. Stated differently, the administrator can limit the geographic scope of the user module estimation tool to be within certain geographic regions/zip code ranges for specific health plans. Zip code lower boundaries and upper boundaries may be specified in fields as shown in FIG. 16.

Upon the administrator completing the configuration, a control may be provided so that the administrator can publish the plan definitions to the user module so that employees/users may begin estimating medical expenses under various health plans as configured by the administrator, in accordance with one embodiment of the present invention. FIG. 17 illustrates an example administrative interface including a control for publishing the plan definitions to the user module for use by employees/users. The administrative interface may also contain the ability to generate an account summary, and an example of such an account summary is illustrated in FIG. 18. An exit screen may be provided as part of the administrative interface, and an example of such is illustrated in FIG. 19.

FIGS. 20-40 illustrate various examples of display screens that may be utilized in user interfaces for the user module, in accordance with embodiments of the present invention. FIG. 20 illustrates an example of a login display screen that may be provided for a user, such as an employee. The login screen includes, in this example, a field for an employer ID, and a security code. Other fields may be utilized, such as the employee's name, e-mail address, or other unique identifier related to the employee. This login screen may be provided with graphics or icons that are unique to the particular company or entity for which an embodiment of the invention is being utilized, so as to provide a customized look and feel for the computer software.

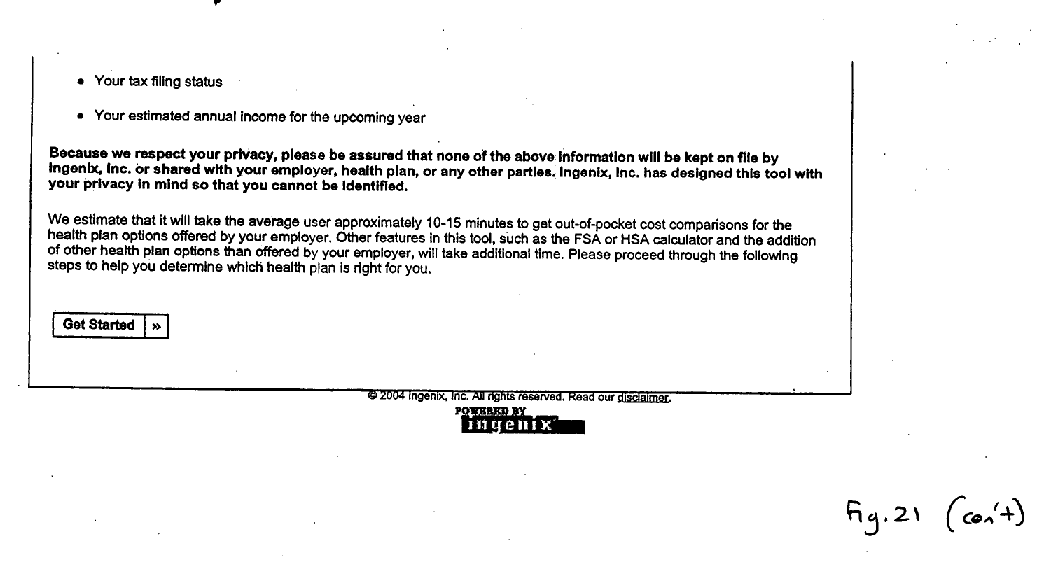

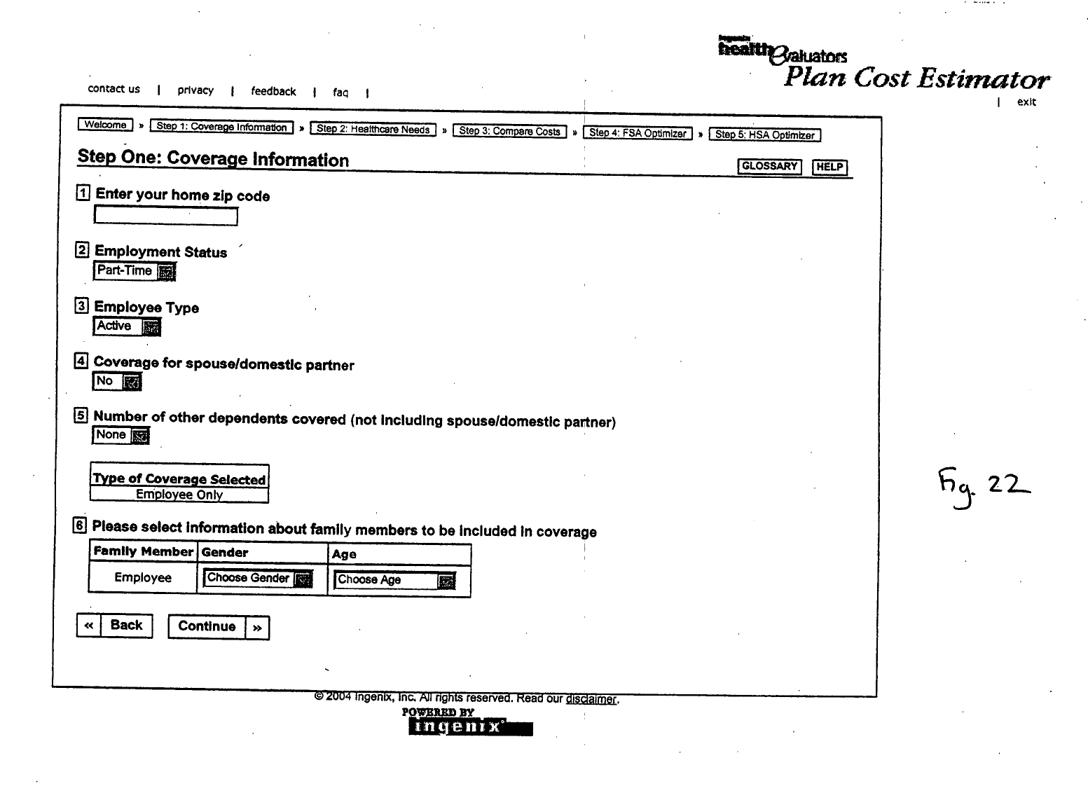

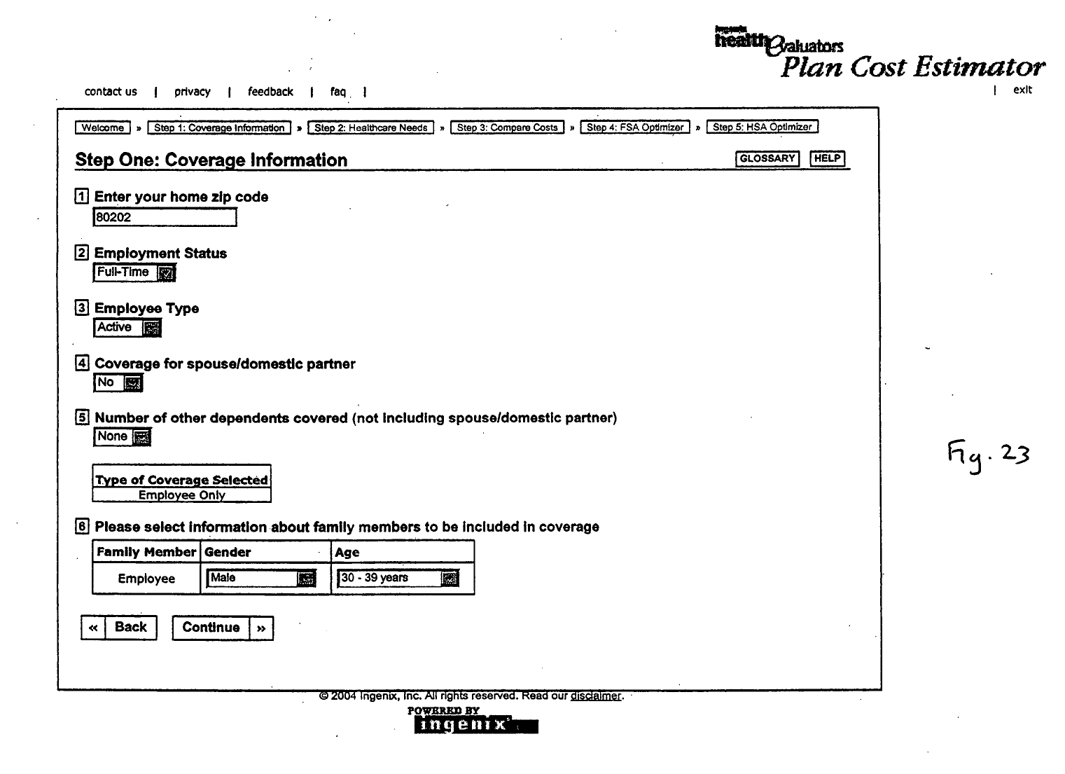

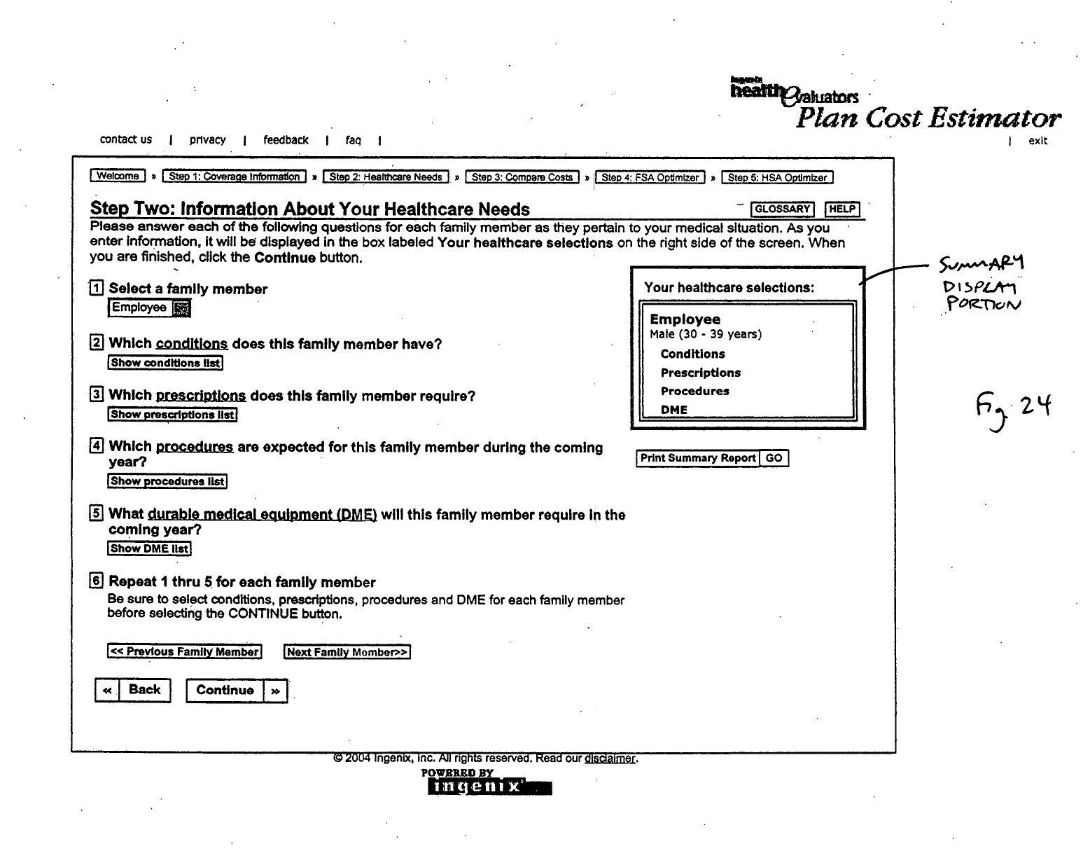

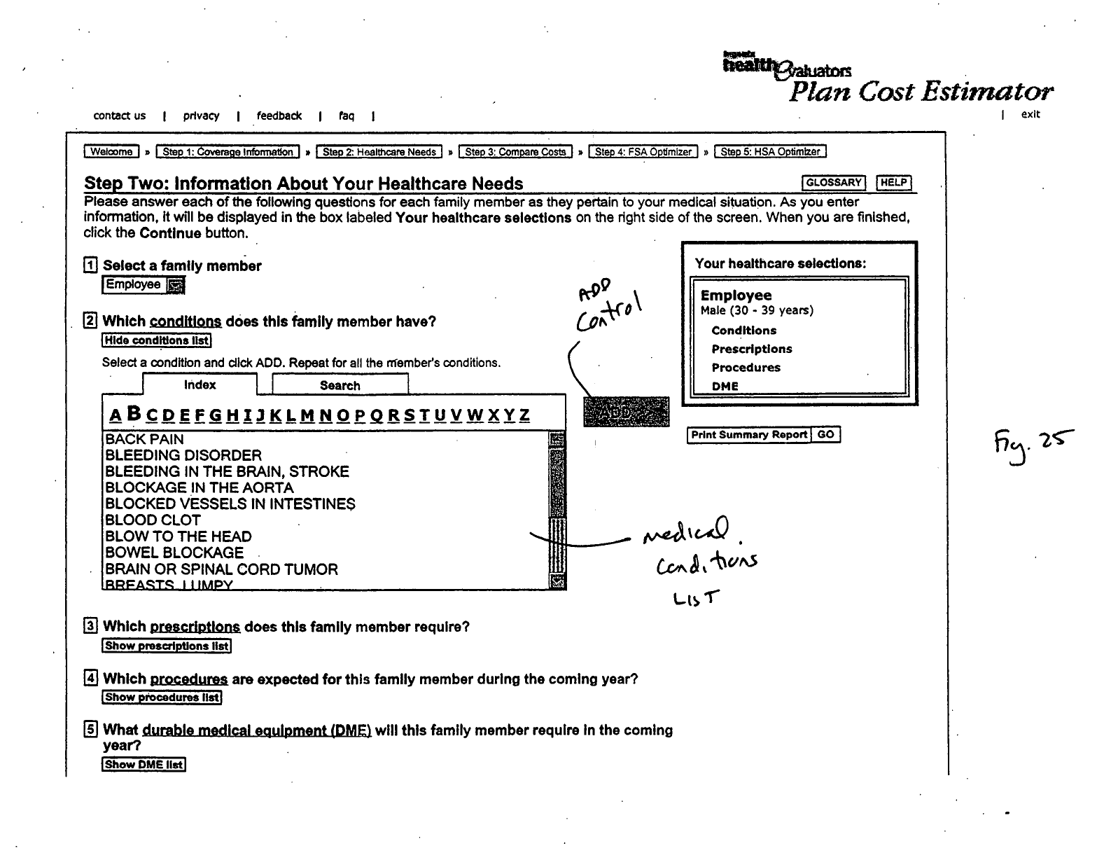

FIG. 21 illustrates an example display screen wherein an introductory page is displayed containing content which describes the basic introductory information and data that the interface will obtain from the user/employee. A set of navigation links may also be provided which can help guide the user through the various steps or main display pages of the user interface. In one example, the navigation links include a link for “Step 1: Coverage Information” which obtains various data fields relating to the user in order to help determine coverage; a link for “Step 2: Health Care Needs” which obtains information from the user relating to the user's health care needs; a link for “Step 3: Compare Costs” for displaying a cost comparison between different health plans given the information provided by the user in Steps 1-2; a link for “Step 4: Flexible Spending Account Optimization” which helps the user budget for flexible spending accounts; and a link “Step 5: Health Care Spending Account Optimizer” which provides information for the user to budget for a health care spending account.

FIGS. 22-23 are examples of display screens for obtaining various coverage information relating to the user/employee and the employee's family. As shown in FIG. 22, a user interface may be provided with fields for entry of the employee's home zip code, employment status (e.g., part time, full time), employee type (i.e., active, retired), coverage for spouse or domestic partner, number of other dependents covered (i.e., such as children), and information about each family member that will be included in the coverage, including the family members' gender and age range. In FIG. 23, an example of a particular scenario is provided for illustrative purposes only. In this example, a full time, actively employed male employee between the age of 30-39 years old, resides in a zip code of 80202, other details about this example will be provided as it relates to example display screens described below.

A graphical user interface may be provided with various fields to obtain information about the user/employee's healthcare needs, as well as the healthcare needs of the employee's spouse or other dependents covered. FIGS. 24-32 show example display screens for obtaining such healthcare information, in accordance with embodiments of the present invention.

Such information may be gathered on a person-by-person basis; stated differently, for each family member covered, the user interface may obtain healthcare information relating to that particular family member, and once that information has been obtained, the user interface can provide the user with the opportunity to provide healthcare information relating to other covered family members until the user interface has obtained healthcare information relating to all covered family members, in one example. For instance, the user interface in FIG. 24 may be provided with a field for selecting a family member. In one example, this field may include a dropdown menu where the user may select the family member, and the contents of the dropdown menu may be based upon the previous information provided by the employee/user with regard to FIG. 23 (i.e., coverage for a spouse/domestic partner, number of other dependents). Upon selecting the particular family member for which the healthcare information will be provided, a user interface may also provide a field for identifying or selecting the medical conditions that this family member has; a field for identifying or selecting the prescriptions that this family member requires, uses or will use in the next year; a field for identifying or specifying the medical procedures that are expected for this family member during the coming year; a field for identifying or specifying the durable medical equipment (DME) that this family member will require or utilize in the coming year. In one example, the user interface provides a list for the employee/user to select from in order to identify/specify the medical conditions, prescriptions, medical procedures, and durable medical equipment. The contents of this list may be maintained in a database and updated to keep these lists current.

In one example, the user interface may include a summary display portion indicating the selections that the user/employee has made thus far, as shown in the example of FIG. 24.

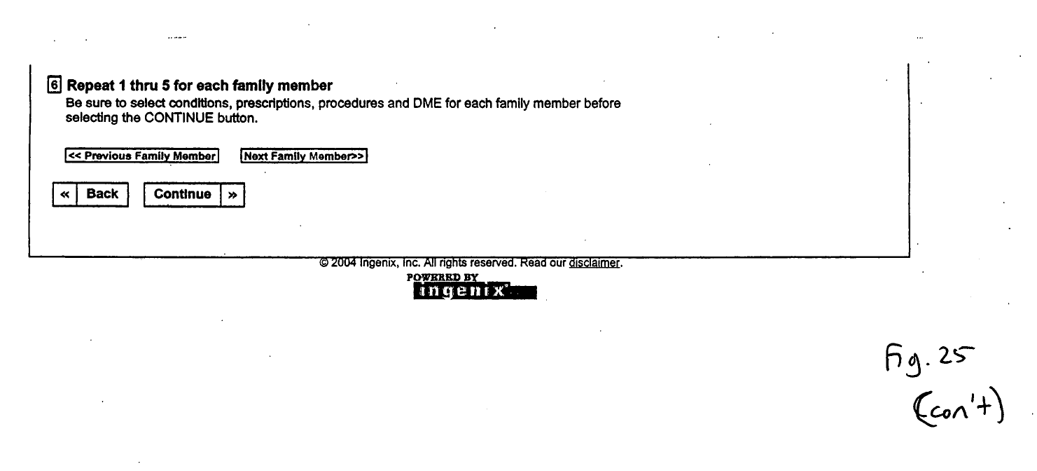

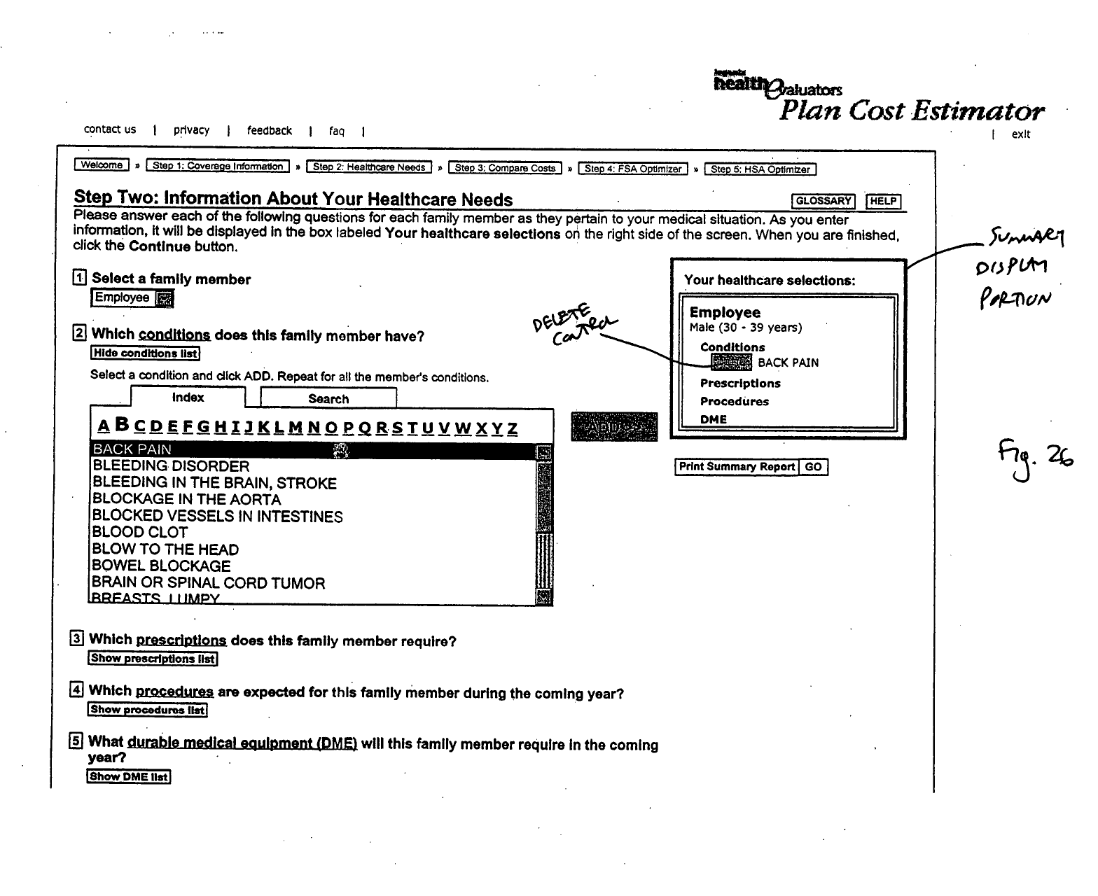

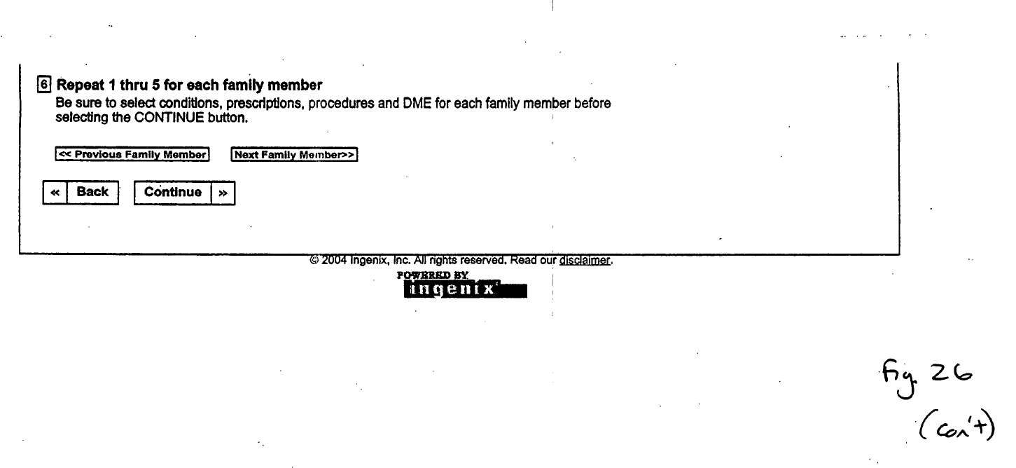

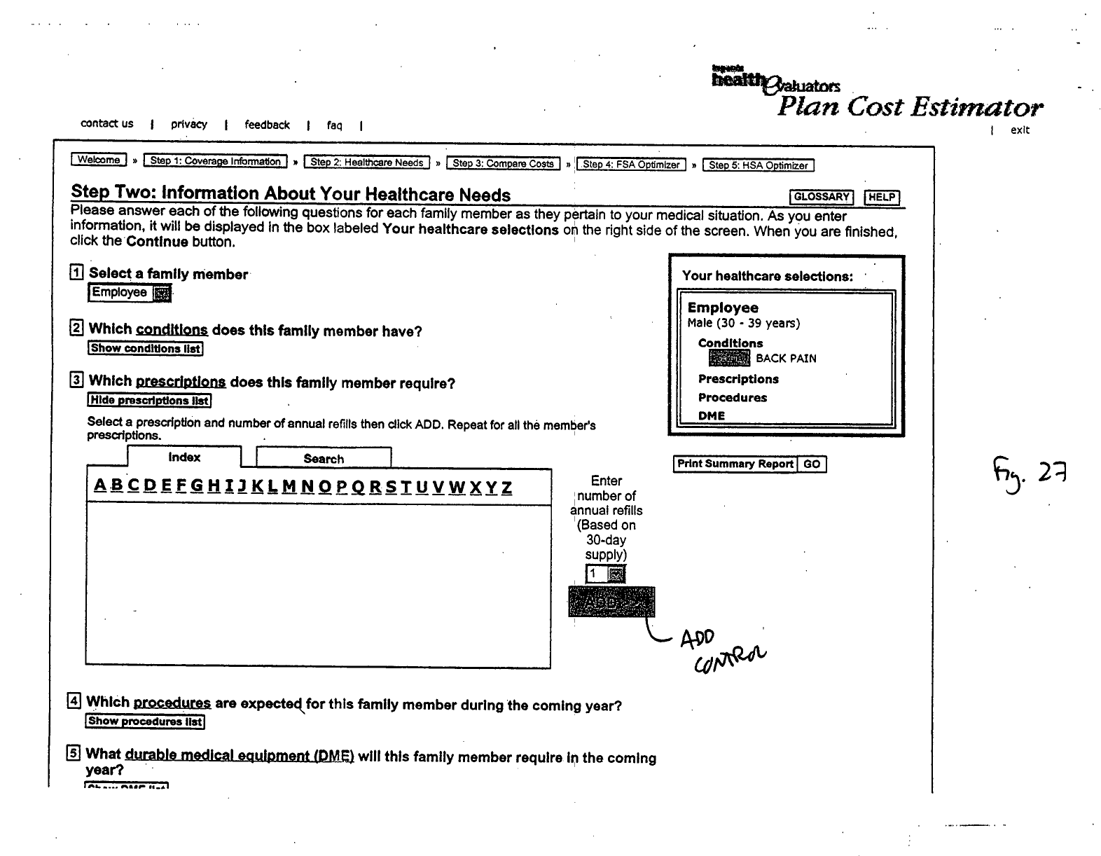

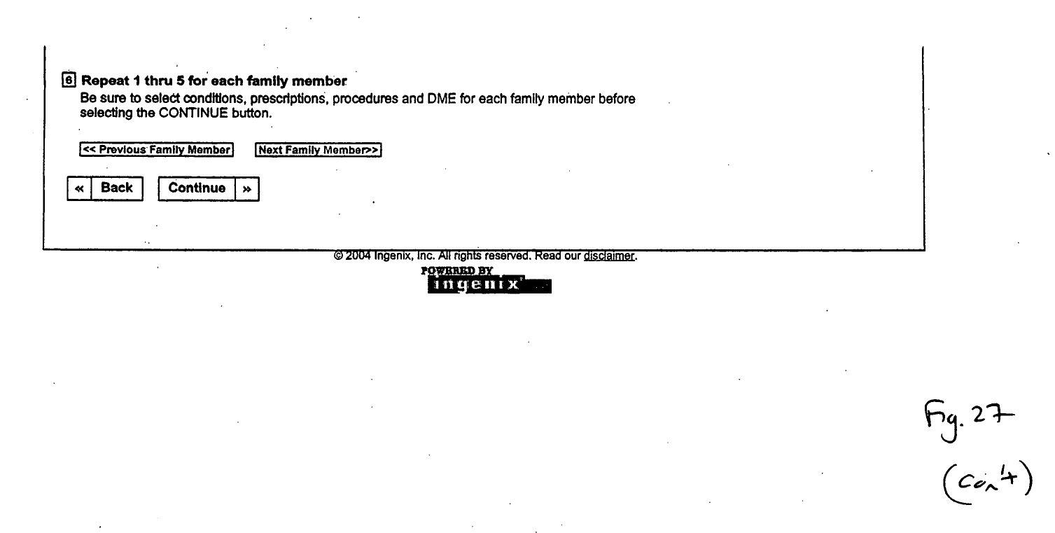

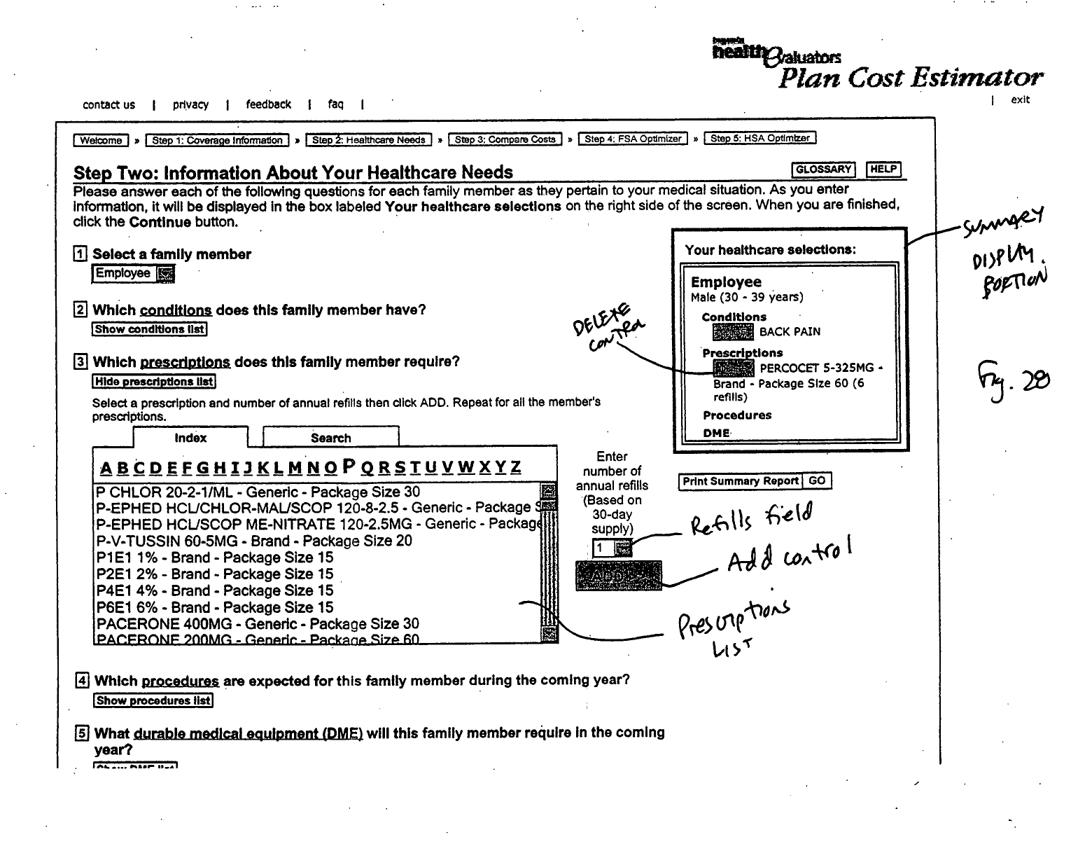

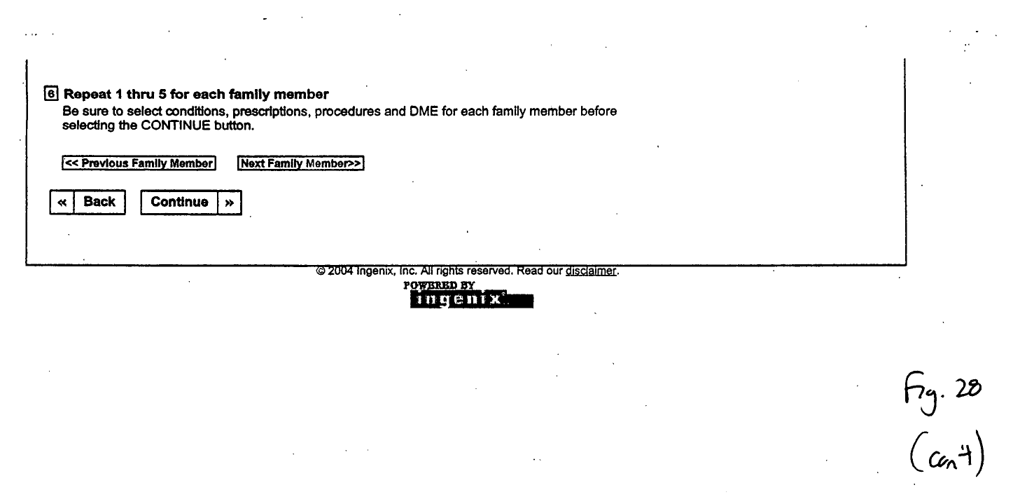

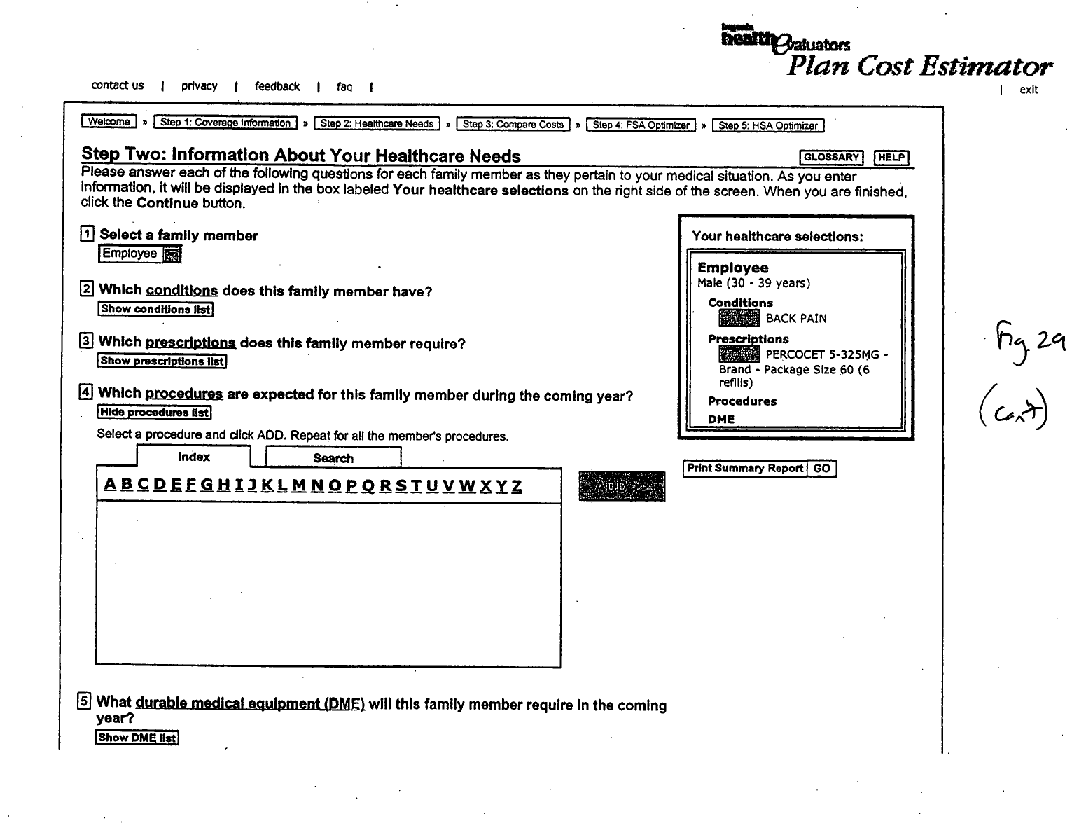

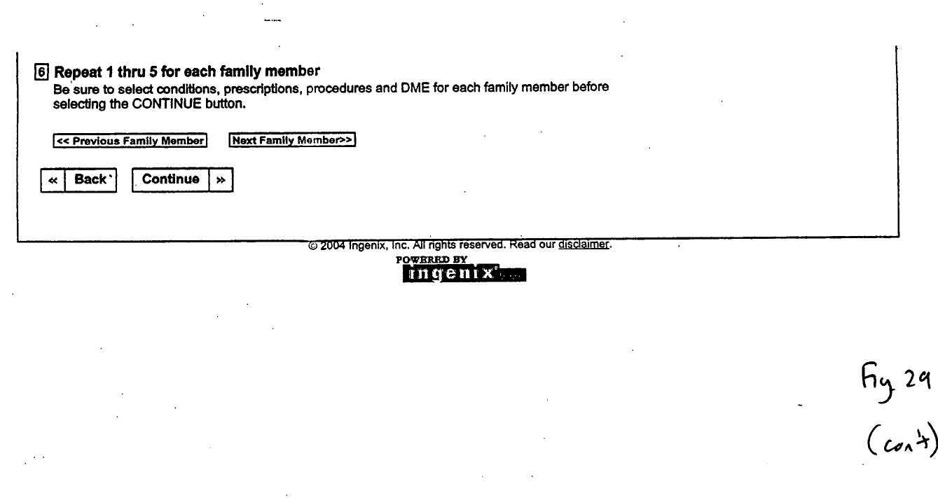

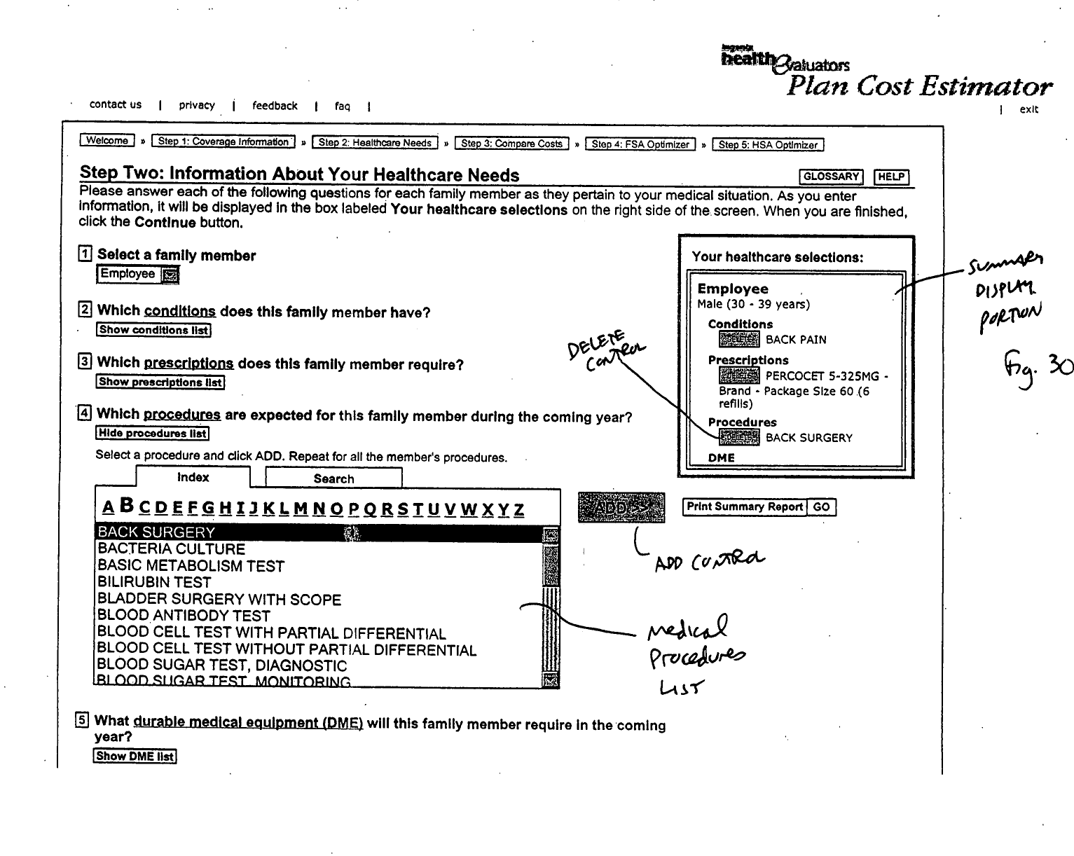

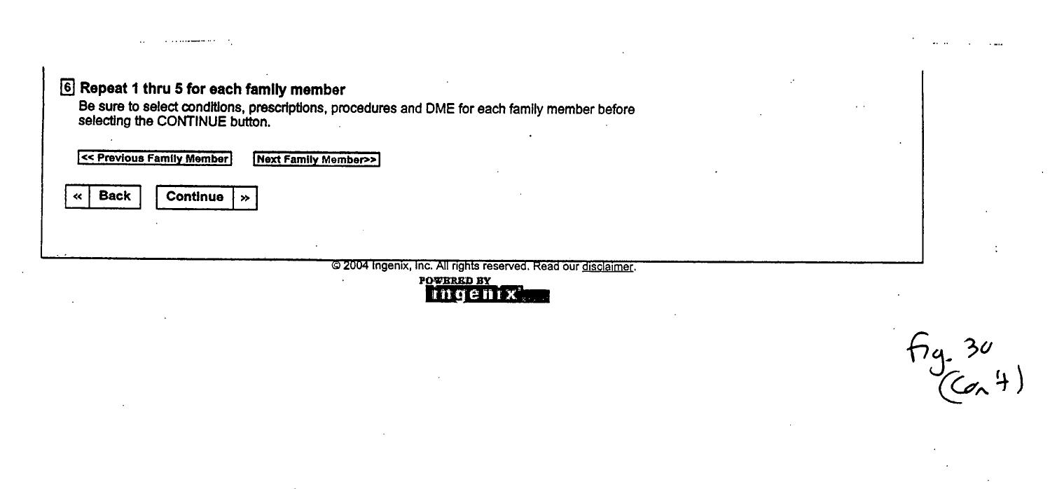

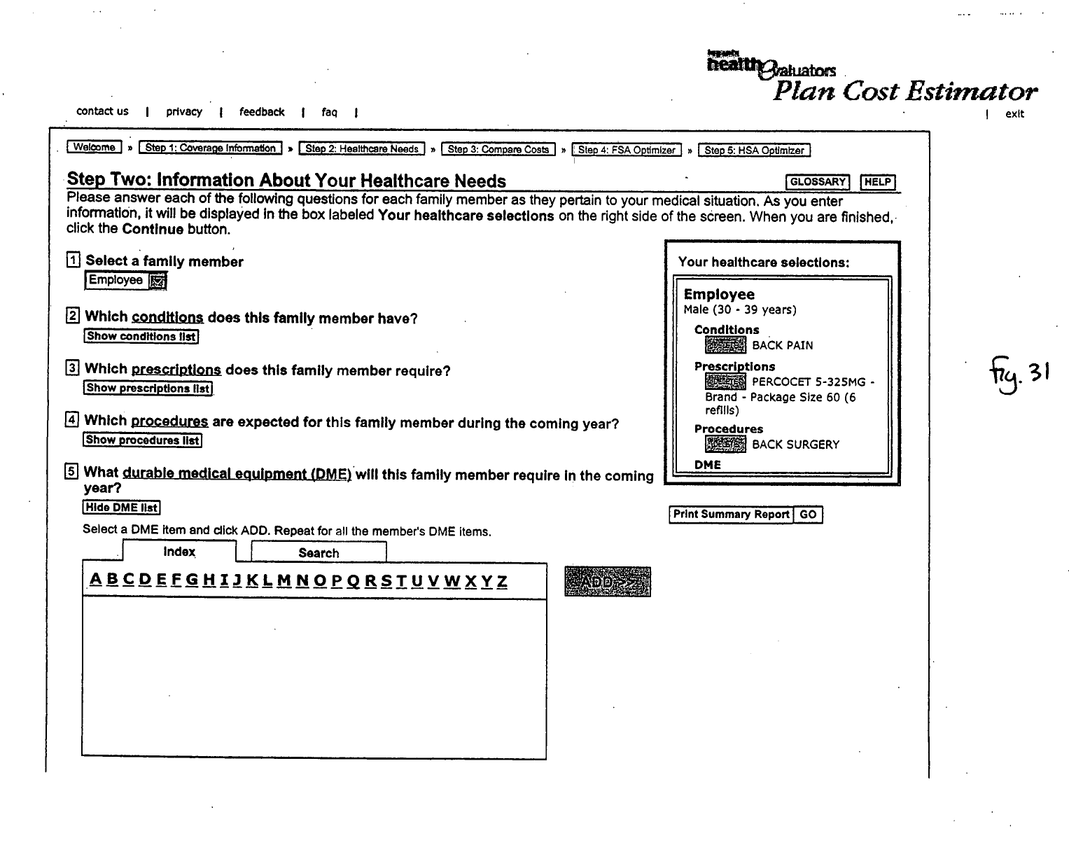

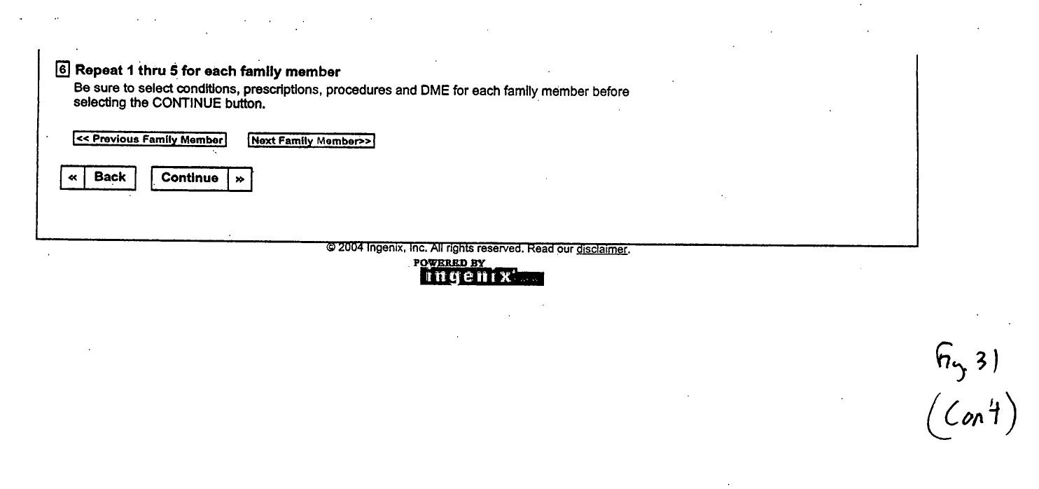

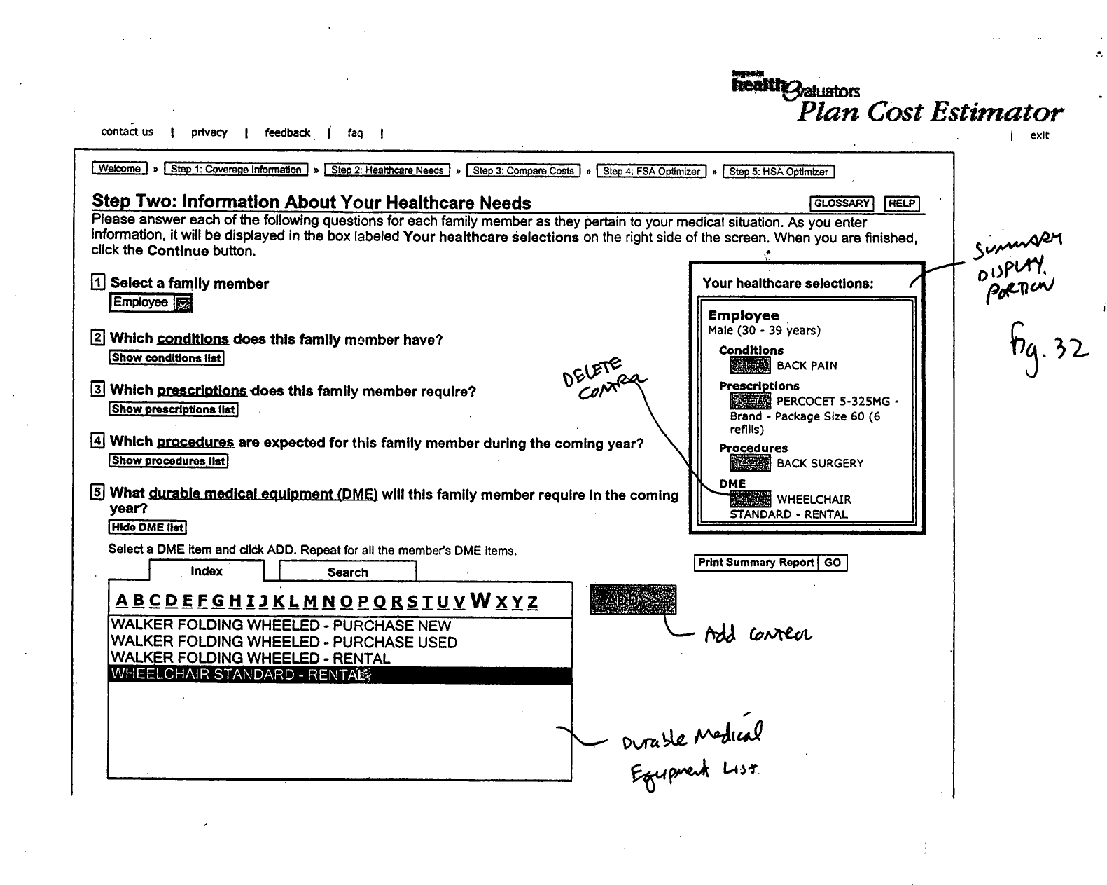

In FIG. 25, a list of medical conditions that the user/employee may select from are shown. In one example, the list may be presented in alphabetical order, with a alphabetical index for use of navigation. A search tool may also be employed to provide the user/employee the ability to search the list for words or phrases. A control or button may be provided so that once the user/employee selects a particular medical condition, that medical condition can be added, via the control, so that the medical condition is associated with the particular family member. In FIG. 26, for example, the medical condition of back pain has been associated with the employee, as illustrated in the summary display portion of the user interface. A control may be provided for deleting a particular condition in the event that the user erroneously selects an incorrect medical condition.

Medical conditions included in the list provided to the user may be created using historical claim data to assess the most common conditions occurring among patients. Alternatively, the list of medical conditions may be generated to include both commonly occurring conditions and those that are less common but very expensive to treat, or on any other basis desired by the administrator of the system.

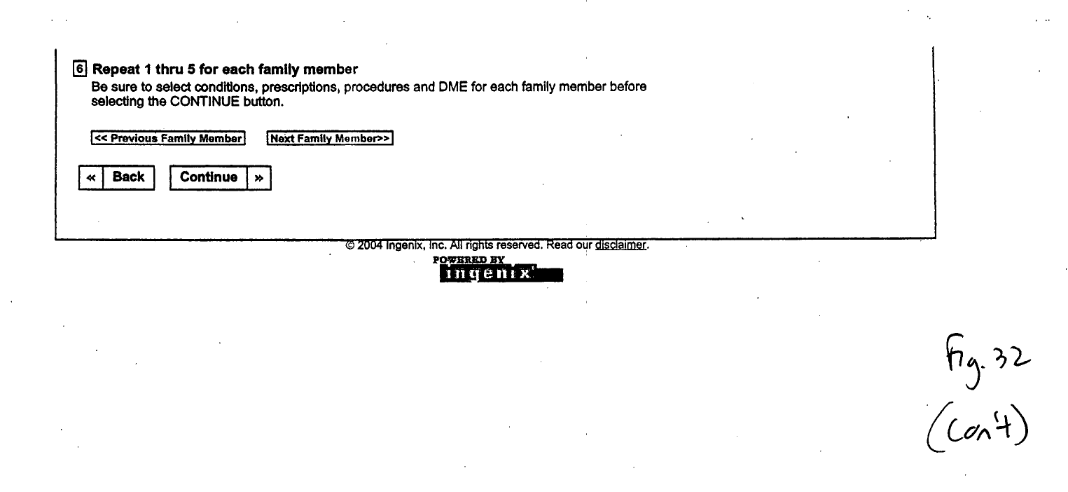

A prescriptions list may be provided in a similar manner as the medical conditions list described above. FIGS. 27-28 illustrate an example of a prescriptions list including an alphabetized list and index of prescriptions along with a search capability. A field may be provided for the user to specify the number of refills of a particular selected prescription (i.e., number of annual refills based upon a thirty day supply). In the example of FIG. 28, the prescription Percocet has been selected with six refills, as indicated in the summary display portion of the user interface, in this example. A delete control or button may be provided so that the user may delete prescriptions that have been erroneously selected.

The medications provided in the list illustrated in FIGS. 27-28 may be generated, for example, using historical health claim data to determine the most commonly used prescription medications. Alternatively, the list of medications may include all medications for which the applicable health plans provide coverage, all available medications, both prescription and over-the-counter medications, or any combination thereof as desired by the administrator of the system.

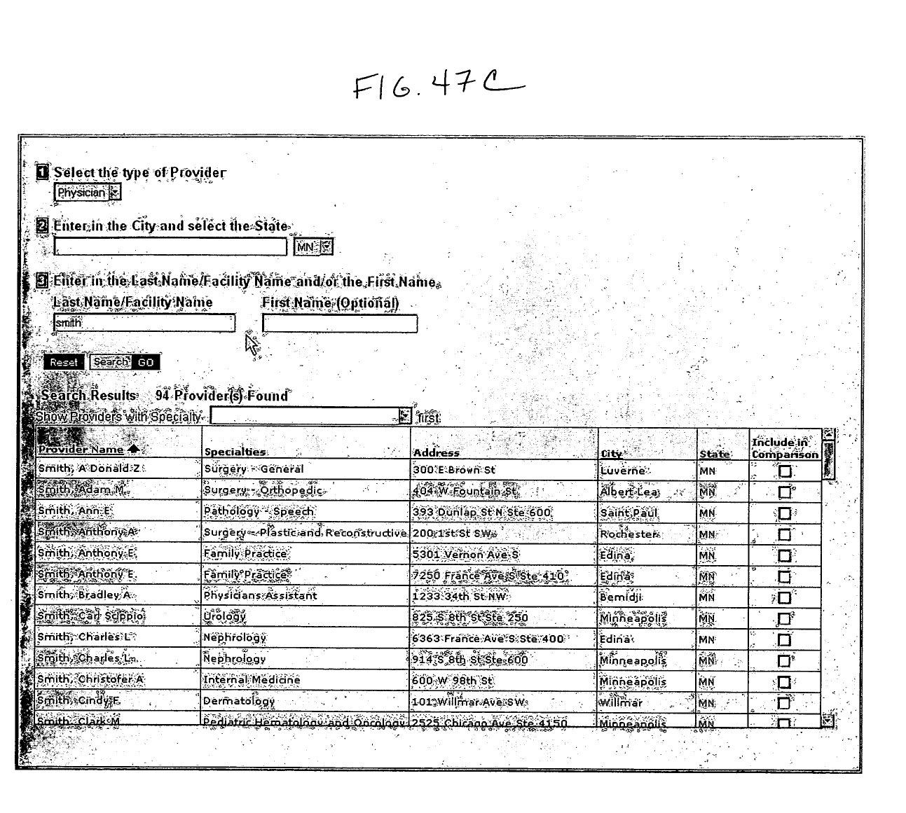

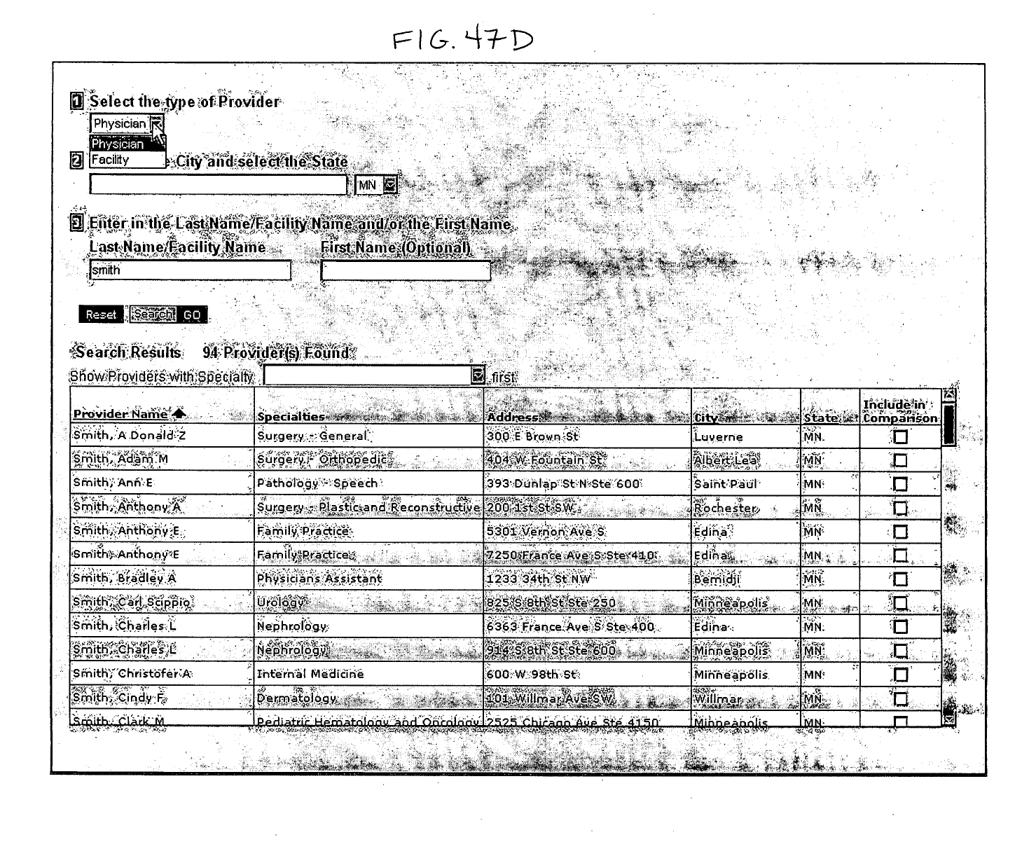

The user may also enter prescription cost savings options. An exemplary user interface for entering prescription cost savings is provided in FIGS. 46A-C. In FIG. 46A, the user may select the prescriptions list under item 3. In FIG. 46B, a list of prescriptions is provided, and, for each medication, the user may select the form of the medication (e.g., pill, liquid, inhaler, etc.), the strength (medications may come in a variety of doses), the count or quantity of medication to be ordered, the number of prescriptions per year, and select from available prescription cost savings options. For example, the user may save money on a medication by ordering it through the mail, ordering a generic version of the medication, and/or opting for pill splitting (ordering pills in a higher dose and then cutting them into the desired smaller doses). For each medication, the applicable prescription savings options may shown in regular font, highlighted, or otherwise indicated as available, while options not available for the specific medication are displayed in lighter font, not displayed, or otherwise indicated as not available. In FIG. 46C, once the user has entered the required prescription information and clicked “ADD,” the prescription information is displayed in the “Your healthcare selections” summary box on the right side of the user interface.

A medical procedures list may be provided in a manner similar to the medical conditions and prescriptions list described above. An example of medical procedures is illustrated in FIGS. 29-30. An alphabetized list of medical procedures, along with an index and a search capability, may be provided with an add control in order to associate particular medical procedures with the covered family member. As shown in FIG. 30, in this example, the medical procedure of back surgery is associated with the employee male, as shown in the summary display portion of the user interface. A delete control may be provided so that the user can delete any erroneously selected medical procedures that have been associated with the family member.

Medical procedures included in the list provided to the user may be created using historical claim data to assess the most common procedures undergone by patients. Alternatively, the list of medical procedures may be generated using a list of diagnostic and treatment codes (such as DRG codes published by the American Medical Association), or on any other basis desired by the administrator of the system.

A searchable list of durable medical equipment may be provided in a similar manner as described above with regard to the medical conditions list, prescription list, and medical procedure list. FIGS. 31-32 illustrate an example of durable medical equipment lists. As shown in FIG. 32, an alphabetized list of durable medical equipment may be provided, along with an alphabetized index and search capability, and an add control or button so that the user may associate particular durable medical equipment with a particular family member. Once some durable medical equipment has been associated with a particular family member, the selection is indicated in the summary display portion. A delete control is provided so that the user may delete any erroneously selected durable medical equipment.

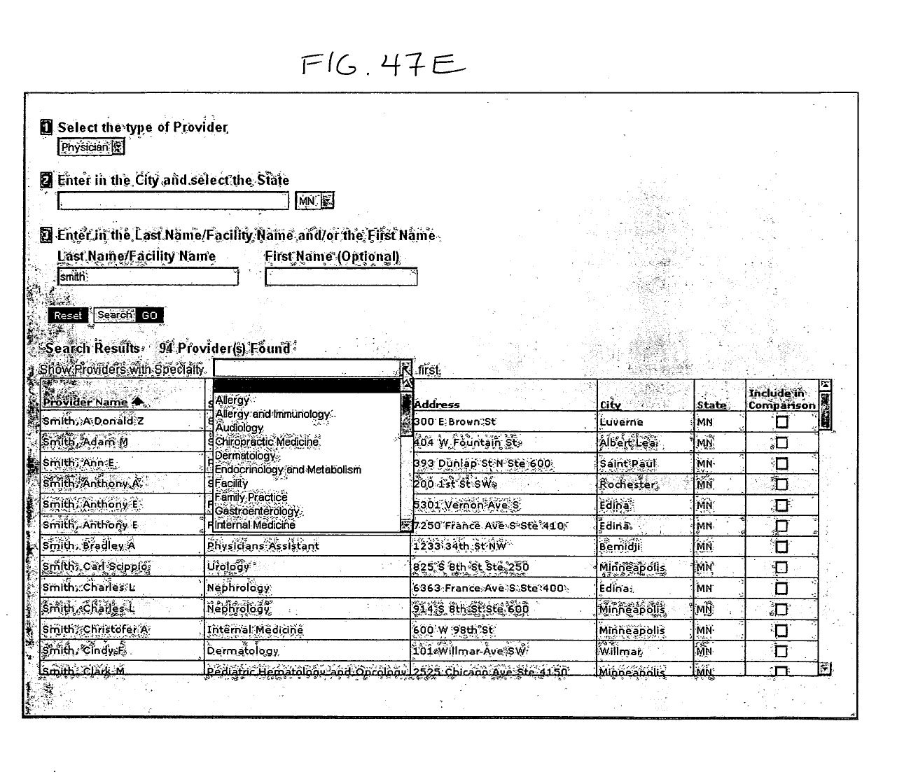

The user may also enter health care provider selection data, such as provider preference information, as illustrated with reference to the exemplary user interface shown in FIGS. 47A-E. In FIG. 47A, the user may select to find providers that they are interested in using during the coming year by clicking on “Find Providers” at item 1. In FIG. 47B, the user enters the type of provider (e.g., physician or facility), the location of the providers, the last name or facility name of the provider, optionally the provider's first name, and then initiates the search. The results of the search are displayed in FIG. 47C. An exemplary interface for entering selection options for provider type (physician or facility) is illustrated in FIG. 47D. An exemplary interface for selection of a provider specialty is illustrated in FIG. 47E. Once the search results are displayed, the user may enter health care provider selection data by checking the box associated with the providers the user wishes to include in the health plan cost estimator analysis.

Historical data may also be used by the system to automatically provide default medical condition and procedure data, prescription data, and/or DME data for the user. For example, the system may use the past year's claim data for the user to identify chronic conditions and established procedures, prescriptions, and or DME to automatically populate the user's profile with this data. As a result, the user does not need to reenter this data each year for purposes of assessing health plan costs. The user may also modify the data generated from the historical data as desired, for example, if the user no longer suffers from a condition or no longer takes a medication. Also, as a result of using historical data to automatically populate a user's profile, the user is less likely to forget to enter information and will obtain a more accurate estimate of health plan costs.

The system may also use a user's historical claim data to modify the prototypical costs for given procedures. In general, the cost of each procedure or condition is estimated based upon a prototypical patient. However, actual historical claim data for an individual patient may be used to assess the costs of the procedure or condition for the individual patient. As a result, the costs of treatments and procedures used by the system may be modified to more accurately estimate the healthcare costs for the individual patient.

User interfaces may be provided to display comparisons of the estimated health care costs for the employee/user under different healthcare plans. The comparison of estimated health care costs may be based upon the inputs provided by the user/employee in one or more of the fields shown in the prior examples of graphical user interfaces. The estimates may also be based upon preventative care guidelines, as well as geographical considerations, as described above. The estimated expenses, including the employee premium and the out-of-pocket expenses (estimated and maximum) can also be based in part upon the particular plan coverage details which were obtained for each plan involved in the estimate.

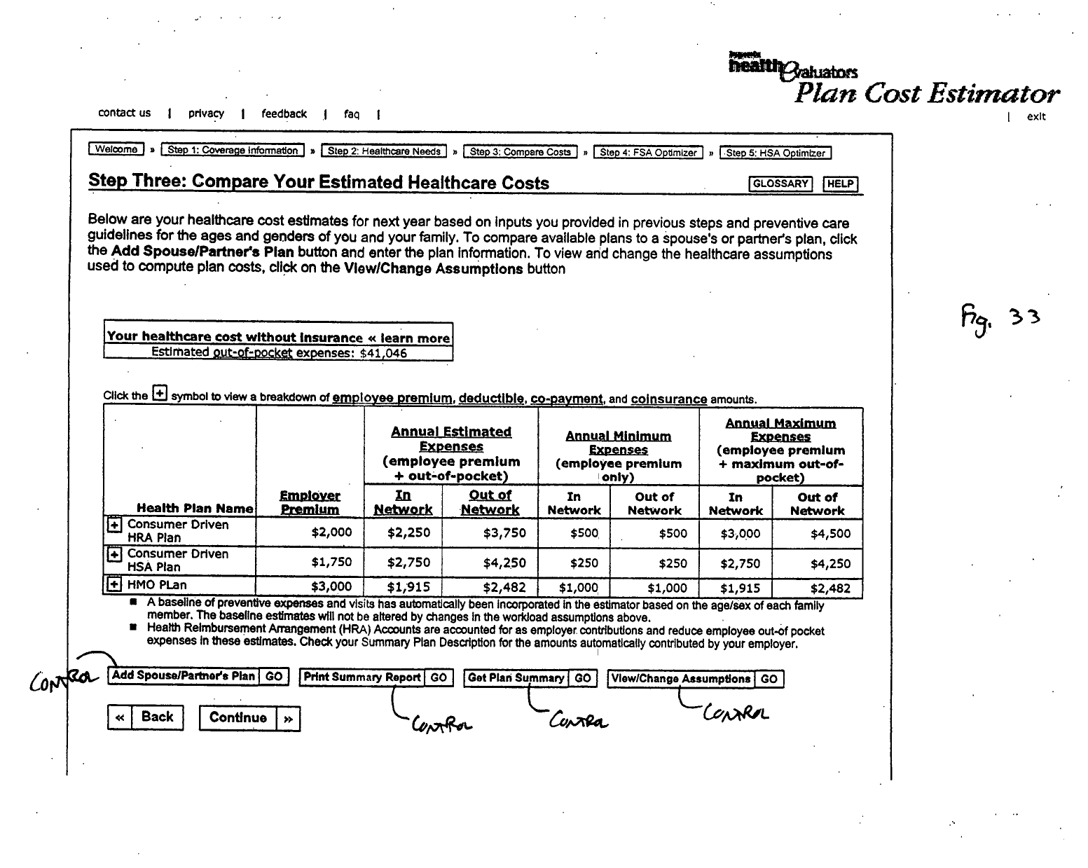

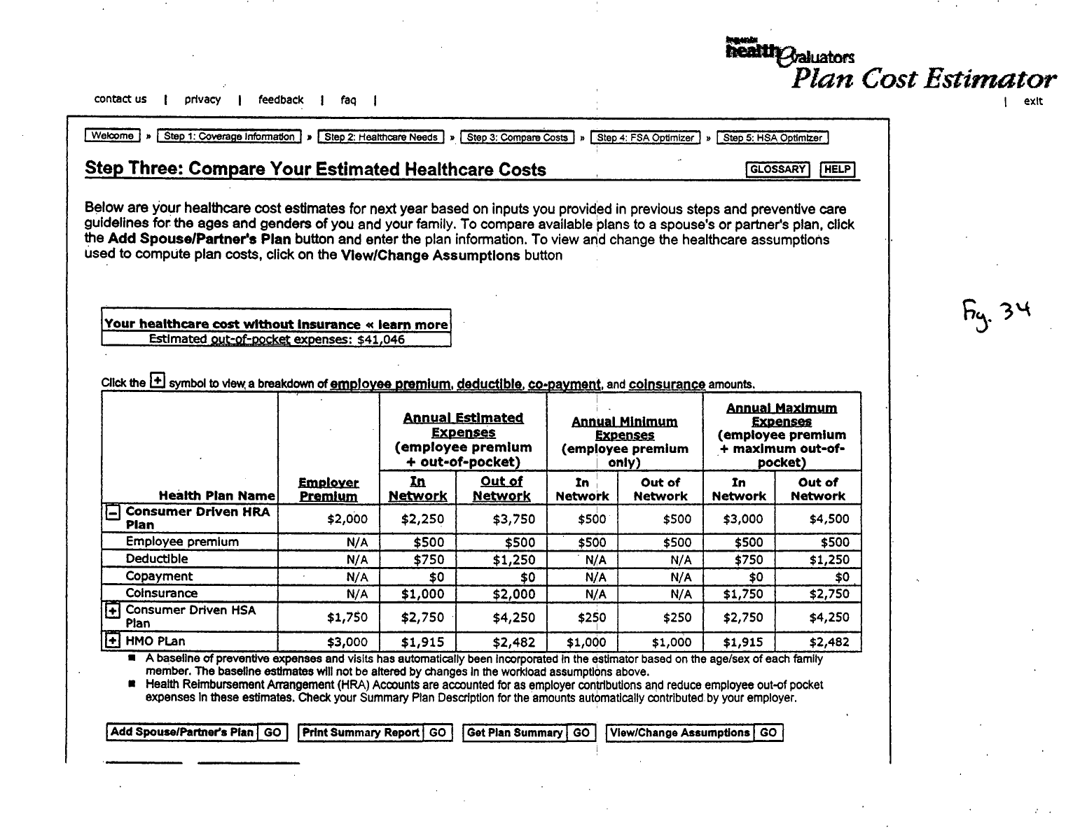

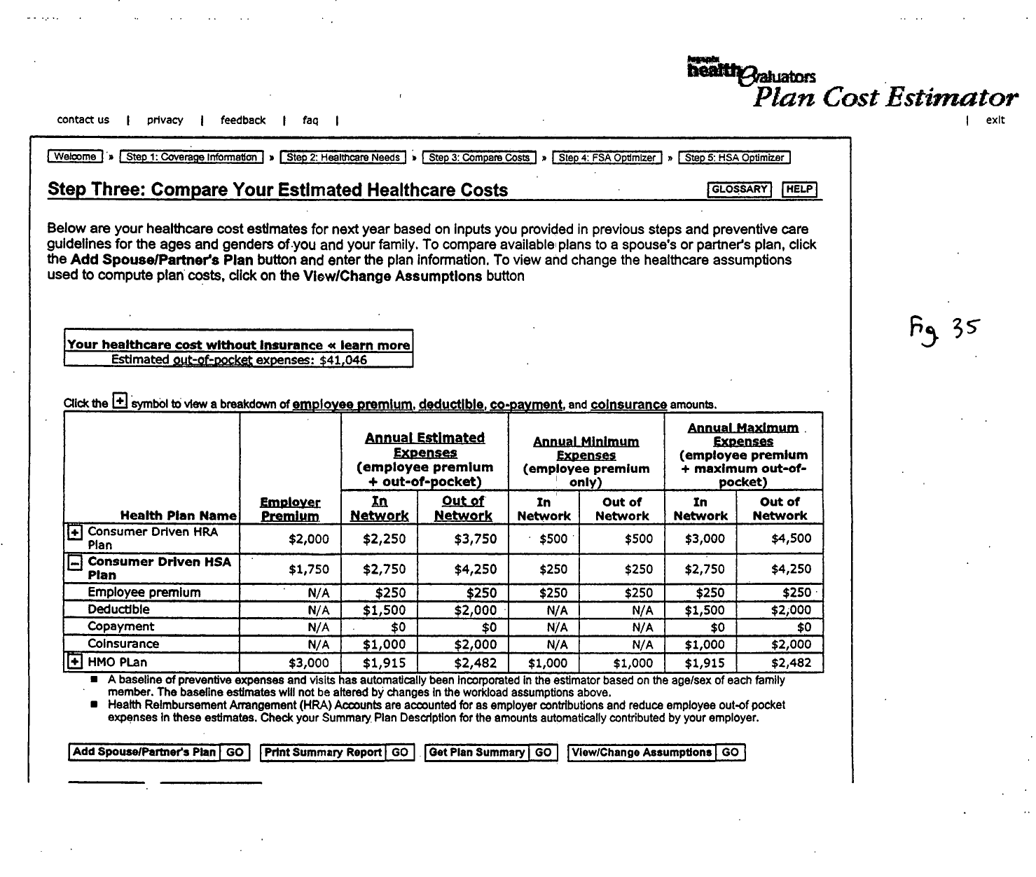

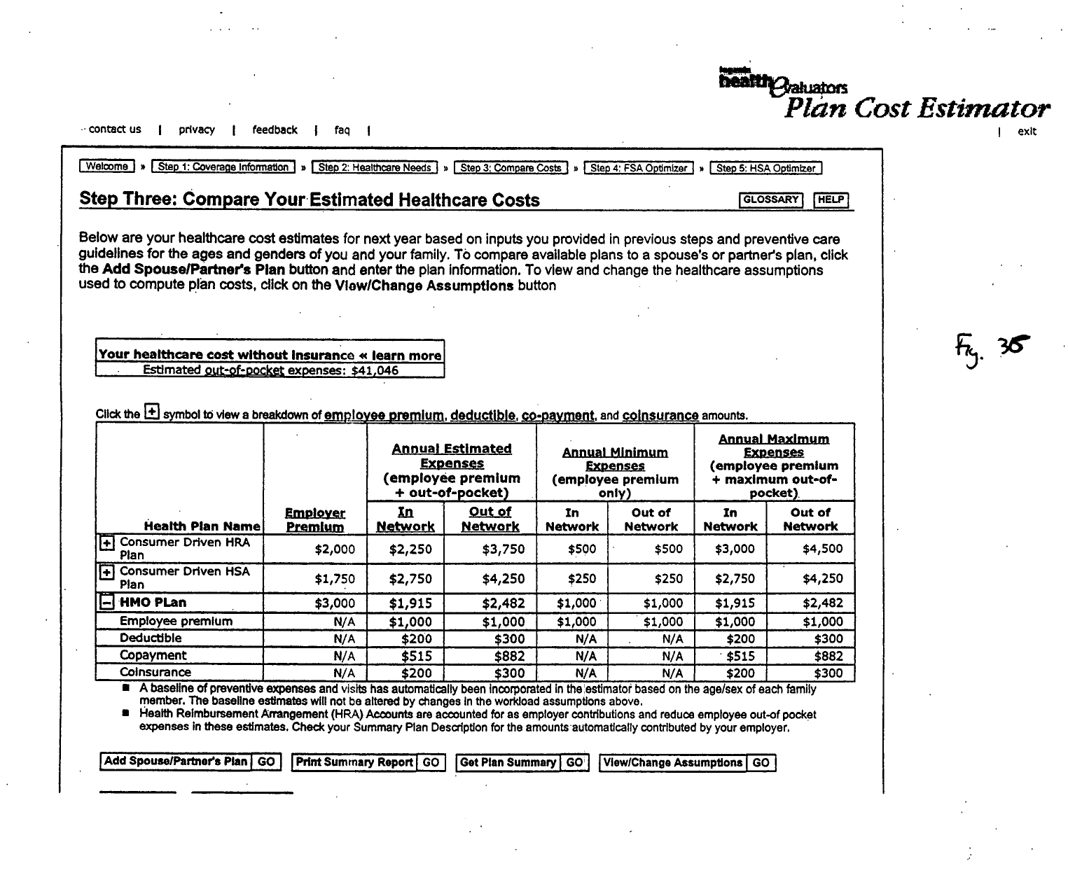

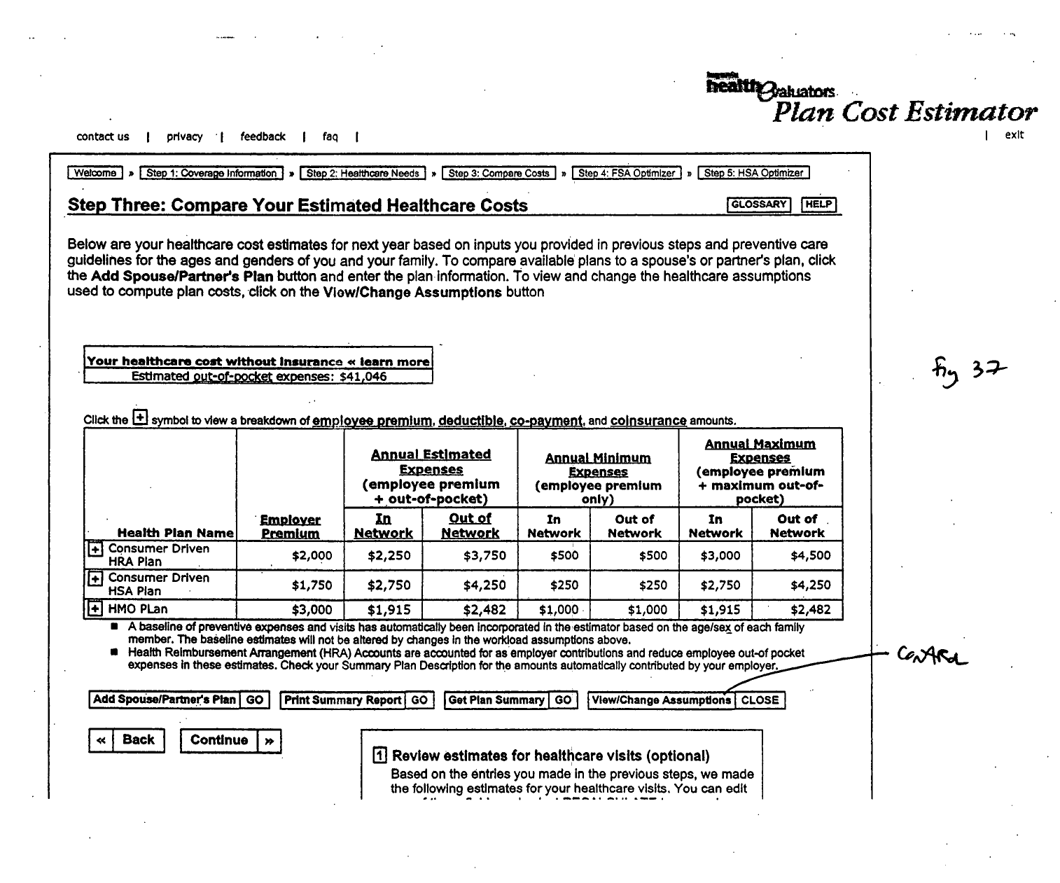

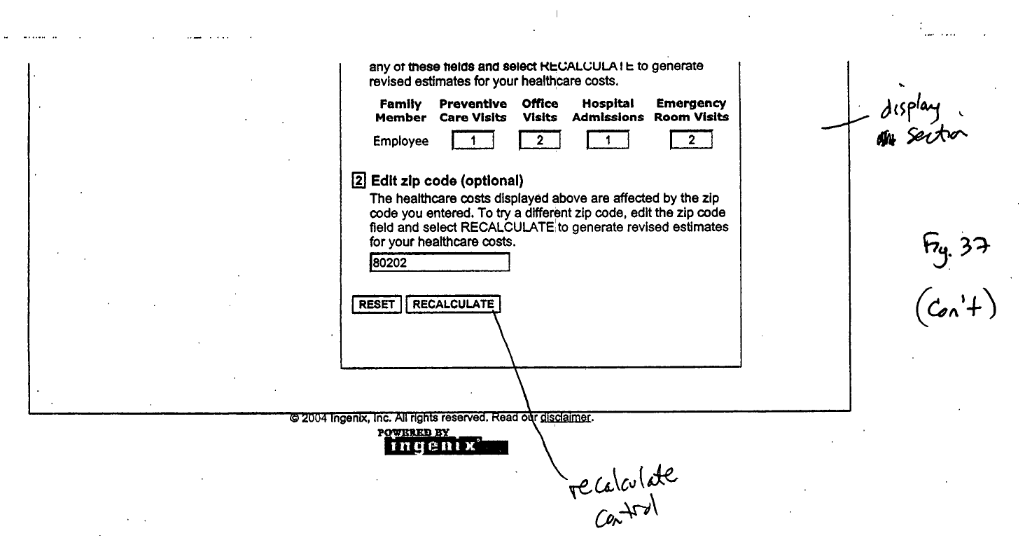

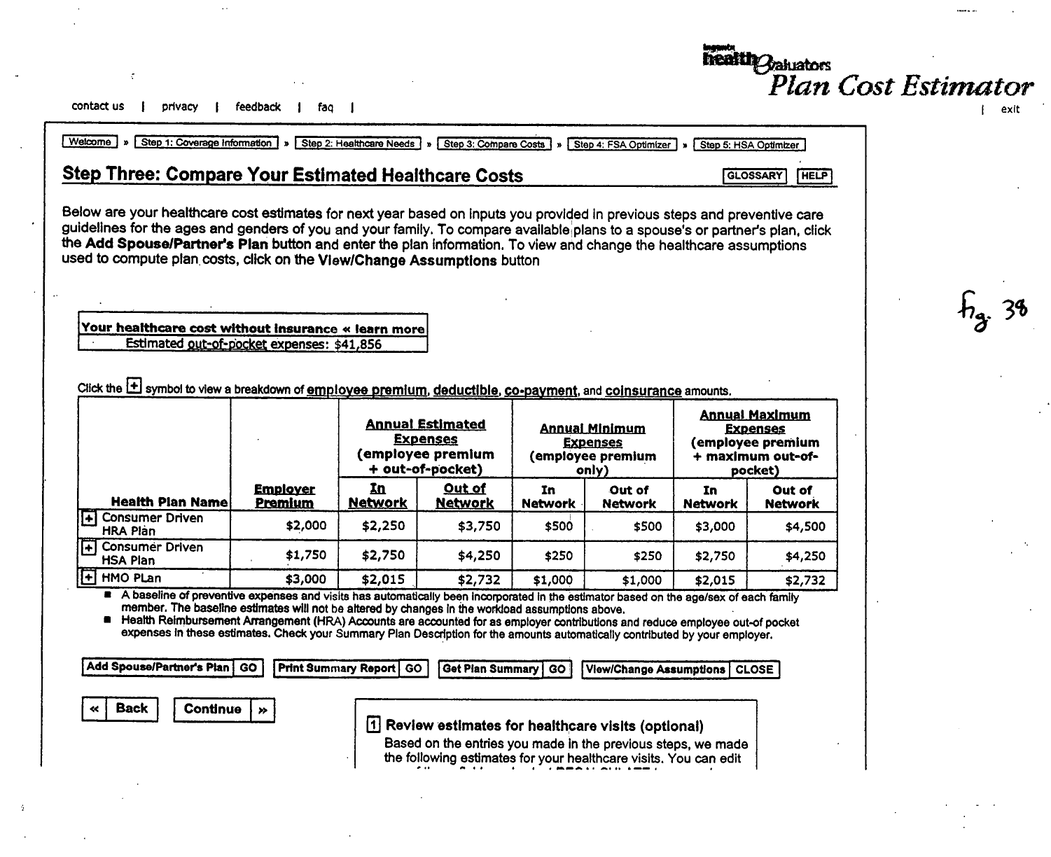

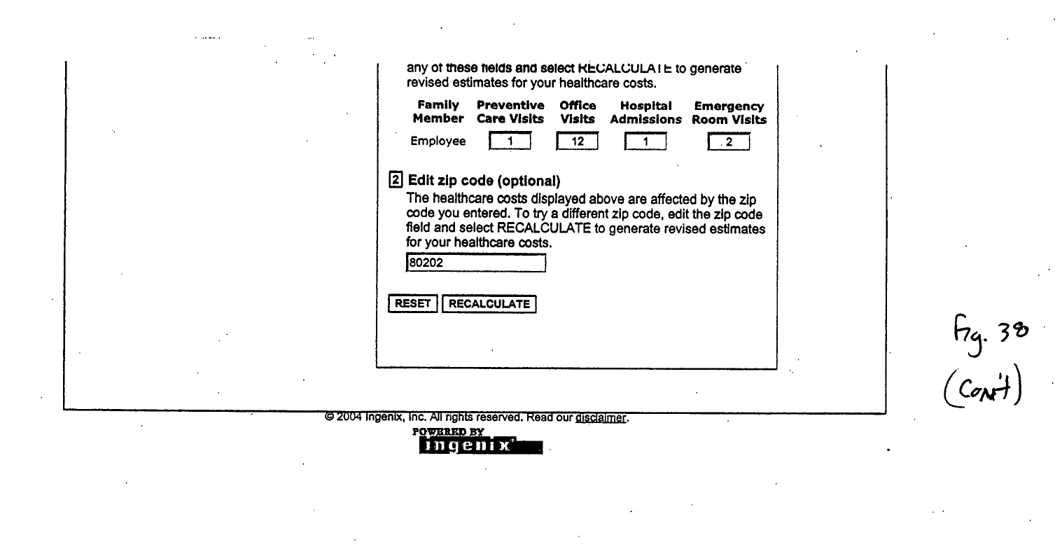

As shown in FIG. 33, a user interface may be provided with a field for displaying the estimated healthcare costs without insurance. In one example, this field contains the amount of total estimated healthcare expense for the employee, spouse (if any) and dependents (if any). The user interface may also include fields for indicating, for each health plan that the employee/user may select from, the annual estimated expenses to the employee (i.e., including employee insurance premiums plus estimated out-of-pocket expenses). These estimates can be provided as an “in-network” estimate (i.e., where the healthcare services are provided by doctors and other service providers within the plan's network); or as an “out-of-network” estimate (i.e., where medical services are provided by service providers outside of the plan's network). Fields may be provided which display an estimate of the annual minimum expenses to the employee (i.e., the employee premium for participating in the particular healthcare plan). Fields may be provided for displaying an estimated annual maximum of healthcare expenses for the employee, either in-network or out-of-network (i.e., the employee premium plus an estimate of maximum out-of-pocket expenses based in part upon the particular healthcare plan details).

If desired, one or more of these fields described herein can be provided in tabular form, as shown in the example of FIG. 33. In this way, an employee can easily visualize the different healthcare expenses under different health plans, which aids the employee in comparing the relative benefits of each health plan so that the employee can choose the optimal plan given the assumptions entered by the employee previously. For instance, in the example shown in FIG. 33 and based upon the data previously entered in the example of a male employee, 30-39 years old with back pain, a Percocet prescription, and an expected back surgery in the coming year, living in Denver, Colo., the total estimated healthcare costs without insurance are $41,046. If the employee opts for the “consumer driven HRA Plan” the annual minimum expense is $500 (employee premium), and the estimated annual maximum expense is $3,000 in-network and $4,500 out-of-network. Alternatively, if the user/employee opts for the “HMO Plan”, the annual premium is $1,000 (higher than the first plan by $500), but the estimated annual maximum expenses in-network are $1,915 (a savings of $1,615) and out-of-network, $2,482 (a savings of $2,018). Hence, the employee/user can analyze the costs or benefits of individual plans and compare the costs/benefits relative to other plans.

In one example, the user interface may also include a control for adding data relating to the health plan of the user/employee's spouse/partner, if desired. Controls may also be provided for printing a summary report, obtaining health plan summary information, and/or viewing/changing assumptions used in the computations.

As shown in FIGS. 34-36, a display may be provided wherein a further breakdown of the estimated costs/expenses are provided, such as showing employee premiums, deductible amounts, co-payments and coinsurance, for example.

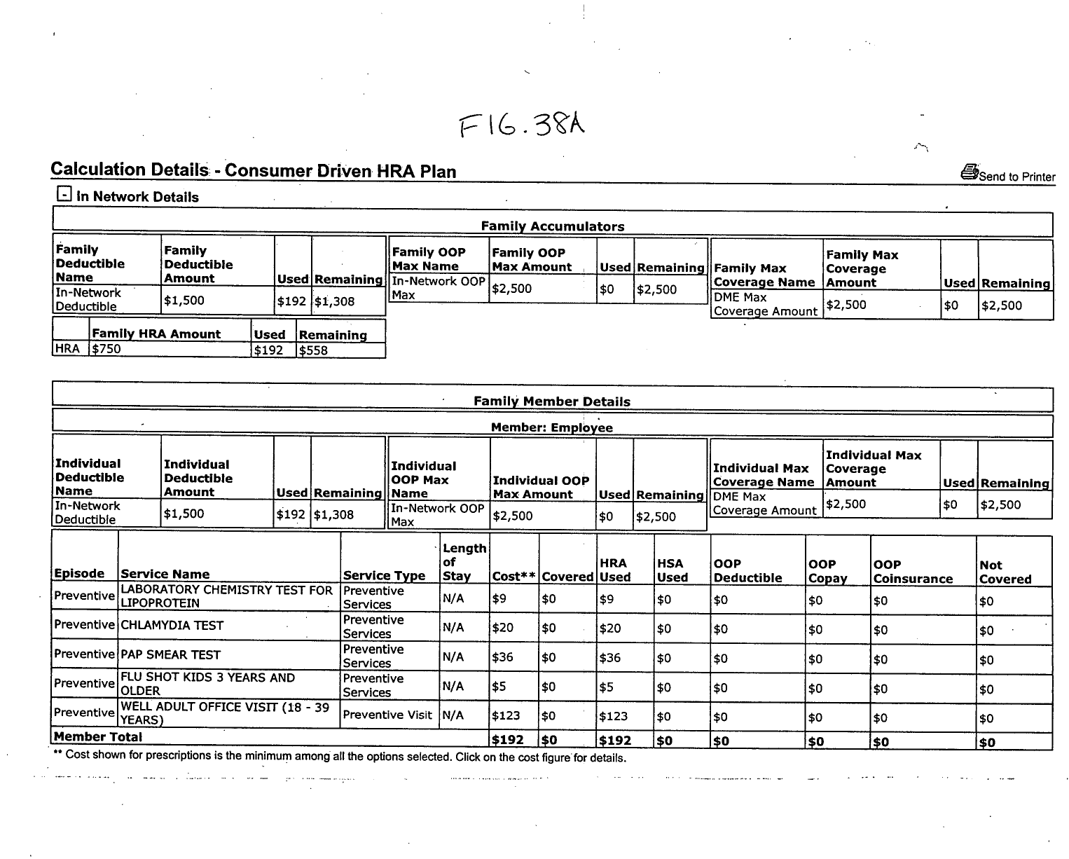

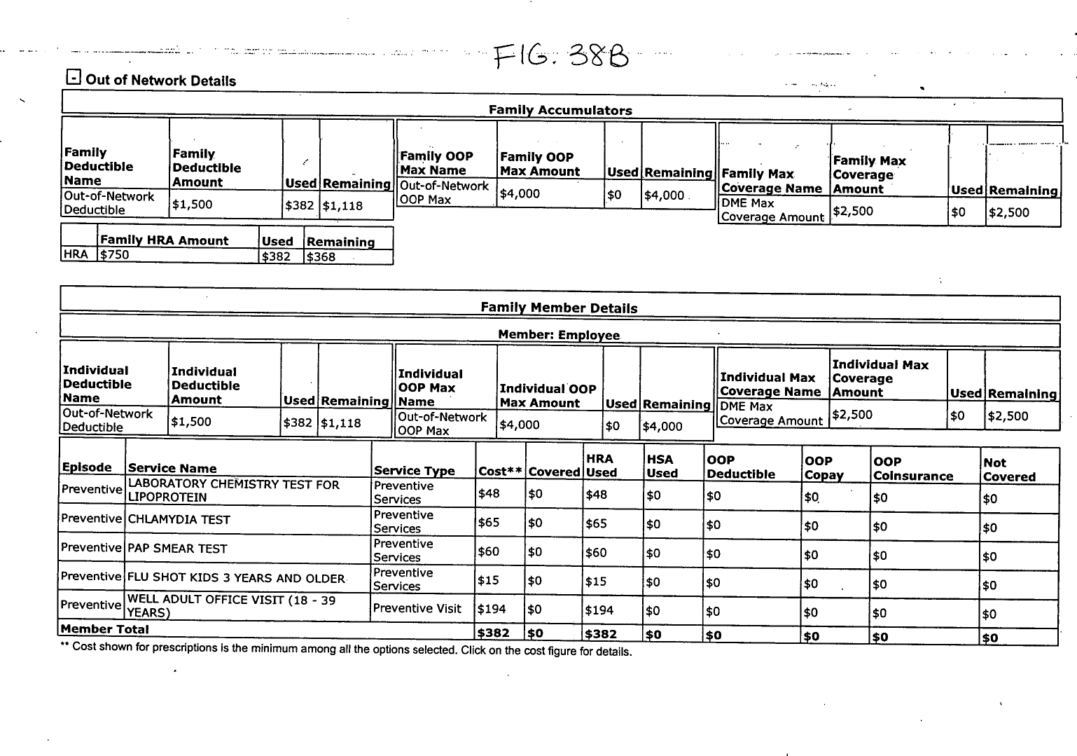

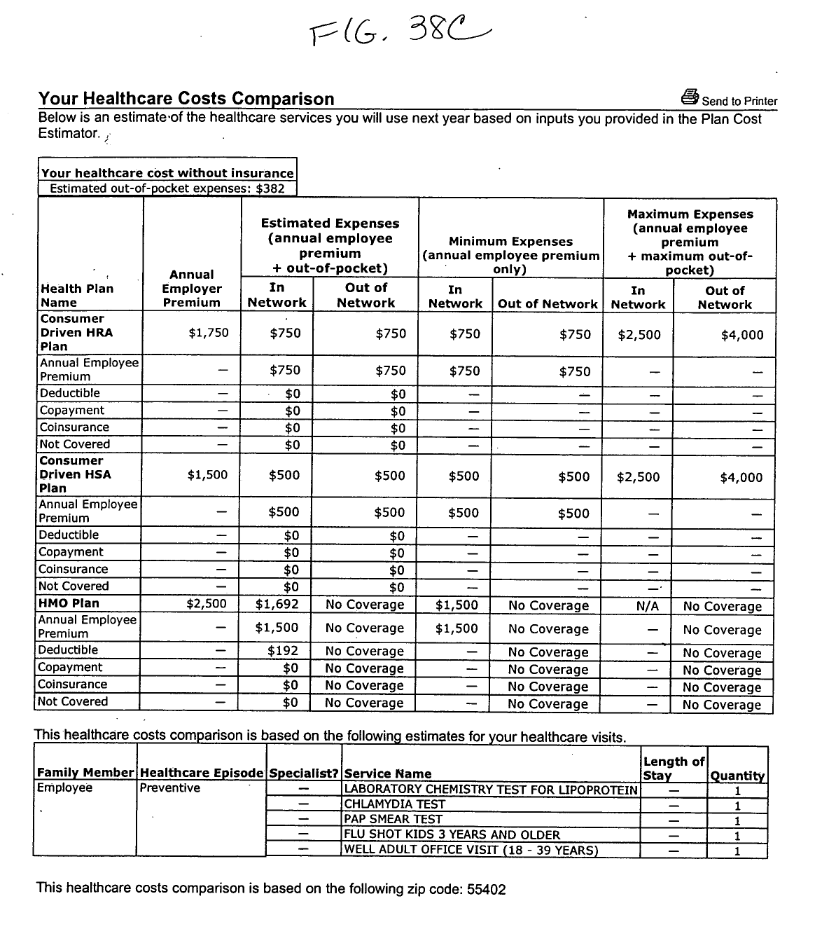

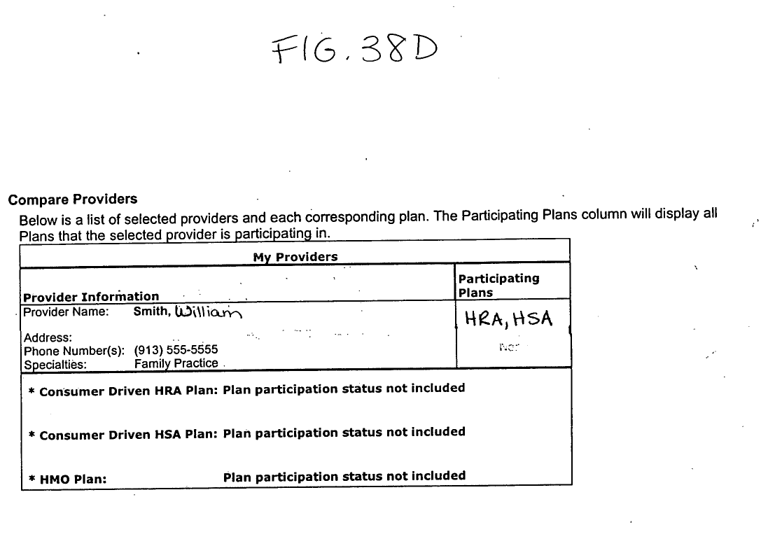

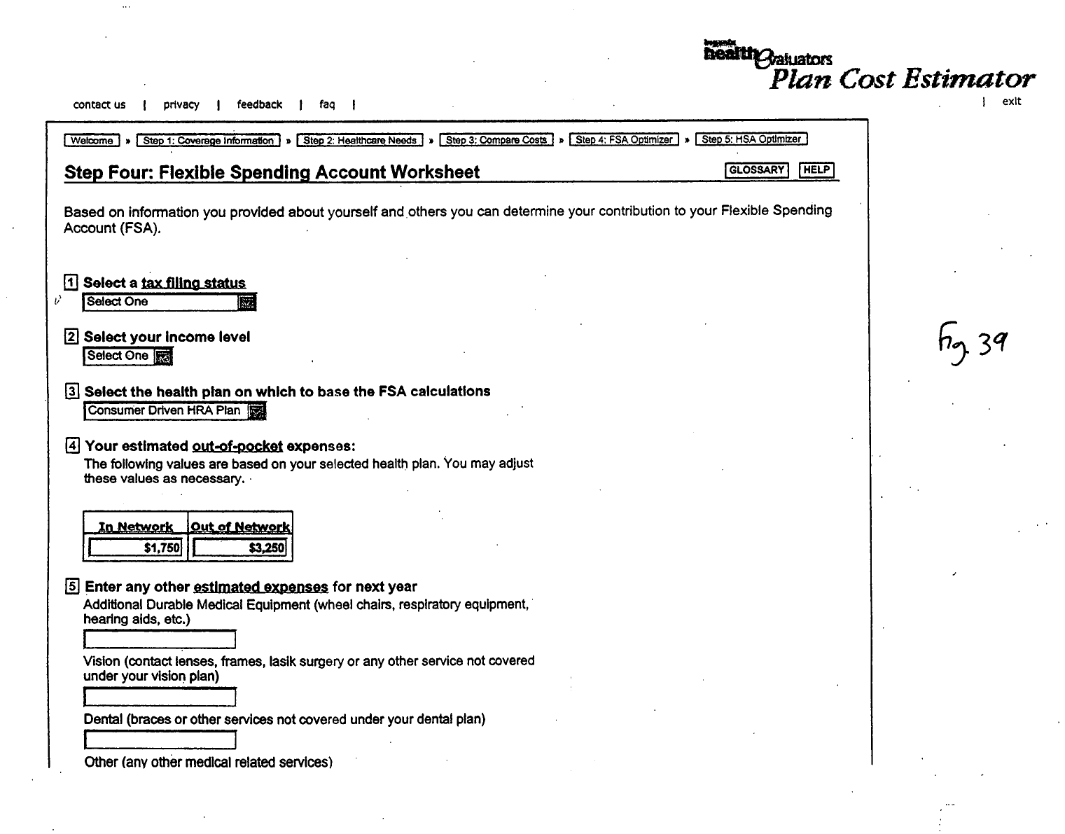

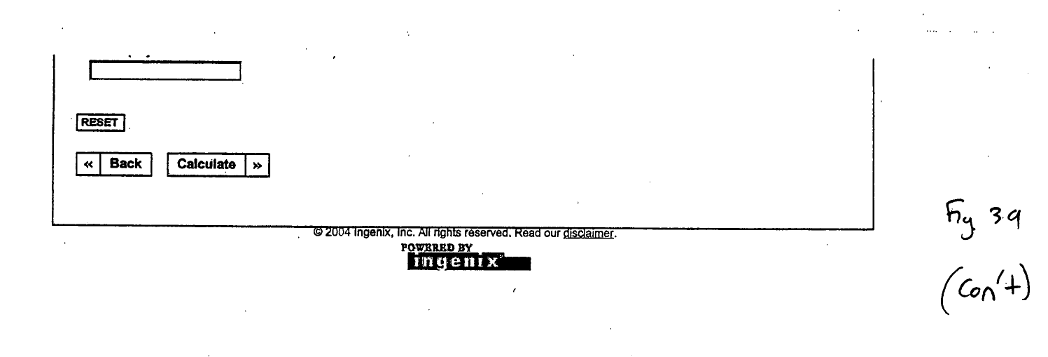

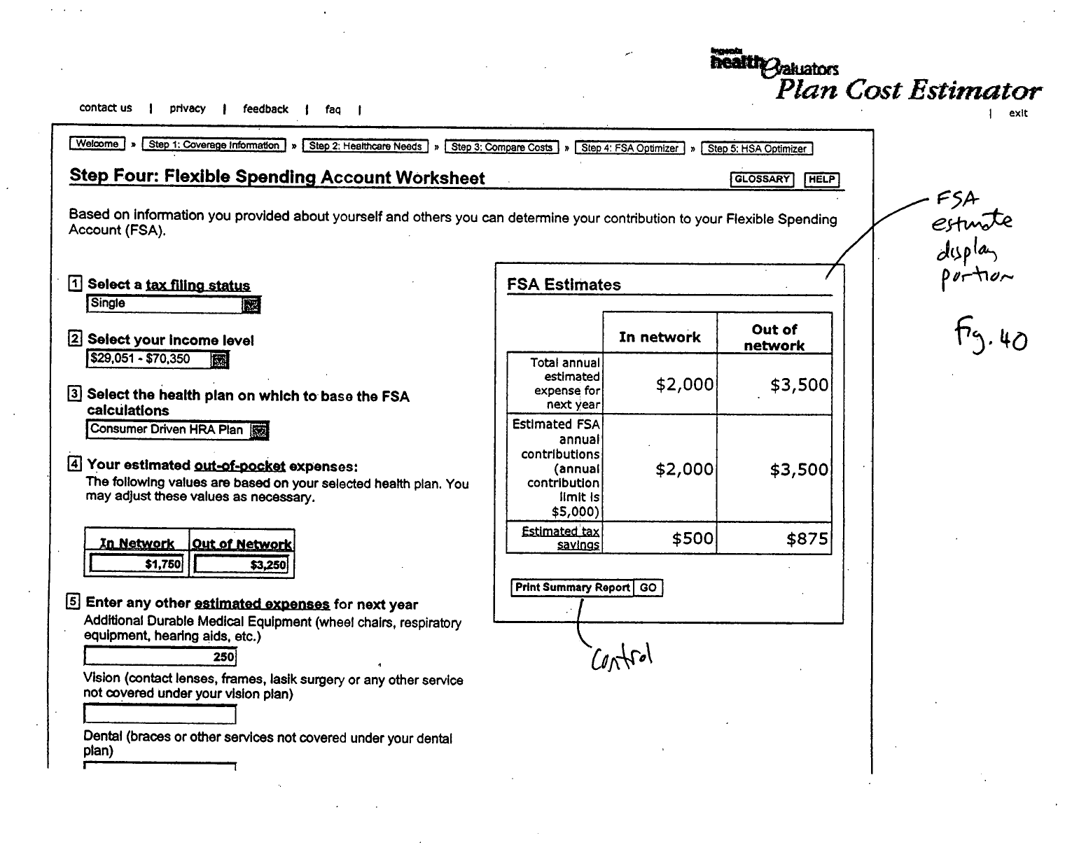

FIGS. 37-38 relate to the view/change assumptions control that may be provided in a user interface, in accordance with one embodiment of the present invention. In FIG. 37, upon the user selecting the control for viewing/changing assumptions, a display section is provided showing a set of estimates that were made based on the user/employee's entries. These assumptions relate to, for example, an estimated number of preventive care visits, office visits, hospital admissions, and emergency room visits. The user is provided with the ability to increase or decrease the number of estimated visits for each of these categories, as well as to change the zip code if desired. A recalculate control is provided which permits the user to affect a recalculation of the estimated healthcare costs based on the changed assumptions entered within the display section of FIG. 37. For instance, in the examples of FIGS. 37-38, the user changes the number of estimated office visits from 2 to 12, and accordingly, the estimated out-of-pocket expenses rises from $41,046 to $41,856, in this example.

The system may further provide details of the calculation of costs under each health plan option. For example, in FIGS. 38A and 38B, calculation details of In-Network costs and Out-of-Network costs are displayed. This information enables users to better understand how the cost estimates for each health plan are calculated and what types of services are included in the estimates. As a result, users who know that they will likely need additional care may add the additional procedures to their profile to enable a more accurate estimate of their healthcare costs under each health plan option.

The system additionally may provide a summary report of healthcare cost comparisons under each available health plan option, as illustrated in FIGS. 38C and 38D. FIG. 38C provides a report of the cost comparisons under each health plan option, and FIG. 38D displays an example of a provider selected by the user and indicated whether the provider participates with any of the health plan options.

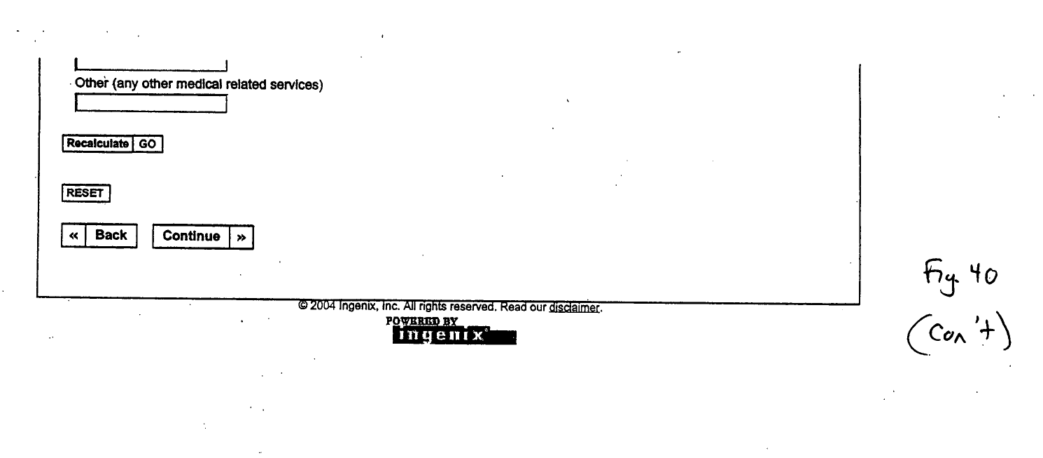

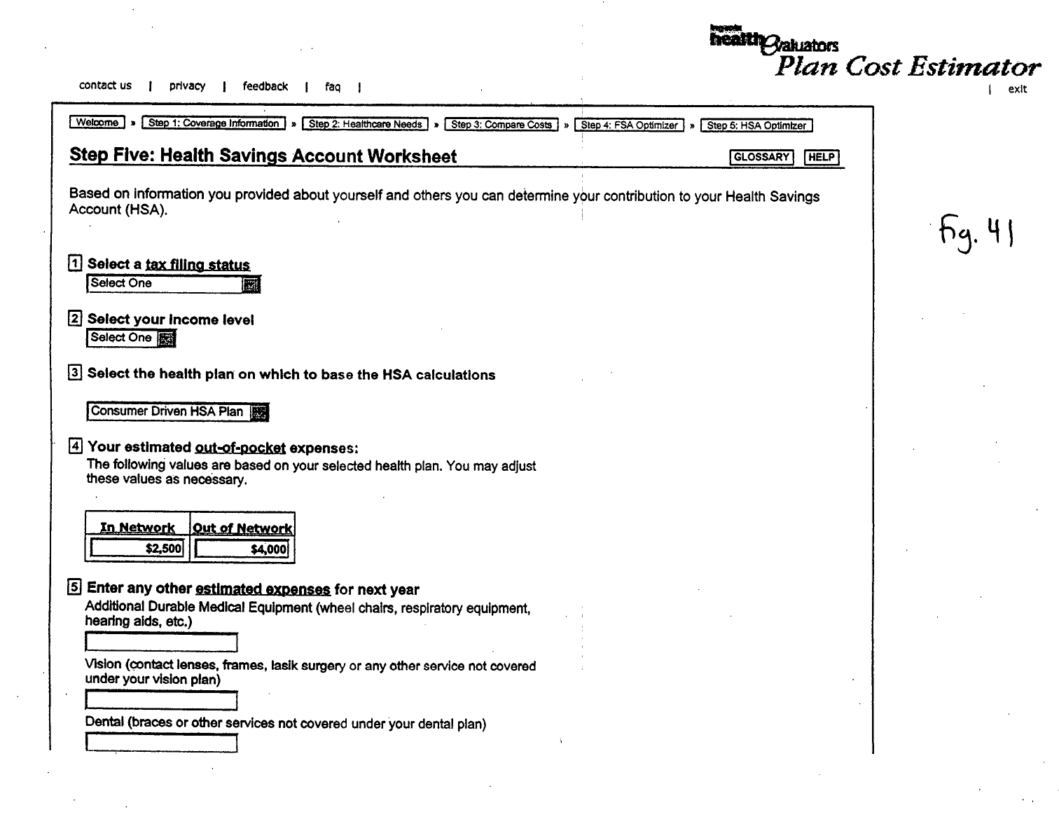

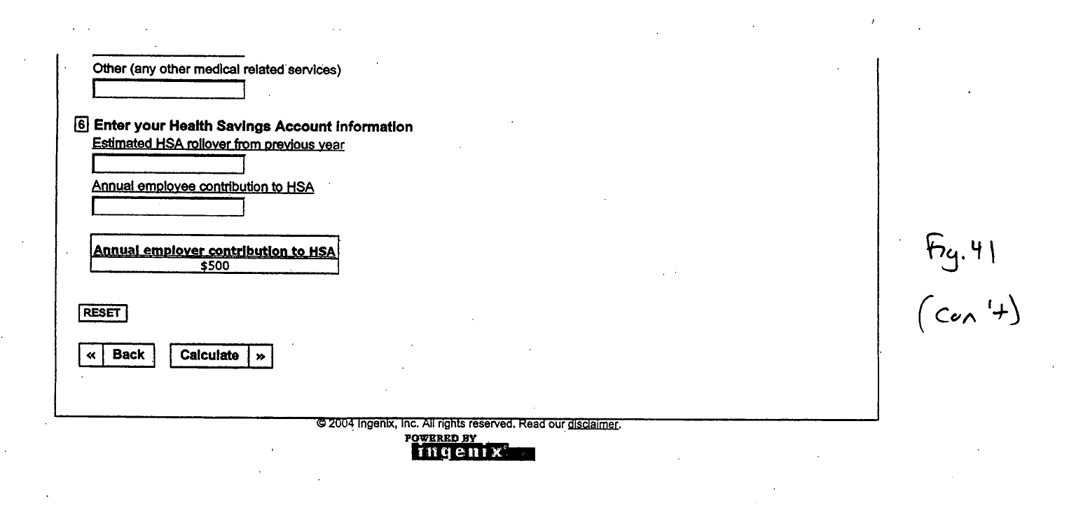

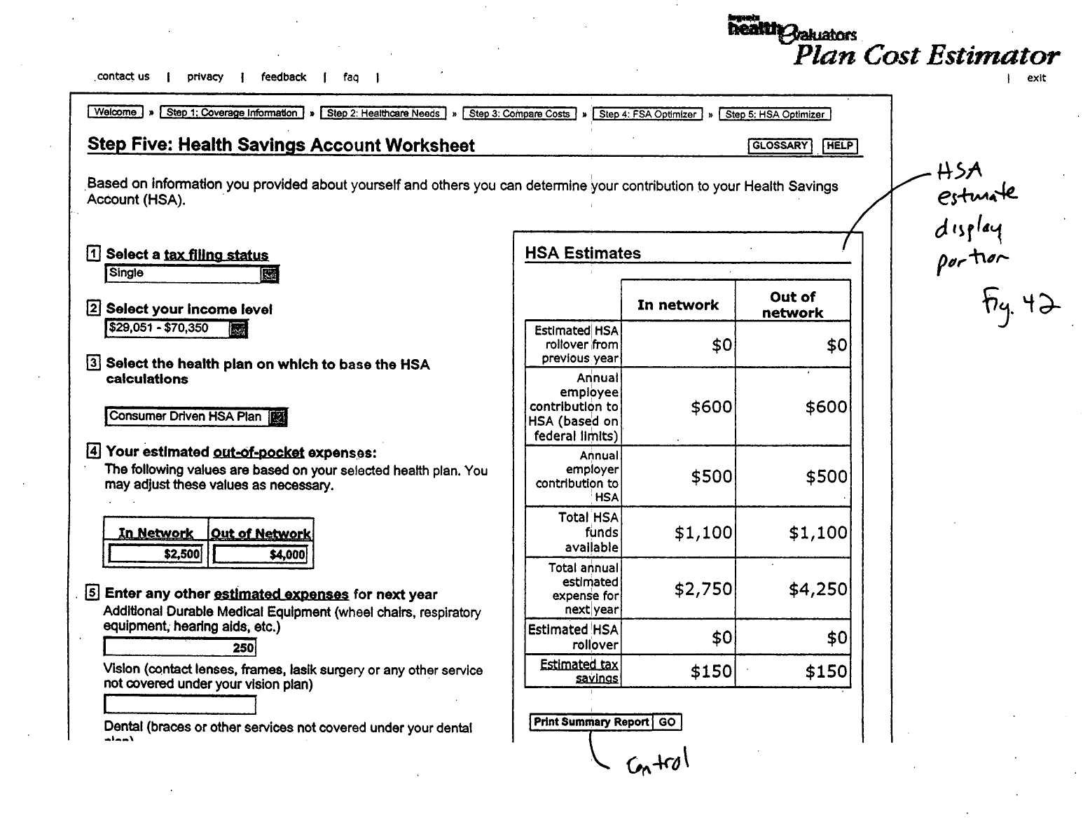

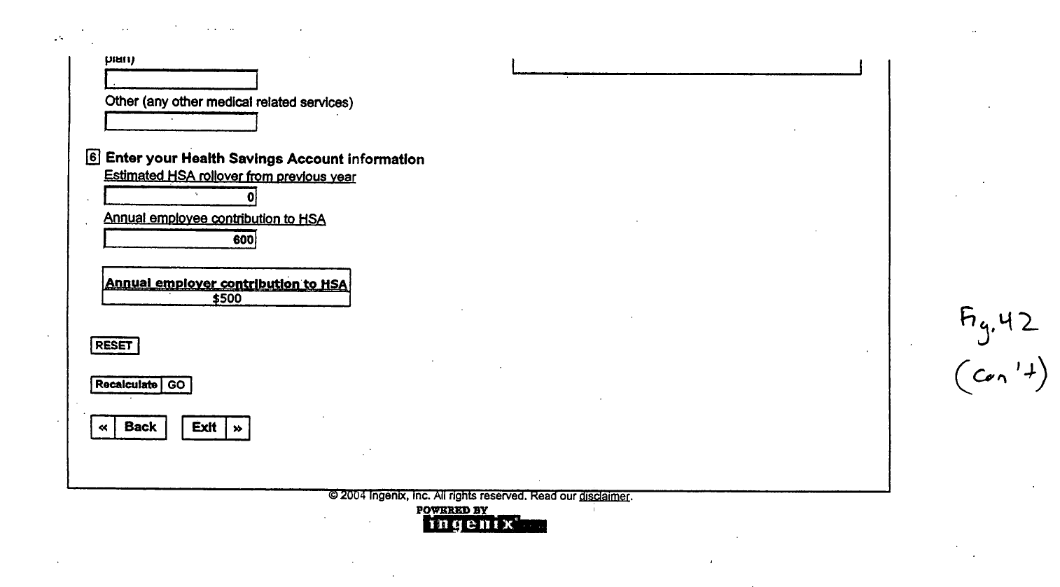

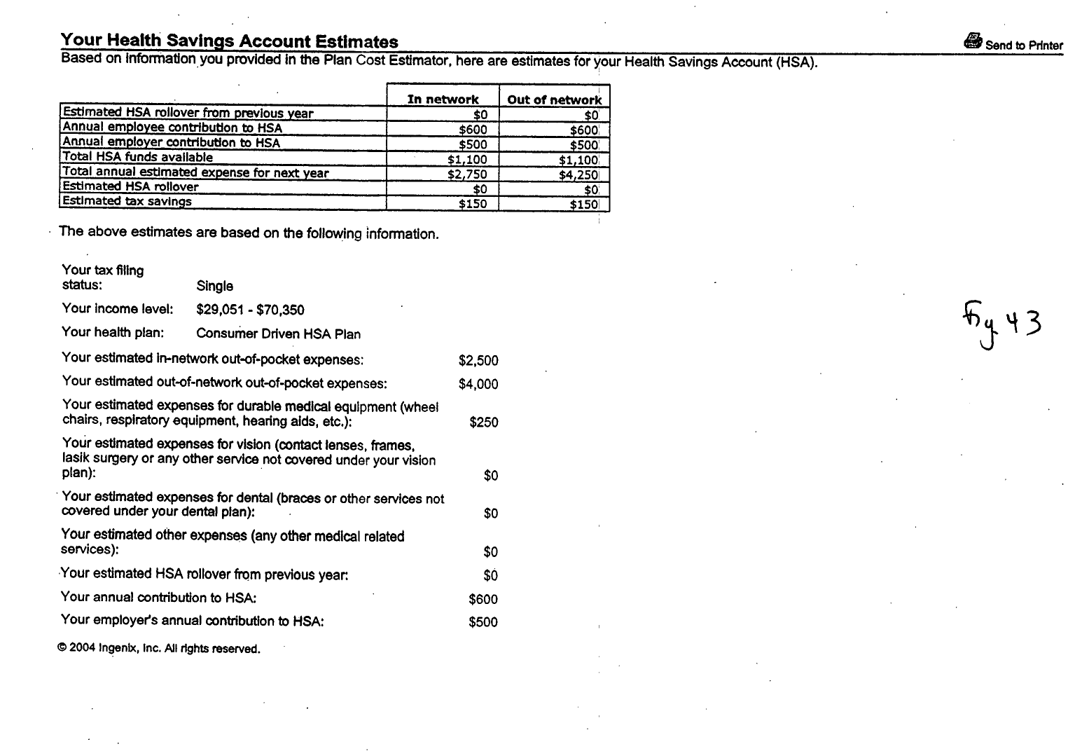

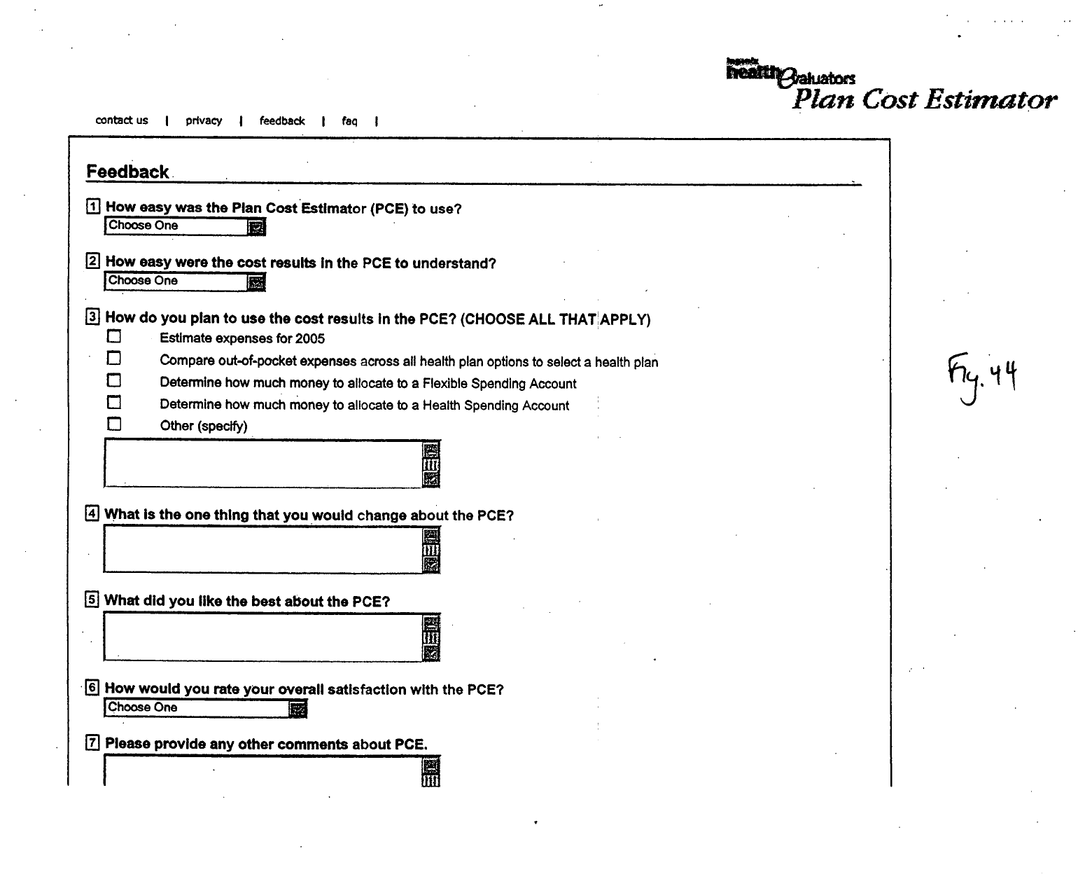

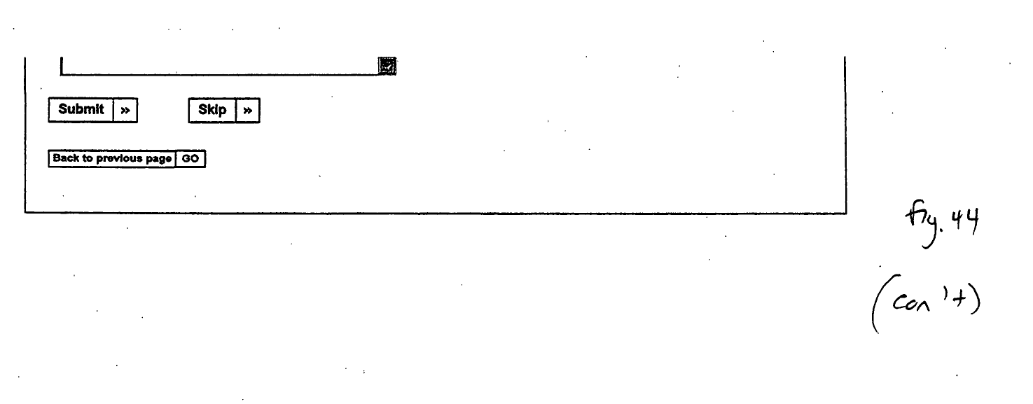

Embodiments of the present invention may include user interface display screens which permit a user/employee to obtain an estimate of contribution amounts to flexible spending accounts (FSA) or health saving accounts (HSA). FIGS. 39-40 illustrate example display screens for flexible spending accounts, and FIGS. 41-43 illustrate example display screens for health saving accounts.

Referring to FIGS. 39-40, a user interface may be provided which contains fields for the user/employee to select their tax status (single, joint, etc.); selecting the employee/user's income level; selecting the health plan on which to base the flexible spending account calculations; inputting the user's estimated out-of-pocket expenses, in-network and/or out-of-network; and inputting other estimated expenses for the year, including expenses for durable medical equipment, and expenses not covered under other plans such as vision expenses (contact lenses, glasses, Lasik surgery) and dental services (such as braces or other services not covered under a dental plan) as well as other medical related services. As shown in FIG. 40, upon the user/employee entering such information, an FSA estimate display portion may be provided which shows the total annual estimated expense for next year (both in-network and out-of-network as well as estimated annual FSA contributions as well as estimated tax savings. For instance, in the example of FIG. 40, the estimated out-of-network expenses are $3,500, and if an annual FSA contribution is made in the amount of $3,500, the estimated tax savings is $875 for these out-of-network expenses.

A user interface may also be provided for determining contributions to a health savings account, in a similar manner as described above regarding the flexible spending account in FIGS. 39-40. FIGS. 41-43 illustrate example display screens for determination of contributions to health savings accounts. Fields may be provided for the user to specify the user's tax filing status, income level, desired health plan, estimated out-of-pocket expenses (in-network and/or out-of-network) and other estimated expenses for the year. Fields may be provided for entering an estimated amount of health savings account rollover from the previous year, as well as an annual employee contribution to the health savings account. The annual employer contribution to the health savings account may also be displayed, as shown in FIG. 41.

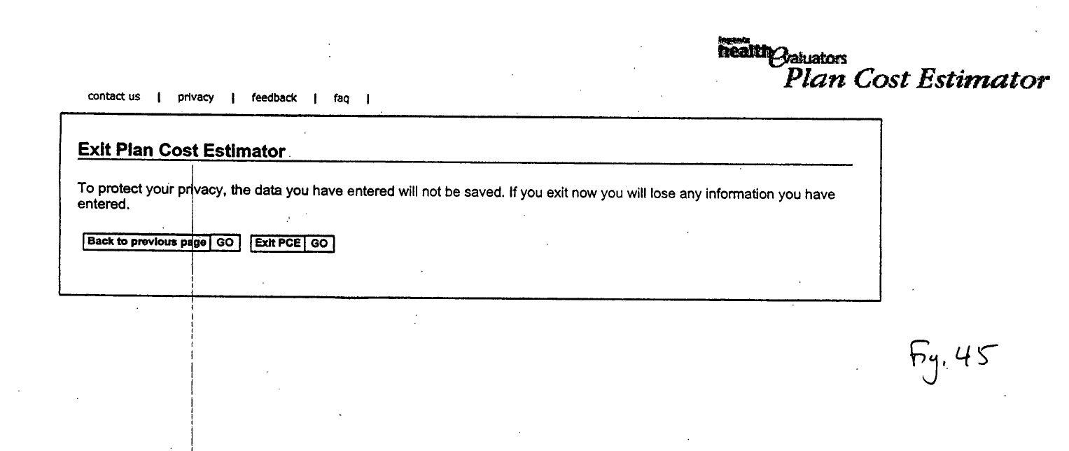

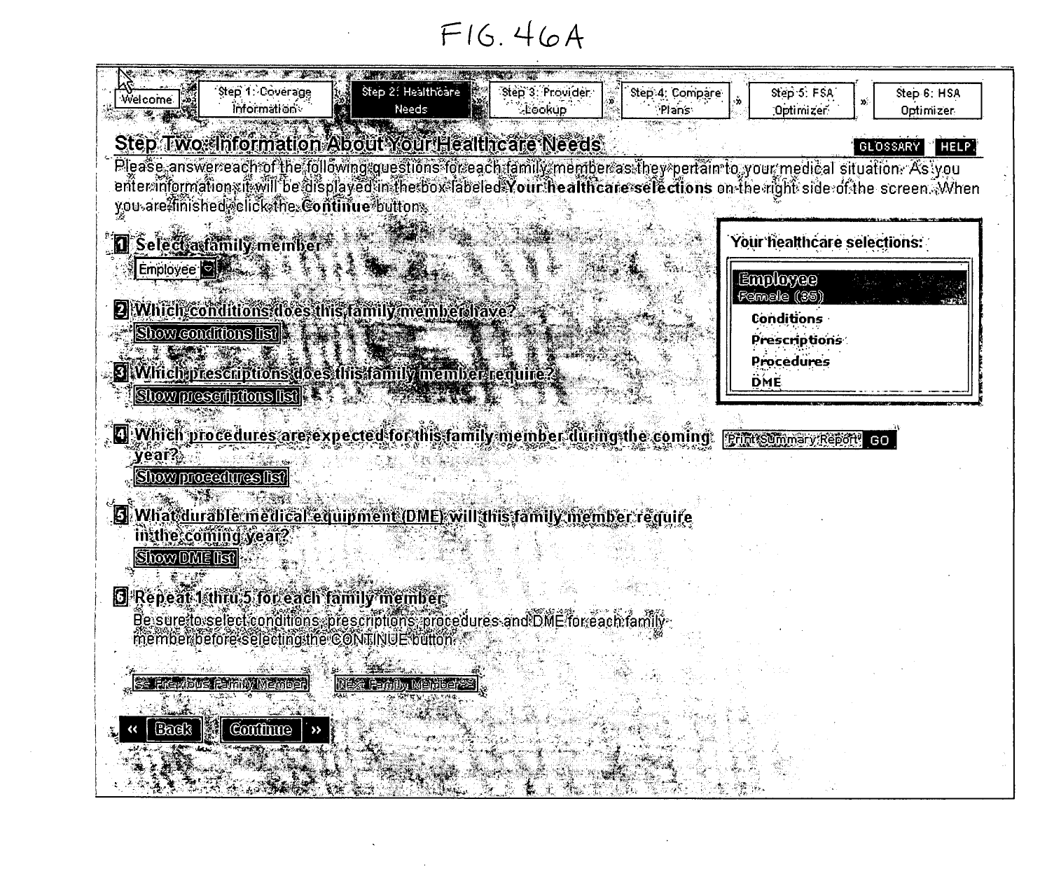

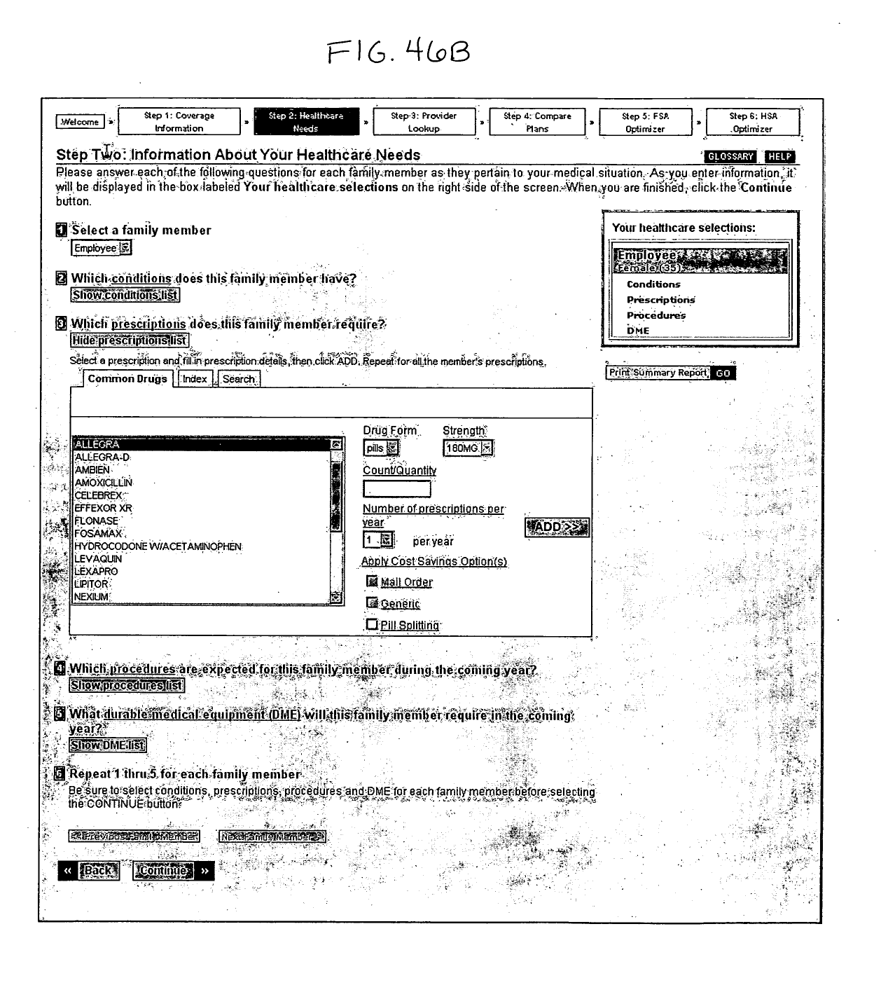

FIG. 42 shows an example where the user/employee has entered various pieces of data into the fields described above, and a portion of the display shows the health savings account estimates. In this example, the total HSA funds available are $1,100 and the estimated tax savings are $150. If desired, a summary report of the flexible spending account estimates and the health savings account estimates may be generated. In FIG. 40, a summary report control is provided for the flexible spending account estimates, and in FIG. 42, a control is provided for printing a summary of health savings accounts. FIG. 43 illustrates an example of such a summary report (in this case, for an HSA account). The summary may include various pieces of data or information that were obtained from the user as well as various estimates that were calculated.

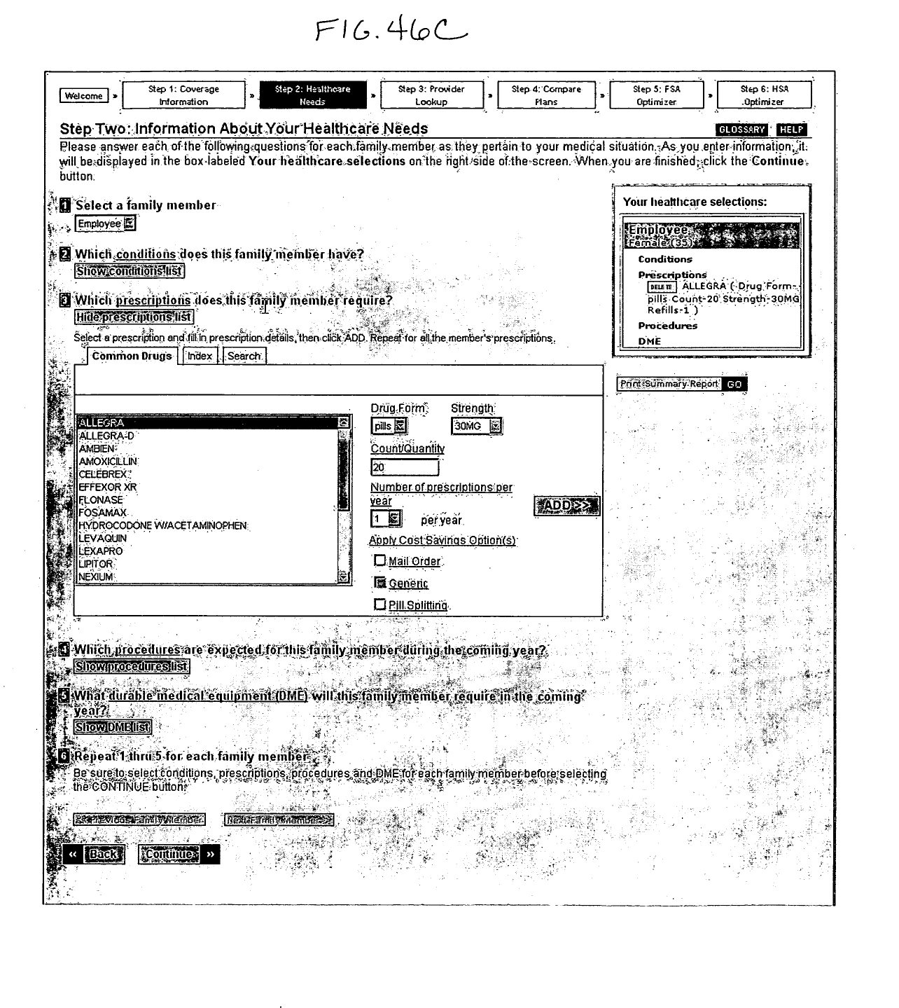

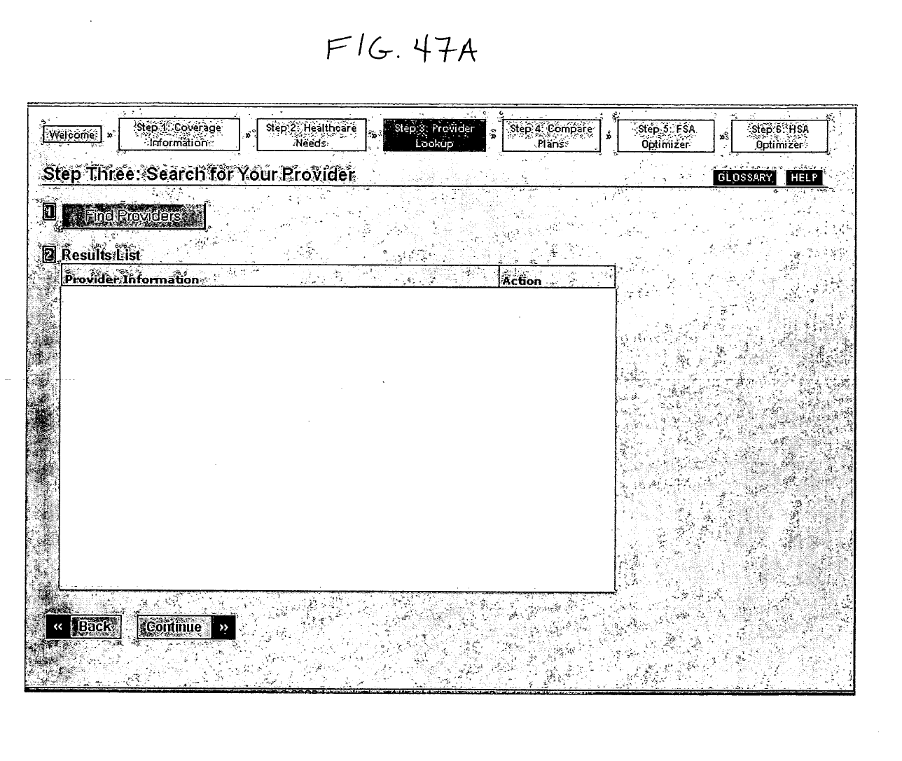

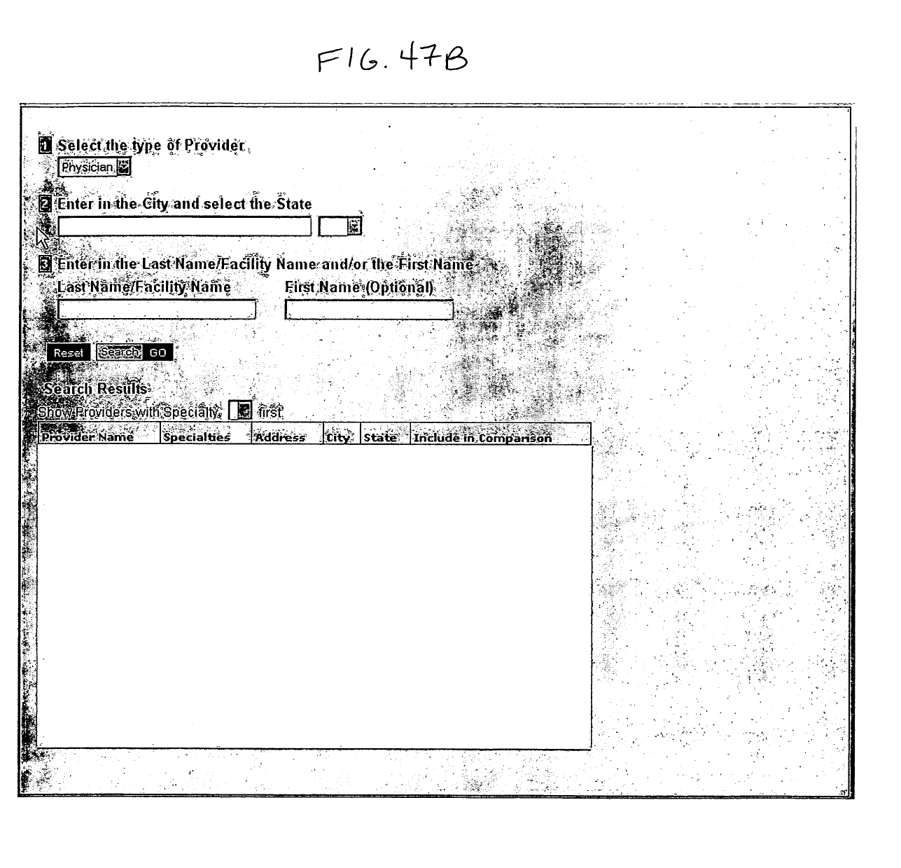

A user interface requesting feedback from the user/employee may be provided, and one example is shown in FIG. 44. FIG. 45 illustrates an example of an exit screen. In one example, the data that the user/employee enters into the planned cost estimator program is not persistently saved in order to protect privacy and confidentiality of the information.

While FIG. 1 shows a plan cost estimator as an application program running on a network, it is understood that embodiments of the invention could be implemented as a standalone software application running on a stand alone computing device (i.e., computer, PDA, etc.), a hardware device, or using other implementations.

It is understood that the display screens shown and described herein are provided as examples only, and that a system embodying various aspects of the invention may be formed with or without use of these example display screens, depending upon the particular implementation.

Embodiments of the invention can be embodied in a computer program product. It will be understood that a computer program product including features of the present invention may be created in a computer usable medium (such as a CD-ROM or other medium) having computer readable code embodied therein. The computer usable medium preferably contains a number of computer readable program code devices configured to cause a computer to affect the various functions required to carry out the invention, as herein described.

While the methods disclosed herein have been described and shown with reference to particular operations performed in a particular order, it will be understood that these operations may be combined, sub-divided, or re-ordered to form equivalent methods without departing from the teachings of the present invention. Accordingly, unless specifically indicated herein, the order and grouping of the operations is not a limitation of the present invention.

It should be appreciated that reference throughout this specification to “one embodiment” or “an embodiment” or “one example” or “an example” means that a particular feature, structure or characteristic described in connection with the embodiment may be included, if desired, in at least one embodiment of the present invention. Therefore, it should be appreciated that two or more references to “an embodiment” or “one embodiment” or “an alternative embodiment” or “one example” or “an example” in various portions of this specification are not necessarily all referring to the same embodiment. Furthermore, the particular features, structures or characteristics may be combined as desired in one or more embodiments of the invention.

It should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed inventions require more features than are expressly recited in each claim. Rather, as the following claims reflect, inventive aspects lie in less than all features of a single foregoing disclosed embodiment, and each embodiment described herein may contain more than one inventive feature.

While the invention has been particularly shown and described with reference to embodiments thereof, it will be understood by those skilled in the art that various other changes in the form and details may be made without departing from the spirit and scope of the invention.

1. A system for estimating medical costs under at least one health plan, comprising:
a user device for providing user health data entered by a user and obtaining estimated health plan cost data generated in response to the user health data; and
a processor for providing the estimated health plan cost data, wherein the processor includes
an administrative module for receiving user account data and health plan data entered by an administrator;
a calculation module for providing estimated cost data based upon the user health data;
a user module for generating the estimated health plan cost data based upon the user health data, user account data, health plan data and estimated cost data and providing the estimated health plan cost data to the user device; and
a database for storing the estimated health plan cost data, user health data, user account data, health plan data and estimated cost data,
wherein the user health data includes prescription data and prescription cost saving option data.

2. The system according to claim 1, wherein the user health data further includes medical condition data, expected medical procedure data or expected durable medical equipment data.

3. The system according to claim 2, wherein the calculation module provides estimated cost data for at least one expected future medical procedure, expected future prescription, or expected future use of durable medical equipment based upon the user health data.

4. The system according to claim 1, wherein the user module calculates the estimated health plan cost data by adding all estimated cost data corresponding to the user health data and applying the health plan data an user account data to determine expected costs to the user under at least one health plan.

5. The system according to claim 1, wherein the estimated health plan cost data includes comparative healthcare costs for the user under two or more health plans.

6. A system for estimating medical costs under at least one health plan, comprising:
a device for providing user health data entered by a user and obtaining estimated health plan cost data generated in response to the user health data; and
a processor for providing the estimated health plan cost data, wherein the processor includes
an administrative module for receiving user account data and health plan data entered by an administrator;
a calculation module for providing estimated cost data based upon the user health data;
a user module for generating the estimated health plan cost data based upon the user health data, user account data, health plan data and estimated cost data and providing the estimated health plan cost data to the user device; and
a database for storing the estimated health plan cost data, user health data, user account data, health plan data and estimated cost data,
wherein the user health data includes health care provider selection data.

7. The system according to claim 6, wherein the user health data includes medical condition data, prescription data, expected medical procedure data or expected durable medical equipment data.

8. The system according to claim 7, wherein the calculating means provides estimated cost data for at least one expected future medical procedure, expected future prescription, or expected future use of durable medical equipment based upon the user health data.

9. The system according to claim 6, wherein the estimating means calculates the estimated health plan cost data by adding all estimated cost data corresponding to the user health data and applying the health plan data an user account data to determine expected costs to the user under at least one health plan.

10. A system for estimating medical costs under at least one health plan, comprising:
a user device for providing user health data entered by a user and obtaining estimated health plan cost data generated in response to the user health data; and
a processor for providing the estimated health plan cost data, wherein the processor includes
an administrative module for receiving user account data and health plan data entered by an administrator;
a module for receiving historical user data;
a calculation module for providing estimated cost data based upon the user health data;
a user module for generating the estimated health plan cost data based upon the user health data, historical user data, user account data, health plan data and estimated cost data and providing the estimated health plan cost data to the user device; and
a database for storing the estimated health plan cost data, user health data, user account data, health plan data and estimated cost data,
wherein the user health data includes prescription data and prescription cost saving option data.

11. The system according to claim 10, wherein the user health data includes medical condition data, prescription data, expected medical procedure data or expected durable medical equipment data.

12. The system according to claim 11, wherein the calculating means provides estimated cost data for at least one expected future medical procedure, expected future prescription, or expected future use of durable medical equipment based upon the user health data.

13. The system according to claim 10, wherein the estimating means calculates the estimated health plan cost data by adding all estimated cost data corresponding to the user health data and applying the health plan data an user account data to determine expected costs to the user under at least one health plan.

14. A computer software product for estimating medical costs under at least one health plan, wherein, when run on a computer, the computer software product performs the steps of:
receiving user health data entered by a user;
receiving user account data and health plan data entered by an administrator;
generating estimated cost data based upon the user health data;
generating estimated health plan cost data based upon the user health data, user account data, health plan data and estimated cost data; and
providing the estimated health plan cost data to the user, wherein the user health data includes prescription data and prescription cost saving option data.

15. A computer software product for estimating medical costs under at least one health plan, wherein, when run on a computer, the computer software product performs the steps of:
receiving user health data entered by a user;
receiving user account data and health plan data entered by an administrator;
generating estimated cost data based upon the user health data;
generating estimated health plan cost data based upon the user health data, user account data, health plan data and estimated cost data; and
providing the estimated health plan cost data to the user,
wherein the user health data includes health care provider selection data.

16. A computer software product for estimating medical costs under at least one health plan, wherein, when run on a computer, the computer software product performs the steps of:
receiving user health data entered by a user;
receiving historical user data;
receiving user account data and health plan data entered by an administrator;
generating estimated cost data based upon the user health data;
generating estimated health plan cost data based upon the user health data, historical user data, user account data, health plan data and estimated cost data; and
providing the estimated health plan cost data to the user.
